(19) United States
(12) Patent Application Publication
(10) Pub. No.: US 2006/0242159 A1
(43) Pub. Date: Oct. 26, 2006

(54) Methods and apparatus for distributing digital medical images via a redirected system

(76) Inventors: Robert J. Bishop, Hinsdale, IL (US); James B. Weldy, Downers Grove, IL (US); Joseph A. Golkosky, Grayslake, IL (US)

Correspondence Address: BELL, BOYD & LLOYD, LLC, PO BOX 1135, CHICAGO, IL, 60690-1135, US

(21) Appl. No.: 11/372,658

(22) Filed: Mar. 10, 2006

Related U.S. Application Data
(60) Provisional application No. 60/661,312, filed on Mar. 10, 2005.

(51) Int. Cl. G06F 17/30

(52) U.S. Cl. 707/10

(57) ABSTRACT

Methods and Systems for viewing, manipulating, transmitting and comparing digital image patient imaging studies. The methods and systems enable a user to take, receive, store and transmit digital imaging studies. The system allows the digital imaging studies to be stored locally and backed up at a remote server. The user is able to provide commands to provide for additional services or features to be performed on the imaging studies at the remote server and/or the local server. Users at local servers are able to grant access to selected images to third parties for collaboration. The user is able to compare a digital patient image with a digital image of an appropriate implant enabling the user to properly size, fit and locate the implant with respect to the digital image. Additionally, the system allows the user to compare digital images over time to determine implant movement with respect to its insertion, as well as changes within the bones.

### PRIORITY CLAIM

This application claims the benefit of U.S. Provisional Patent Application Ser. No. 60/661,312 filed on Mar. 10, 2005, the entire disclosure of which is hereby incorporated.

### TECHNICAL FIELD

The present disclosure relates generally to the management and communication of digital information though a network, and more particularly to methods and apparatus for manipulating and communicating medical information.

### BACKGROUND

Orthopedic practices place unique needs and demanding challenges on the orthopedic surgeon every day, including pressure to reduce costs and deliver faster, higher-quality patient care. Orthopedic digital imaging solutions are designed to improve patient diagnosis, treatment, and care and maximize practice productivity and profitability within orthopedic practices.

Many orthopedic practices, and other medical practices, make use of radiological equipment, computers, networks and similar technology to obtain and manage information regarding patients. An example of one such system is a picture archiving and communication system (“PACS”).

Typically, a conventional PACS includes several components. The components include an imaging modality, an archive, a method of communication, such as a network, and a viewing station. The imaging modality allows a user to generate images of a patient and add them to the PACS. Several typical images generated in a PACS include, but are not limited to, magnetic resonance imaging (“MRI”) images, computed tomography (“CT”) images, X-Ray images, ultrasound (“US”), fluoroscopy, mammography and nuclear medicine. In addition, the imaging modality may also include devices such as digital scanners that can scan and digitize hard copy imaging studies. Images that are generated at the imaging modality are then communicated to an archive where they can be distributed and retrieved at a viewing station. The imaging modality, archive and viewing station all communicate over a network, which can be a local area network (“LAN”), a wide area network (“WAN”), an extranet or the like.

Conventional PACS do not optimally address several areas as they relate to the orthopedic medical practice. More specifically, many of these systems and methods fail to adequately address the areas of applying patient information most relevant to orthopedic practice workflow and clinical decision making to image acquisition, archiving, transmitting, distributing, displaying, comparing and templating off of an image.

With respect to image acquisition, conventional PACS systems typically have a technologist perform the patient imaging study. The technologist may manually enter a patient's information at the imaging modality. Typically, a technologist transcribes information provided from a patient's file, from an assistant, from the physician and/or from the patient. Additionally, the information may be in typed, hand written or in oral form. Such a system is inefficient, as the information is likely to already exist in a computer system in the physician's office. Moreover, it is likely that a technologist can introduce error into the system. The error can result in an imaging study being lost or misplaced in another patient's file. Losing or misplacing an imaging study may result in the patient retaking the imaging study at the time and expense of the patient and the physician. The error may also cause the imaging study to be delivered or routed to the wrong destinations.

With respect to archiving the imaging studies, as digitized radiology has taken off, more and more imaging studies are being stored for later retrieval. Because digitized radiology produces large imaging study data files, and medical practices typically retain imaging studies for a specified minimum number of years, the storage demands on a practice continue to increase. Practices have tried various methods of keeping copies of all imaging studies at the practice site. However, storing all of the imaging studies is not always practical due to the storage demands. Storage restraints may be due to financial considerations, scarcity of required labor expertise, slowness of study retrieval or because of physical media space limitations.

One common solution to the storage problem has been to transfer imaging studies over a certain age to tape backup and other similar types of archiving methods such as optical disk. However, while this storage approach may reduce the equipment and media financial burden, this storage approach typically involves more labor and attendant operational time costs. Additionally, this storage approach slows down the recovery and access time to archived imaging studies. Backup methods such as tape backup require smaller capital expenditure, but, they trade-off less expensive high capacity storage at the expense of longer access time, slower availability of the imaging studies and more labor consumption. Other solutions provide for offsite storage for all but the most recent of imaging studies, which are stored at the practice site. While this storage approach may solve some storage problems, retrieving imaging studies from remote servers can cause inefficiencies. Imaging studies can be quite large. Transmission and retrieval of the imaging studies over the Internet using conventional methods can take a long time. Further, a user may experience additional problems with transmission and retrieval of imaging studies because of problems with their internet service provider (“ISP”). For example, the ISP may experience transmission difficulties in the ability to upload and/or download, and/or the connection to the Internet may be unavailable or intermittent.

With respect to transmitting imaging studies over long distances, medical practices today can have numerous affiliations or locations for one practice. As a result, physicians may see a patient at more than one practice site. Accordingly, a physician may need access to imaging studies located at a different practice site. Moreover, a patient may be referred to a physician outside of the practice affiliation. The referred physician may request access to the imaging study.

One way this problem has been addressed is by having a medical practice produce a hard copy of the imaging study for the patient. Production of a hard copy allows the patient to travel to other practices and present a hard copy of the imaging study. However, producing a hard copy requires practices to acquire hard copy production equipment and acquire hard copy equipment operation expertise. Another problem with producing hard copies of imaging studies is that the production of the hard copy increases the cost of providing services to a practice. The increase costs for example, may result from the utilization of time, materials and equipment to produce the hard copy of the imaging study. One solution to this problem allows the user to email a copy of the digital imaging study to another user. However, this solution requires large imaging studies to be emailed for each recipient. Handling large imaging studies can affect system performance. They can cause a system to slow down or become inoperable as many recipient systems automatically block large inbound files. Another problem with emailing medical imaging studies is that while there are safeguards in place, generally imaging studies being transmitted via email are less secure than a secure system that requires recipients to log in as authorized by the sender. Another problem with emailing imaging studies is that a recipient practice may not have proper access to computing abilities to be able to receive emailed imaging studies.

With respect to distributing imaging studies during a clinical visit, many conventional PACS rely on sending newly acquired imaging studies directly to pre-determined reviewing stations as the images are processed. Sending imaging studies to pre-determined reviewing stations may increase the likelihood that a requested imaging study will be provided sooner to the physician who requested the new imaging study. However, sending imaging studies to pre-determined reviewing stations fails to address the problems of subsequent image retrievals and what happens if a physician needs to change the location of where the imaging studies are being reviewed. In both situations, a physician would need to retrieve a copy of the imaging study in order to view the imaging study.

Typically, a conventional PACS will send the newly acquired imaging study to the pre-determined reviewing station. However, a physician may need to review prior imaging studies for the patient in conjunction with the newly acquired imaging study. Therefore, a physician may have to log onto a system, search for an imaging study and then retrieve the imaging study. Searching for and retrieving an imaging study for the same patient is an inefficient utilization of the physician's resources. The physician is required to spend some time search through lists to find a related imaging study to review. Accordingly, a physician must take time to find the particular study they are looking for, as well as take time as the imaging study is being retrieved from the server.

With respect to comparing imaging studies, the user may want to compare an imaging study taken on one day with another imaging study taken on another day. Traditionally, one solution to this problem is to compare hard copies of the two imaging studies side-by-side or one on top of the other. Typically when an imaging study is placed on top of another imaging study, the stacked imaging studies become difficult to see through. In addition, the user may need to obtain measurements to compare the two imaging studies. However, with this hard copy method, measurements are taken manually, which is prone to human error. Another solution allows two imaging studies to be digitized and compared side-by-side on a display. However, when images are tiled or cascaded across a display, there is no interaction between the images. While digitally displaying imaging studies may be an improvement over other conventional methods, it does not allow the imaging studies to be digitally connected and compared efficiently. Typically, when two imaging studies are digitally displayed, a user may select certain points or locations on one imaging study. The user may then select corresponding points on second imaging study. The user performs calculations and comparisons between the two imaging studies. Alternatively, the user may have software that can perform analysis and comparisons between the two imaging studies. However, it is difficult to manipulate the points in one imaging study and have the corresponding points automatically and equally manipulated in the second imaging study.

Many patients see orthopedic surgeons because they need an implant. The orthopedic surgeon or an implant vendor and the like, may need to select an appropriate implant to fit and insert into a patient. Typically, a pre-operative template analysis is performed for a patient who is going to receive an implant. Many conventional methods rely upon using inefficient and imprecise methodologies for the pre-operative template analysis. Another problem with pre-operative template analysis off an imaging study is that imaging studies are not anatomically correct. For example, where the patient has an X-Ray taken, the image is the shadow of the anatomic structure produced on the film cassette by the X-Ray source. This is because the X-Ray source is located on one side of a patient and the film cassette is located on the other side. For example, in a conventional X-Ray, the radiation source is placed several inches to several feet from the body with the film cassette on the opposite side of the body. The anatomic structure is inside the body, and therefore, is some distance away from the film cassette. The radiation travels from the X-Ray source, through the body, hitting the cassette on the other side. As the radiation travels, the beam spreads out. Accordingly, when the beam passes through the body, a shadow of the image is cast on the film cassette. Depending upon the distance from the radiation source to the film plate and the distance from a point on the patient's anatomic structure imaged to the film cassette, the shadow image produced on the film cassette can be differently sized. Thus, the image used to determine template selection is not anatomically sized, but rather enlarged by a certain percentage based upon the different distances. The images produced are generally larger than the actual anatomical body part.

Traditionally, when performing pre-operative implant selection for a patient, the user will use manual methods. For example, the user may place an image on a light box and measure the image by hand to produce the data needed to facilitate selection of the proper implant. In selecting the implant, the user will measure various points on the image and make a series of marks and sketches of specific features of the implant to help determine the proper selection. Because the imaging study is an enlargement of the actual anatomical structure, the user may select a different size or type of implant. This is because an implant selected by using the imaging study in the pre-operative implant selection may not be the proper size implant for the patient because the imaging study is typically an enlarged image of the anatomical structure. This method produces an estimation of the proper implant size and a location of placement in the patient. The manual implant selection process also provides estimates of the instruments required for the operation as well as the complexity of the operation. This manual implant selection process is labor intensive and is highly dependent upon user skill. As a result, the inaccuracy often causes improper implant selection.

One solution to the implant selection process is to utilize implant templates to place over the images. Implant templates may reduce the sketching required by the user. However, utilizing implant templates is still labor intensive, dependent upon user skill and produces inaccuracies. The inaccuracies are because the templates come in fixed sizes. Template producers may factor in some image enlargement. Therefore, the templates may be larger than the implant's actual size. However, these templates are typically enlarged by predetermined amounts. Therefore, the templates may not accurately compensate for enlargement on each imaging study.

Other solutions try to address the problem where imaging studies may have a different amount of enlargement from another imaging study by utilizing a digital template overlay. A digital template overlay is where a hard copy of an imaging study can be placed in a specialized type of light box. The imaging study then has a clear display placed over top. The clear display is then utilized to display digitized templates and template tools. These solutions provide enlarged digital templates that allow the user to try and match the template and the image to the same scale ratio. However, different imaging modalities and methods may magnify images to different degrees, and therefore a direct comparison between the image and the implant template is not always possible. Analyzing images taken with varying degrees of magnification can make template selection for such images difficult. As a result, the user may need to make an estimate of the enlargement required for the template.

These solutions suffer from additional shortcomings such as not being able to provide sufficient backlight as to allow proper viewing of the film. If the backlighting is increased, the digital display may become difficult to see. Moreover, because these solutions rely on a digital image and a hard copy of the imaging study, it is difficult to allow the two images to interact with each other. Moreover, because these solutions use a display over a hard copy of and imaging study, there is some distance between the film and the display. The angle at which one looks at the screen can result in variations in the way overlaid images are matched to the film residing behind the screen. Such solutions create inaccuracies, especially when very minute discrepancies in measurements can be very significant with respect to analyzing patient films and selecting of implants.

Other solutions use calibration or magnification markers with known measurements and affix these markers along side the patient in the image field. These images can be measured on the film, compared to the actual image size and the magnification level can be determined. Knowing the magnification of the imaging study, the template image can be adjusted to match the image magnification. However, using the markers to determine the magnification level of an imaging study is not perfect. The markers are not always present in an imaging study. Therefore, determining the magnification level of an imaging study using a marker is difficult. An additional problem with using markers is that the markers are not always placed at the proper position in the imaging field, and therefore, while the marker magnification can be determined, the actual patient image magnification is not accurately determined.

Because many of the conventional methods of implant selection are imprecise, the pre-operative implant selected is often different from the actual implant used. When an implant is selected, the physician is often provided with multiple variations of the selected implant. Having multiple variations of the selected implant requires the hospital, surgery center, implant vendor, distributor and/or manufacturer to maintain a large inventory of implants of multiple variations and sizes. Providing the multiple implants is because until the actual operation, implant selection is difficult. If proper inventory is not maintained, the proper implant may not be available to the physician during the operation. Accordingly, current implant selection and implant ordering systems and methods result in extra inventory for the vendors, manufacturers, hospitals and the like. The extra inventory is costly and occupies space.

Many conventional inventory tracking systems and methods do not efficiently provide tracking of implant inventory at the operative site and the vendor and/or manufacture site. Moreover, many conventional inventory systems fail to provide an analysis of the pre-operative selection as compared to the post-operative utilization of an implant. The analysis can be extremely helpful to a surgeon, as it would allow them to refine intra-operative decisions about instrumentation and implant surgical technique relative to pre-operative plans. Further, as this process of accurate planning and intra-operative technique is iteratively improved through consistent method usage, predictive implant size and position decisions become more accurate. Such information can be extremely helpful to a vendor or manufacturer of implants, as it would allow them to better predict the required inventory necessary to keep on hand, as well as what implant selections would be best selected to have in the operative suite during a surgery to account for measurement error.

Accordingly, if physicians and implant vendors and manufactures were able to determine the precision to which prosthesis selections were determined, a physician would be able to take fewer numbers of implants into the operating suite. Accordingly, the inventory kept on hand could be reduced because fewer numbers of different implants would be required for a selected implant procedure.

### SUMMARY

The present disclosure utilizes a high-performing digital medical imaging platform that allows for the elimination of film, chemicals, and processing which can increase workflow efficiency and staff productivity, and provides significant cost savings. With digital imaging, the entire process of managing medical imaging studies is optimized, from image acquisition, viewing and analysis, and archiving to pre-operative digital templating and planning. It should be understood that the term imaging study or imaging studies is not limited to just imaging study or imaging studies, but is provided as an example of any type of information that may be associated with system 100. For example, the type of information associated with system 100 may include medical imaging studies, video files, word documents, sound recordings, drawings and the like.

Eliminating the need to physically access medical imaging studies in hard copy also allows an orthopedic practice to cover more patients from a much wider geographic area. Digitizing imaging studies enhances workflow and staff flexibility by allowing the review of a patient medical image on any workstation, regardless of where the examination was performed, enabling access and view of any image, any time, anywhere.

In accordance with the present disclosure, image acquisition is improved as the system more fully integrates a practice management system (“PMS”) to provide automated entry of a patient's demographics into the imaging study to reduce the error associated with manual entry. This is accomplished by allowing a practice server to communicate with the PMS and create a listing of the patients and their demographic information. The list is then made accessible to an imaging modality at a practice site to allow a technologist to select a patient and have the imaging modality automatically enter the patient's demographic information into the imaging study. This can reduce user error, increase efficiency and reduce lost or misplaced imaging studies.

In an embodiment, imaging study archiving is improved by utilizing local and remote storage to maintain compressed and uncompressed imaging study. Uncompressed file formats include any uncompressed file format as well as uncompressed digital medical imaging studies such as DICOM compliant imaging study. One skilled in the art should also readily recognize that DICOM compliant imaging studies are not limited to those imaging studies compliant with DICOM protocols, but also those imaging studies that are compliant with digital imaging in medicine protocols. The practice site maintains a complete archive of all imaging studies in a compressed file format that is immediately accessible, such as JPEG, JPEG 2000, PNG, GIF, XBM, BMP, TIFF and other similar compression formats. The practice site also maintains an archive of the uncompressed imaging studies. Depending upon the amount of imaging studies contained within the system, the duration of storage of the uncompressed imaging studies can vary. However, all uncompressed imaging studies are remotely backed up, and are readily accessible. This allows access to the uncompressed information even after it has been deleted at the practice site, as well as provides a remote backup for all imaging studies. An advantage of compressing the imaging studies and maintaining a copy of all imaging studies at the practice site is that practice site is not dependent upon an Internet connection to retrieve and review imaging studies. Another advantage is the time to load the compressed imaging studies is less than the time to load the uncompressed imaging studies, thereby allowing the user to be more efficient.

In an embodiment, communications between affiliated practice sites is improved. The system allows the servers at affiliated practice sites to communicate and exchange the listing of imaging studies available at a practice site. Thus, this system is advantageous in that it can allow the user to view one list and know what imaging studies are available throughout the practice. Another advantage of this system is it allows the user to remotely gain access to a server to view any imaging study they have authority to view. This allows the user to be more efficient in that, they are not required to go to a practice location to view an imaging study that might require immediate attention.

In an embodiment, the distribution of imaging studies is improved with the use of a today list of imaging studies. When a newly acquired imaging study is obtained by the system, the archives are scanned for prior imaging studies for the same patient. This allows a list to be presented to a user that includes the newly acquired imaging study and all historical or prior available imaging studies. The imaging studies presented to the user are readily available for the user to review. This list allows a physician to more efficiently utilize their time, as they would not need to spend time searching for and retrieving prior imaging studies.

In an embodiment, distribution of imaging studies to computing devices and various users is improved. Because imaging studies are maintained at the practice site, the information does not need to travel over the Internet when the user requests a specified imaging study. Such transmission can slow or prevent imaging studies from being delivered efficiently. The system enables an authorized user to grant access to new or other users to specified imaging studies. This method does not require the user to email, download or prepare a hard copy of an imaging study or other information in order to share an imaging study with others. The user can log onto the system to be provided with access to any imaging study they have authority to view. This allows users such as unaffiliated physicians and implant vendors the ability to quickly and efficiently obtain access to the imaging studies.

In an embodiment, the ability to compare imaging studies is improved as the system provides an improved method to view and compare multiple digital imaging studies at the same time. The system allows a user to select particular locations on an imaging study. The user can then select the corresponding locations on each additional imaging study. Once the locations are selected, the computing device, utilizing software to facilitate an analysis, can compare the selected locations in one imaging study to that in the additional imaging study. The comparison of imaging studies allows the user for example, to select locations in one imaging study that may reflect the position of an implant after an operation. The user can select corresponding locations in a second imaging study from the first imaging study. The second imaging study, may for example, reflect the position of the implant after the patient had an accident. Thus, the analysis provided by the computing device can compare the locations of the selected points before and after the patient had the accident. Accordingly, this analysis may provide information to the user on whether the implant moved and if so, by how much. This can be advantageous in determining whether a patient requires surgery to correct the implant.

In an embodiment, the ability to pre-operatively select an implant is improved. The system calculates the actual enlargement of the shadow image as compared to the anatomical size, based upon the distance from the radiation source to the cassette film and between the anatomical part and the cassette film. The system then calibrates the image to the actual anatomical size. This allows the user to utilize the actual implant templates without having to readjust or make modifications. Thus, this is advantageous because by utilizing anatomical imaging studies and implant templates, the user can more accurately perform pre-operative implant selection.

By providing greater precision with pre-operative implant selection, the user requires fewer implant variations to be available during the operation. Thus, inventory levels are not required to remain as high to provide for uncertainties in pre-operative implant selection.

Additionally, where an implant vendor, manufacturer and/or distributor are able to determine levels of precision of pre-operative implant selection and monitor inventory levels across the system, they are able to better predict their inventory and supply requirements. Being able to reduce on hand inventory supplies eliminates costs by requiring less financial resources to be tied up in inventory and warehousing of the inventory.

### BRIEF DESCRIPTION OF THE FIGURES

FIG. 1 is a block diagram of a medical information and management information communications system.

FIG. 2 is a block diagram showing one example of a personal computing device and vendor computer.

FIG. 3 is a block diagram showing one example of a server.

FIGS. 4A-D are flow diagrams showing one example generally of a method of acquiring patient information, an imaging study and the storing and transmitting of the imaging study on the uncompressed information server.

FIG. 5 is a flow diagram showing one example generally of a method of acquiring an imaging study and the storing and transmitting of the imaging study on the secure web server.

FIG. 6 is a flow diagram showing one example of a maintenance routine of the uncompressed information server.

FIG. 7 is a flow diagram showing one example of a daily imaging list being created.

FIG. 8 is a flow diagram showing generally a method of rules to be processed by the uncompressed information server and/or the secure web server.

FIG. 9 is a flow diagram showing one example of imaging studies being stored and processed by the remote backup server.

FIGS. 10A-D are flow diagrams showing one example of imaging studies being stored and processed by another remote backup server, the production server, the clinical research server and the individual server.

FIGS. 11A-C are flow diagrams generally showing methods of accessing imaging studies at a practice from a personal computing device.

FIG. 12 is a flow diagram showing one example of a method of providing warnings to the user viewing medical images.

FIG. 13 is a flow diagram showing one example of granting access to an imaging study to a new or other user.

FIG. 14 is a flow diagram showing one example of a method of using and billing for add-on services.

FIG. 15 is a flow diagram showing one example of a method of creating and copying CD imaging studies.

FIG. 16 is a flow diagram showing one example of selecting and templating an imaging study.

FIG. 17 is a flow diagram showing one example of recording the templating information, verifying inventory and communicating with an implant vendor.

FIG. 18 is a flow diagram showing one example of a method of performing post-operative implant selection and inventory analysis.

FIG. 19 is a flow diagram showing one example of a method of comparing imaging studies and/or analyzing an implant already placed in a patient.

FIG. 20 is a screen shot illustrating one embodiment of accessing imaging studies from a portable computing device.

FIG. 21 is a screen shot illustrating one embodiment of a web interface for adding patients to a worklist.

FIG. 22 is a screen shot illustrating one embodiment of the daily imaging list.

FIG. 23 is a screen shot illustrating one embodiment of a web interface applet providing access to the system.

FIGS. 24, 25, 26, 27 and 28 are screen shots illustrating various embodiments of listing imaging studies.

FIGS. 29, 30, 31, 32, 33 and 34 are screen shots illustrating various points in the course of creating and copying CD imaging studies.

FIG. 35 is a screen shot illustrating one embodiment of calibrating a display.

FIGS. 36, 37, 38, 39, 40, 41, 42, 43, and 44 are screen shots illustrating various menu options available while displaying imaging studies.

### DETAILED DESCRIPTION

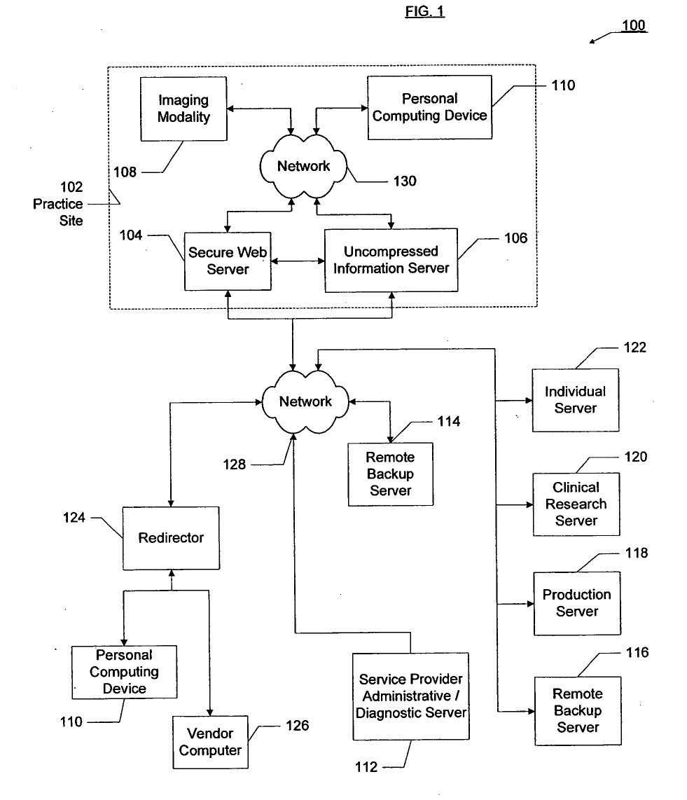

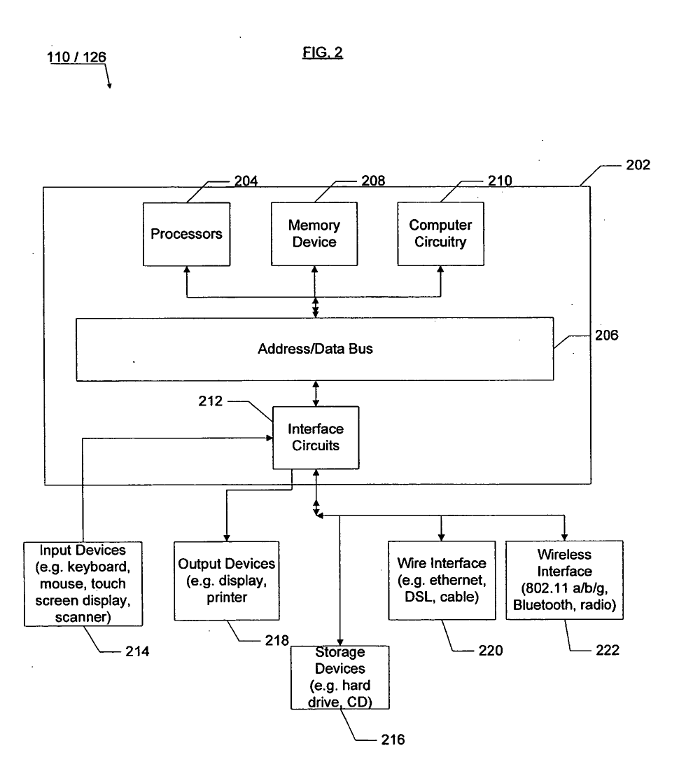

A high level block diagram of an exemplary network communications system 100 is illustrated in FIG. 1. The illustrated system 100 includes one or more practice sites 102, with one or more secure web servers 104, one or more uncompressed information servers 106, one or more imaging modalities 108 and one or more personal computing devices 110. Each of these devices may communicate with each other via a connection to one or more communications channels 130 such as a network. The network 130 may be any type of suitable network, such as a LAN, WAN and/or the Internet. Additionally, the illustrated system 100 includes one or more service provider and administrative and diagnostic servers 112 remote backup servers 114 and 116, one or more production servers 118, one or more clinical research servers 120, one or more individual user servers 122, and one or more redirectors 124. The system 100 may also include vendor computers 126. Each of these devices may communicate with each other via a connection to one or more communications channels 128 such as a network. The network 128 may be any type of suitable network, such as those types of networks suitable for network 130.

To connect practice site 102 to the internet and allow remote access along with converting and storing uncompressed and compressed imaging studies, a secure web server 104 may be used. A secure web server 104 is a computing device with a large storage capacity that is located at practice site 102. The secure web server 104 communicates with the uncompressed information server 106, the imaging modality 108 and the personal computing devices 110 via the network 130. The secure web server 104 also communicates with personal computing device 110 outside of practice site 102, along with a vendor computer 126 via network 128 and a redirector 124. Secure web server 104 may also communicate with a service provider administrative and diagnostic server 112, a remote backup server 114, a production server 118, a clinical research server 120 and an individual server 122 via network 128. The secure web sever 104 will be further described below as it relates to other components of system 100.

To store uncompressed imaging studies and provide intranet functionality to network 130 at practice site 102, an uncompressed information server 106 may be used. By storing uncompressed imaging studies at the practice site 102, the user may view and utilize imaging studies that have not been altered. An uncompressed information server 106, like the secure web sever 104, is a computing device with a large storage capacity that is located at practice site 102. The uncompressed information server 106 communicates with the secure web server 104, imaging modality 108 and personal computing device 110 via the network 130. The uncompressed information server 106 also communicates with the service provider administrative and diagnostic server 112, a remote backup server 114, a production server 118, a clinical research server 120 and an individual server 122 via network 128. The uncompressed information server 106 will be further described below as it relates to the other components of system 100.

To allow for images to be generated and uploaded onto system 100, an imaging modality 108 may be used. An imaging modality 108 is an imaging machine or image reader, than can provide an uncompressed imaging study to the uncompressed information server 106 and/or the secure web server 106. The imaging modality is preferably located at practice site 102, but can be located in a different facility or office site from practice site 102. The imaging modality 108 may include digital radiology (“DR”) and computed radiology (“CR”) devices. DR devices combine the imaging device and image processing device into one unit, while CR utilizes separate, more conventional imaging devices and separate image readers to process the image. Additional examples of imaging modality 108 may include MRI's, CT scanners, X-Ray devices, ultrasound, fluoroscopy, mammography and nuclear devices, as well as the image and cassette reading devices. The imaging modality 108 will be further described below as it relates to other components of system 100.

To allow the user to access system 100, review images, order add-on services and the like, a personal computing device 110 may be used. A personal computing device 110 is a computing device with storage capacity, processor capacity, networking capacity, display capacity and the like that is located in any place where a physician may want to have access to their data. A personal computing device may be located at practice site 102, an affiliated or unaffiliated practice site 102, at a site other than practice site 102, such as in a home or on somebody as a personal and portable computing device. An example of a screen shot of accessing the system from a portable computing device is shown FIG. 20. The personal computing device 110 communicates with the uncompressed information server 106 and secure web server 104 at practice site 102 via the network 130. The personal computing device 110 at practice site 102 may communicate with other affiliated secure web servers 104 at other practice sites 102, along with the production server 118, the clinical research server 120 and the individual server 122 via the network 128. Additionally, personal computing device 110, when located at an unaffiliated practice site 102 or located at a site other than practice site 102, communicates with secure web servers 104 via redirector 124 and network 128. Communications to the production server 118, clinical research server 120 and the individual server 122 are available through secure web server 104, uncompressed information server 106, network 128 and redirector 124. The personal computing device 110 will be further described below as it relates to other components of system 100.

To monitor and diagnose problems of the uncompressed information server 106 and the secure web server 104 at practice site 102, along with providing administrative functions to system 100, a service provider administrative and diagnostic server 112 may be used. A service provider administrative and diagnostic server 112 can automatically respond to problems within system 100. In addition, where service provider administrative and diagnostic server 112 cannot automatically correct or properly respond to problems within the system 100, the service provider administrative and diagnostic server 112 can alert a support technician that a problem exists. The service provider administrative and diagnostic server 112 may inform the support technician where the problem is located and what the problem is.

The service provider administrative and diagnostic server 112 may further allow the support technician to gain access to the computing device where the problem has occurred. The service provider administrative and diagnostic server 112 thereby allows for automatic and manual remote trouble shooting for problems occurring within system 100. The service provider administrative and diagnostic server 112 is a computing device with a large storage capacity that is typically not located at practice site 102. Preferably, the service provider administrative and diagnostic server 112 is located at a central site. The service provider administrative and diagnostic server 112 communicates with the uncompressed information server 106 and secure web server 104, along with other servers on system 100 to monitor and diagnosis problems that may arise with the hardware and/or software. Service provider administrative and diagnostic server 112 also may connect with the various servers on system 100 to monitor and update user defined information such as available users, user preferences and service utilization. The service provider administrative and diagnostic server 112 is described below in further detail.

To prevent a disaster from destroying the data at practice site 102 and to provide for long term data backup, a remote backup server 114 may be used. A remote backup server 114 is a computing device with a large storage capacity that is not located in the same facility as the practice site 102. The remote backup server 114 stores a copy of the uncompressed imaging study. As a result, the secure web server 104, and the uncompressed information server 106 need not maintain a copy of all uncompressed imaging studies. Therefore, the secure web server 104 and the uncompressed information server 106 need relatively less storage capacity. The remote backup server 114 communicates with the uncompressed information server 106, secure web server 104, the service provider administrative and diagnostic server 112 and remote backup server 116 via network 128. The remote backup server 114 will be further described below as it relates to other components of system 100.

To provide additional security and protection of practice site 102's data, another remote backup server 116 may be used. The remote backup server 116 stores a copy of all uncompressed imaging studies. As a result, a redundant backup of all uncompressed imaging studies are maintained. The remote backup server 116 is a computing device with a large storage capacity that is not located in the same facility as practice site 102 or at the same facility as remote backup device 114. The remote backup device 116 may be used to provide redundancy in data storage and backup. Remote backup server 116 communicates with remote backup server 114 via network 128. The remote backup server 116 will be further described below as it relates to other components of system 100.

To provide additional services not available at practice site 102, a production server 118 may be used. A production server 118 is a computing device such as a server with a large storage capacity that may contain software applications to provide information to the user based upon an imaging study. The production server 118 allows services to be rendered in relation to an imaging study without requiring the user to transmit the imaging study to the production server 118. In addition, because the production server maintains copies of all imaging studies in compressed and/or uncompressed format, the production server 118 does not need to retrieve a copy of the imaging study from another server or access a backed copy of the imaging study. The production server 118 also provides a method of recording all user requests for services and billing the user for those services performed. The production server 118 communicates with the remote backup server 114, personal computing device 110, secure web server 104 and uncompressed information server 106 via the network 128. The production server 118 will be further described below as it related to other components of system 100.

To provide the research and educational community with additional medical images and imaging studies, a clinical research server 120 may be used. A clinical research server 120 is a computing device with a large storage capacity that contains various imaging studies. The clinical research server 120 removes all PHI from the imaging studies in order to comply with HIPAA requirements. Therefore, the clinical research server 120 allows users to view an imaging study without revealing the PHI of a patient. The clinical research server 120 communicates with the remote backup server 114 and the personal computing device 110 via the network 128 and/or redirector 124. The clinical research server 120 will be further described below as it relates to other components of system 100.

To provide individual physicians and patients with the ability to separately store and access all their imaging studies together in one central server, an individual server 122 may be used. An individual server 122 is a computing device with a large storage capacity that allows users to have imaging studies stored on a remote server, categorized by the individual user. The individual user can utilize the individual server 122 for example, as their practice site 102, as an additional backup server, and/or to keep all related imaging studies in one location. The individual server 122 communicates with the remote backup server 114 and personal computing device 110 via the network 128 and/or the redirector 124. The individual server 122 will be further described below as it relates to other components of system 100.

To allow a vendor computer 126 and personal computing devices 110 that are located at unaffiliated practice sites 102 or at sites other than practice site 102, to have access to the secure web sever 104, a redirector 124 may be used. A redirector 124 is a computing device such as a server that may contain a software application that intercepts requests for remotely provided services, such as imaging studies in server shares, and sends the request to the appropriate computer on the network. The redirector 124 communicates with personal computing device 110, vendor computer 126, secure web server 104, production server 118, clinical research server 120 and individual server 122 via network 128.

To allow a vendor or manufacture to access system 100, receive patient information regarding an implant and monitor prosthesis inventory and the like, a vendor computer 126 may be used. A vendor computer 126 is a computing device with storage capacity, processor capacity, networking capacity, display capacity and the like that is located in any place where a vendor and/or manufacturer may want to have access to the data. The vendor computer 126 allows a user, such as the implant vendor and/or manufacturer representative to access imaging studies, pre-operative template analysis and the like from a practice site 102. The vendor computer 126 may be located in any place were a vendor and/or a manufacturer is located to provide for electronic ordering, data analysis, and inventory and materials monitoring. The vendor computer 126 communicates with secure web server 104 at practice site 102 via redirector 124 and network 128. The vendor computer 126 will be further described below as it relates to other components of system 100.

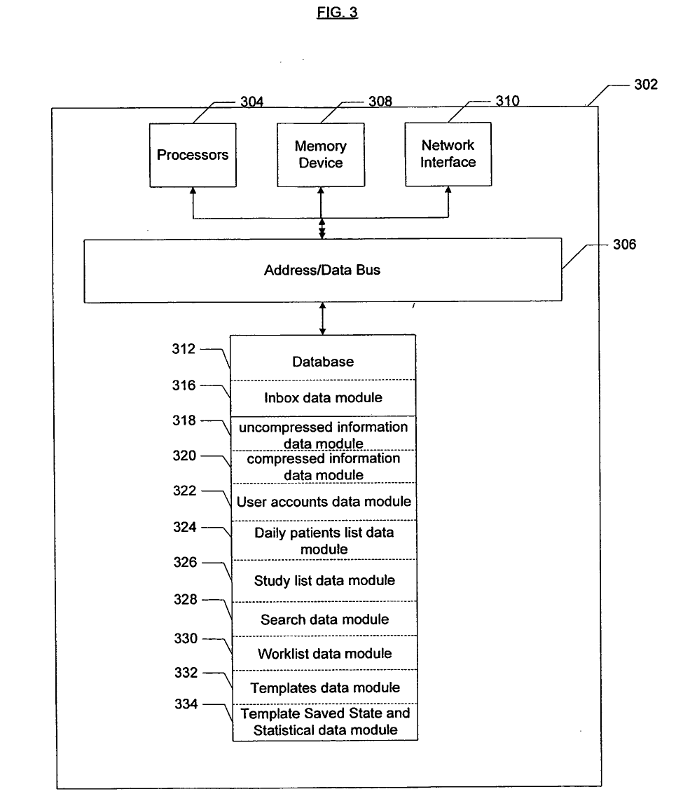

A more detailed block diagram of a personal computing device 110 and vendor computer 126 is illustrated in FIG. 2. The personal computing device 110 and the vendor computer 126 may include a controller or any other suitable device. The personal computing device 110 and the vendor computer 126 include a main unit 202 which preferably includes one or more processors 204 electrically coupled by an address/data bus 206 to one or more memory devices 208, other computer circuitry 210, and one or more interface circuits 212. The processor 204 may be any type of suitable processor. The memory 208 preferably includes volatile memory and non-volatile memory. Preferably, the memory 208 runs and/or stores a software program, such as an application or applet that interacts with the other devices in the system 100 as described below. This program may be executed by the processor 204 in a conventional manner. The memory 208 may also store digital data indicative of device settings, images, imaging studies, programs, web pages, protocols, etc. retrieved from a server 104, 106, 112, 114, 116, 118, 120 and 122 and/or from imaging modality 108.

The interface circuit 212 may be implemented using any suitable type of interface standard, such as a serial interface. One or more input devices 214 may be connected to the interface circuit 212 for entering data and commands into the main unit 202. For example, the input device 214 may be a keyboard, mouse, touch screen, track pad, track ball, isopoint, a voice recognition system, and/or any other suitable input device.

One or more storage devices 216 may also be connected to the main unit 202 via the interface circuit 212. For example, a hard drive, CD drive, DVD drive, and/or other storage devices may be connected to the main unit 202. The storage devices 216 may store any type of data used by the system 100.

One or more displays, printers, speakers, and/or other output devices 218 may also be connected to the main unit 202 via the interface circuit 212. The display 218 may be a cathode ray tube (CRTs), liquid crystal displays (LCD), or any other type of suitable display. The display 218 generates visual displays of data generated during operation of the personal computing device 110 and/or vendor computer 126. For example, the display 218 may be used to display medical images received from the secure web server 104 or the uncompressed information server 106. The visual displays may include prompts for human input, run time statistics, calculated values, data, etc.

The personal computing device 110 at practice site 102 may also exchange data with other network devices via a wired interface 220 and/or a wireless interface 222, such as an Ethernet connection, digital subscriber line (DSL), telephone line, coaxial cable, etc., or wireless modem, which connects to the secure web server 104 and/or uncompressed information server 106 over network 130, such as a LAN, WAN, extranet or through the Internet. Personal computing devices 110 and/or vendor computers 126 exchanging data over the Internet may need to connect through a redirector 124 or through another secure web server 104. Preferably, the personal computing devices 110 and vendor computers 126 include multiple modes of communication.

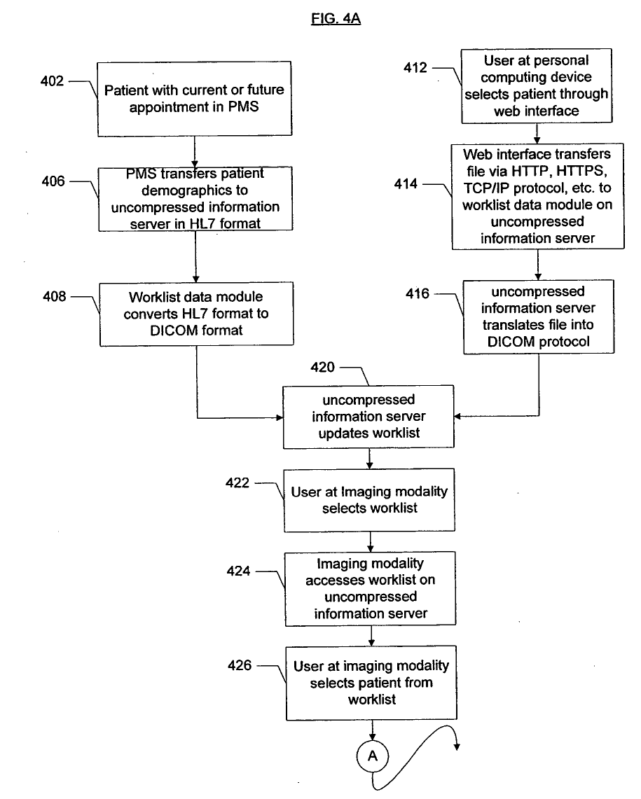

A more detailed block diagram of a server is illustrated in FIG. 3. Each server 104, 106, 112, 114, 116, 118, 120, 122 and 124 stores a plurality of imaging studies, programs, and/or web pages for use by the personal computing devices 110 and vendor computers 126. In particular, each secure web server 104 and uncompressed information server 106 hosts one or more programs designed to monitor and/or control a plurality of personal computing devices 110. For example, each secure web server 104 and uncompressed information server 106 is associated with a practice site 102.

One server 104, 106, 112, 114, 116, 118, 120, 122 and/or 124 may interact with a large number of personal computing devices 110, other servers 104, 106, 112, 114, 116, 118, 120, 122 and/or 124, imaging modality 108, redirector 124 and vendor computers 126. Accordingly, each server 104, 106, 112, 114, 116, 118, 120, 122 and 124 is typically a high end computer with a large storage capacity, one or more fast microprocessors, and one or more high speed network connections. Conversely, relative to a typical server 104, 106, 112, 114, 116, 118, 120, 122 and 124, each personal computing device 110 and vendor computer 126 typically includes less storage capacity and a single microprocessor. However, as described in detail in this disclosure, each personal computing device 110 and vendor computer 126 preferably supports multiple network connections and/or protocols.

Like the personal computing devices 110 and vendor computers 126, the main unit 302 in the server 104, 106, 112, 114, 116, 118, 120, 122 and 124 preferably includes a processor 304 electrically coupled by an address/data bus 306 to a memory device 308 and a network interface circuit 310.

The server 104, 106, 112, 114, 116, 118, 120, 122 and 124 may exchange data with other devices via a connection to the network 128 and/or the network 130. The network 128 and/or network 130 may be any type of network, such as a LAN, WAN, extranet and/or the Internet. The processor 304 may be any type of suitable processor, and the memory device 308 preferably includes volatile memory and non-volatile memory. Preferably, the memory device 308 stores computer code or a software program that implements all or part of the method described below. This program may be executed by the processor 304 in any suitable manner. However, some of the blocks described in the methods below may be performed manually or without the use of the servers 104, 106, 112, 114, 116, 118, 120, 122 and/or 124. The memory device 308 and/or a separate database 312 also store imaging studies, images, programs, web pages, etc. for use by other servers 104, 106, 112, 114, 116, 118, 120, 122 and/or 124, vendor computers 126, and/or personal computing devices 110.

Users of the system 100 may be required to register with the service provider administrative and diagnostic server 112. In such an instance, each user may choose the user identifier (e.g., username) and a password which may be required for access to the system, various access levels and access to the various add-on services. The user identifier and password may be passed across the network 128 and 130 using encryption. Alternatively, the user identifier and/or password may be assigned by the service provider administrative and diagnostic server 112.

More specifically, the memory device 308 and/or the database(s) 312, preferably include a plurality of modules 316-334 which determine the overall functionality of the server 104, 106, 112, 114, 116, 118, 120, 122 and/or 124. Each module includes a set of computer readable instructions and/or data which are related to a designated subject matter, topic or purpose. This type of modular construction of the server can be created using any suitable computer programming language and/or database, including, without limitation, JAVA, C++, SQL, etc. Although certain example modules 316-334 are described herein, it should be appreciated that the modules 316-334 of servers 104, 106, 112, 114, 116, 118, 120, 122 and/or 124 may be structured in other ways including as a single module. In such a case, the single module would have the functionality of the separate modules illustrated in FIG. 3. It should also be appreciated that modules 316-334 may not be present on each and every server 104, 106, 112, 114, 116, 118, 120, 122 and/or 124.

In the illustrated example, the database(s) 312 include an inbox data module 316, an uncompressed information data module 318, a compressed information data module 320, a user accounts data module 322, a daily patient list data module 324, a study list data module 326, a search data module 328, a worklist data module 330, a templates data module 332 and a template saved state and statistical data module 334.

To receive and process incoming imagining file associated with a server, an inbox data module 316 may be used. The inbox data module 316 is used to store incoming uncompressed and compressed imaging studies on servers 104, 106, 112, 114, 116, 118, 120, 122 and/or 124. The inbox data module communicates with servers 104, 106, 112, 114, 116, 118, 120, 122 and/or 124, imaging modality 108 and personal computing device 110.

To receive, write, store and index uncompressed imaging studies, an uncompressed information data module 318 may be used. The uncompressed information data module 318 can maintain a list of all available uncompressed imaging studies available on the uncompressed information data module 318 on its respective server, all available compressed imaging studies on a compressed information data module 320 on another server, as well as all available uncompressed and compressed images available from other affiliated practice sites 102.

To receive uncompressed imaging studies and convert the uncompressed imaging studies to compressed imaging studies, a compressed information data module 320 may be used. The compressed information data module 320 may also write, store and index the compressed imaging studies. Compressed imaging studies are stored in smaller files than their uncompressed imaging study counterparts are. Thus, the compressed imaging study requires less storage for the same uncompressed imaging study. The compressed information data module 320 can maintain a list of all available compressed images available on its respective server, all available uncompressed imaging studies available on the uncompressed information data module 318 on the same server, in addition to all available compressed and uncompressed imaging studies available on secure web servers 104 from affiliated practice sites 102.

To maintain a list of registered users for a particular practice site 102, or for all practice sites 102, the user accounts data module 322 may be used. The user accounts data module 322 can store all user names, passwords, imaging studies accessible by a particular user name, access levels and user account history. The user accounts data module 322 can also store a list of practice sites 102 and secure web servers 104 that a particular username may access. The user accounts data module 322 may be updated by a practice site 102, or via the service provider administrative and diagnostic server 112. In an embodiment, uncompressed information server 106, secure web server 104 and redirector 124 all contain the same user information for each user name.

To view a list of all studies performed on the current day, along with all historical images for those particular patients, a daily patient list data module 324 may be used. For each server, the respective daily patient list data module 324 scans the uncompressed information data module 316 and/or the compressed information data module 318. The daily patient list data module 324 scans the data modules to find all imaging studies performed on the current day. The daily patient list data module 324 may then scan the uncompressed information data module 316 and/or the compressed information data module 318 of the same server to find all imaging studies matching a particular patient that had a scan on the current day. The daily patient scan data module 324 may then provide a list of patients who had studies performed on the current day, with an index of all their available imaging studies.

To provide faster and efficient access to a list of imaging studies according to pre-selected criteria, a study list data module 326 may be used. A study list data module 326 allows the user of the system to configure a study list, wherein the study list contains a listing of patients, imaging studies and other imaging studies that match pre-selected criteria. The study list data module 326 can be configured to scan all data modules at a practice site 102, all data modules at an affiliated practice site 102, selected data modules only and/or specific data modules based upon certain criteria. Thus, a study list data module 326 may contain a listing for each patient at a practice and any imaging study contained within the practice that meet certain criteria. Additionally, the study list data module 326 can be saved and regularly updated. For example, searches that are regularly run can be saved in the study list data module 326 and re-called. Creating and saving patient study lists based upon pre-selected criteria can save time for a user because they do not have to formulate and enter search criteria, nor do they have to wait for a search to run.

To allow the user to search all available directories for a particular file or imaging studies, a search data module 328 may be used. A search data module 328 may allow the user to enter some or all of the information related to an imaging study or imaging studies that the user is seeking. The search data module 328 can then search all available or selected locations for all matching imaging studies and return a list of the matching imaging studies to the user.

To allow a technologist or other user of the imaging modality 108 to have a list of all patients having a study performed, a worklist data module 330 may be used. A worklist data module 330 communicates with the PMS via a Health Level 7 (“HL7”) protocol. A HL7 protocol is a healthcare specific communication standard for data exchange between computer applications. The worklist data module 330 can then convert the HL7 data into DICOM compliant format to be available and accessible to the imaging modality 108. The worklist data module 330 can also communicate with a web interface using standard web protocol, such as HTTP, HTTPS, TCP/IP and the like to allow the user to select from a list of patients to add to the worklist data module 330. The worklist data module 330 can therefore contain a list of all patients scheduled for studies for the current day and all future days. For example, the worklist data module 330 can contain a list of all patients scheduled for studies sorted by patient name, ID number, day scheduled and the like. Once a patient is selected, the patient's demographic information is downloaded to the imaging modality 108 to be attached to the imaging study.

To maintain, store and index all available templates for use, a template data module 332 may be used. A template data module 332 maintains all the templates that are available for use by the user, vendor and/or manufacturer representative. The user may select a template and use the selected template on the imaging study, for example, to select the proper implant for a patient. The template data module 332 can contain all available templates. The templates may be searched and/or sorted based upon manufacturer, type (e.g. hip, knee, elbow, shoulder, spine, trauma, etc.), size and the like. Each type can also be sorted and/or searched by subcategory (e.g., hip may have the subcategories stem type, liners, acetabular, instrument type, etc.). Each subcategory may be further searched and/or sorted (e.g., stem type may have the subcategories cemented, porous, revision, etc.). It should be understood, that the search order for implant templates can occur in any arrangement. Accordingly, the user can start the search by selecting a hip implant, a size and then select a stem type. Such a selection may reveal a list of all available implant templates from all manufactures corresponding to a hip implant of a particular size with a particular stem type.

To allow the user to save a copy of an imaging study including any modifications, annotations, patient images overlaid with implant templates and/or evaluations of such imaging studies, a template saved state and statistical data module 334 may be used. A template saved state and statistical data module 334 allows the user to save working or modified imaging studies without overwriting, deleting, moving or otherwise affecting the original imaging study of a patient. For example, a user can provide annotated remarks, drawings, measurements, implant template images, markings, and the like on a patient image.

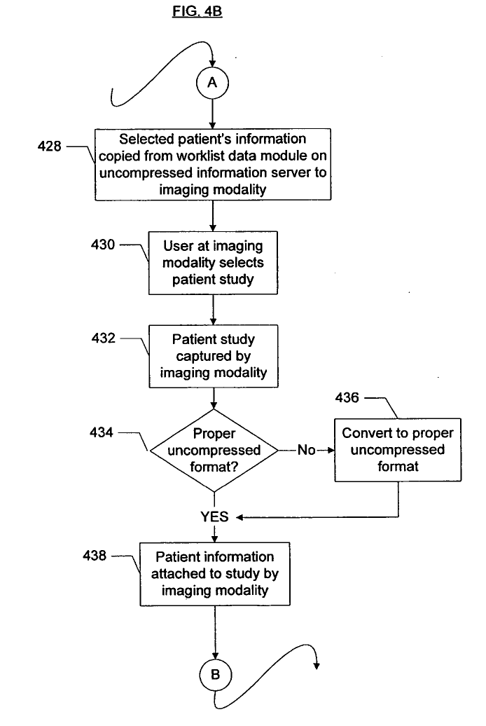

A more detailed flow diagram showing one example of a method of acquiring patient information at the imaging modality 108 is shown in FIG. 4A. The worklist data module 330 can be updated automatically or manually. At block 402, where practice site 102 contains a PMS, the practice is able to link the PMS with the system 100 to make certain patient information available to the system. This allows the user at the imaging modality 108 to select from a list of patients and have their information entered automatically by selecting the appropriate patient. Thus, the technologist or other user does not have to re-enter a patient's information manually. By not having the technologist re-entering the patient's information, the user can reduce the potential for mistakes or errors, such as associating the study with a different patient, no patient or a different study. The user of the PMS can also create appointments for the current day or future days, and order tests as in the ordinary practice.

Once the worklist data module 330 receives a new appointment from the PMS, at block 406, the worklist data module 330 retrieves the patient appointment, including the patient demographics, and imports the information via the HL7 protocol into the worklist data module 330.

At block 408, the patient demographics and appointment schedule are converted from HL7 to DICOM compliant format by the worklist data module 330. Then, at block 420, the worklist data module 330 on uncompressed information server 106 updates the worklist. Once the worklist is updated, it is readily available for the user or technologist to utilize.

Practice site 102 may also wish to update the worklist by use of a web interface. FIG. 21 shows one example of a web-interface according to the present disclosure. It should be appreciated that other suitable displays are available in accordance with the present disclosure. This is practical when a patient is added at the time of the appointment or where the PMS and the system 100 do not communicate. At block 412, the user at the personal computing device 110 can open up a web interface, such as Internet Explorer, Netscape Navigator, and the like. The user may be presented with a search command where some or all of a patient's information may be entered. For example, the user can search by a patient's first or last name, by birthday, patient ID number and the like. The web interface searches and returns all patients matching the search command. The user then selects the appropriate patient from the list.

At block 414, the web interface may then transfer the patient file utilizing standard web protocols. The imaging study is transferred to the worklist data module 330 on the uncompressed information server 106. As in the previous example, the worklist data module 330 converts the patient information into DICOM format. Then, in block 420, the worklist data module 330 on the uncompressed information server 106 updates the worklist. Once the worklist is updated, it is readily available for the user or technologist to utilize.

At block 422, the user or technologist at the imaging modality 108 can select an option to display the worklist. The imaging modality 108 then retrieves the worklist from the worklist data module 330 on the uncompressed information server 106 as indicated in block 424. The user can search for the patient by entering in some or all of the patient's information or by scrolling though the worklist by day as indicated in block 426. Once the patient is selected from the worklist, the imaging modality 108 can retrieve the patient's demographics, as indicated in block 428 in FIG. 4B. In an embodiment, the worklist data module 330 can push the patient demographics to the imaging modality 108.

A flow diagram showing one example of a method of acquiring an imaging study is shown in FIG. 4B. In blocks 430-438, the user can select an imaging study. The patient's images are then captured for the selected imaging study by the imaging modality 108 as indicated in block 432. Imaging modality 108 can prompt the user so the user may enter in any information that may be missing or unknown, such as the distance of the X-Ray source to the imaging plate, the distance from the part of the patient's body being imaged to the imaging plate, the body part being imaged, etc. The imaging modality can then check to verify that the imaging study is in the proper uncompressed format as indicated in block 434. If the imaging study is not in the proper uncompressed format, the imaging modality 108 can covert the patient's imaging study to the proper uncompressed format, as indicated in block 436. Once in the proper uncompressed format, the imaging modality can then attach the patient demographics to the imaging study, as indicated by block 438. Header fields in the imaging study may include, but are not limited to the patient name, patient ID, the patient date of birth, the patient sex, the study date, the study time, the specific imaging modality utilized, a study description, a study instance unique ID, the body area of the study, the radiation source to film distance, the body part to film distance, the institution taking the imaging study, the referring physician, the imaging modality manufacturer, the imaging modality serial number, the image number, the image slice number, the image slice location, the rows, columns, pixel spacing, window level, window width, series description, image position of patient, image orientation, frame reference unique ID, a study ID, an accession number, etc. Part of this information may be provided automatically by the imaging modality, while other information may be provided automatically by the system 100. The information may also be provided by a user of the system 100. Each field can be marked to indicate whether the field may contain PHI. Marking each field allows the system 100 to automatically determine whether the information in the field is to be redacted before certain types of users are presented with the information.

A flow diagram showing one example of a method to store and transmit an imaging study associated with the uncompressed information server 106 is shown in FIG. 4C. The inbox data module 316 stores uncompressed imaging studies on server 106 pushed from the imaging modality 108 as indicated in block 440. The imaging study in inbox data module 316 is available to be processed once its writing is complete. If writing to the inbox data module 316 is not successful, then the uncompressed information server 106 may be offline as indicated in block 458. If the uncompressed information server 106 is offline, the imaging modality 108 may detect that the uncompressed information server 106 is unavailable as indicated in block 460. This allows the user to determine whether the uncompressed information server 106 is performing routine maintenance or has a problem and needs to be serviced. The user at imaging modality 108 can then decide to re-attempt delivery to the uncompressed information server 106 as indicated in block 462. The user can also decide to send the imaging study to the secure web server 104 as indicated in block 464.

If the user selects to have the imaging modality 108 write the imaging study to the inbox data module 316 on the secure web server 104, as in block 464, the imaging modality 108 may be able to be configured to make additional attempts to write to the inbox data module 316 on the uncompressed information server 106. A more detailed description of the secure web server 104 is described below.

Referring again to block 442, if the imaging modality 108 successfully writes an imaging study to the inbox data module 318 on the uncompressed information server 106, then, in block 456, the user at imaging modality 108 can be notified and the uncompressed information server 106 can log the entry into the system log (“syslog”). The syslog is a collection of message logs from the systems and components of system 100 and/or the components at the practice site 102. Each system or component sends short text messages to a syslog recorder. The syslog recorder may record the message logs in any desired manner including writing the message logs to a file, sending the message logs on to other systems and/or printing the message logs out. Originally written for UNIX, the syslog has become a de facto standard for many network devices.

If the imaging modality 108 successfully writes an imaging study to the inbox data module 318 on the uncompressed information server 106, then inbox data module 316 on the uncompressed information server 106 also parses the header fields of the uncompressed imaging studies, as indicated in block 444. The inbox data module 316 then writes the imaging study and header fields to the uncompressed information data module 318 as indicated in block 446. The uncompressed information data module 318 utilizes the information parsed from the imaging study to create an index for the imaging study as indicated in block 448. The index entry is added to a list in the uncompressed information data module 318.

The uncompressed information data module 318 can then check whether processing rules related to the uncompressed imaging study exist as indicated in block 450. If there are rules for processing the uncompressed imaging studies, then those rules are processed. The rules are discussed in more detail below. After checking for processing rules, uncompressed information data module 318 may verify whether a matching imaging study exists on the secure web server 104 in the compressed information data module 320 as indicated in block 472 in FIG. 4D, or in the uncompressed information data module 318 on the remote backup server 114 as indicated in block 476. If the imaging studies do not exist, the uncompressed information data module 318 on the uncompressed information server 106 may push a copy of the imaging study to the inbox module 316 on each respective server.

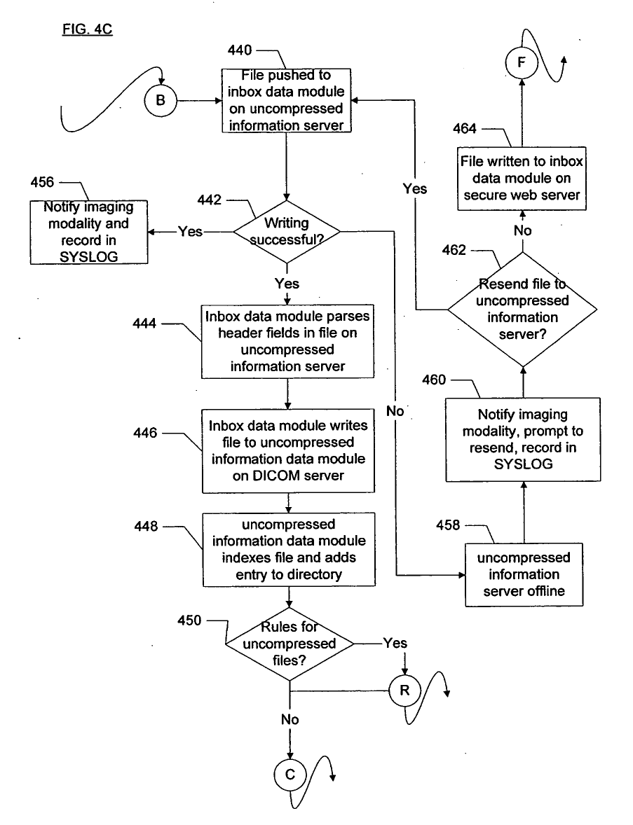

A flow diagram showing one example of a method to acquire, store and transmit an imaging study associated with the secure web server 104 is shown in FIG. 5. Imaging studies are written to the inbox data module 316 as indicated in block 502. The uncompressed information data module 318 and the compressed information data module 320 on the secure web server 104 can process the imaging studies written to the inbox data module 316.

The inbox data module 316 on the secure web server 104 parses the header fields of the uncompressed imaging study as indicated in block 504. The inbox data module 316 then writes the uncompressed imaging study to the uncompressed information data module 318 as indicated in block 506. Then the uncompressed information data module 318 utilizes the information parsed from the imaging study to create an index entry for the imaging study. The index entry is added to a list in the uncompressed information data module 318 as indicated in block 508. Additionally, a copy of the index entry is added to a list in the compressed information data module 320.

The uncompressed information data module 318 may verify whether a matching imaging study exists on other servers, as indicated in block 470. The uncompressed information data module 318 can check whether the imaging study exists on the uncompressed information server 106 in the uncompressed information data module 318 as indicated in block 474. The uncompressed information data module 318 can also check whether the imaging study exists in the uncompressed information data module 318 on the remote backup server 114 as indicated in block 476. If the imaging studies do not exist, the uncompressed information data module 318 on the secure web server 104 may push a copy of the imaging study to the inbox module 316 on each respective server.

The compressed information data module 320 processes the uncompressed imaging studies in the inbox data module 316. The inbox data module 316 parses out the header fields from the imaging study, as indicated by block 510 in FIG. 5. For example, the inbox data module 316 parses the patientID of the header fields to allow the imaging studies to be properly indexed in the list. The inbox data module 316 writes the imaging study to the compressed information data module 320 on the secure web server 104, as indicated in block 512. The compressed information data module 320 converts the uncompressed imaging studies into compressed format, where the compressed image is written to the compressed information data module 320 in place of the uncompressed imaging studies as indicated by block 514. The compressed image is then indexed, as indicated by block 516. The index entry may also be added to the study list data module 326 on the secure web server 104 and on the uncompressed information server 106. Accordingly, the uncompressed information data module 318 on the uncompressed information server 104 contains a list of all uncompressed imaging studies in the uncompressed information data module 318 on the uncompressed information server 106 and all compressed images in the compressed information data module 320 on the secure web server 104. The imaging studies on the secure web server 104 are now web accessible and available to be retrieved and viewed.

In block 520 in FIG. 5, the uncompressed information data module 318 and compressed information, data module 320 on secure web server 104 check for processing rules related to the uncompressed and/or compressed imaging study. If there are rules for the processing of the uncompressed and/or compressed imaging study, then those rules are processed.

In an embodiment, a medical practice may have a DICOM imaging network installed, such as a PACS network. Therefore, a practice may not want to incur the cost of changing the equipment to obtain some of the benefits of the present system. In addition, the practice may not want to give up it current equipment. Therefore, the practice may not want an uncompressed information server 106 at the practice. Accordingly, the system 100 can provide functionality to a practice where the practice only chooses to have the secure web server 104. The practice may therefore add the secure web server 104 to the existing DICOM imaging network. The network server handling the uncompressed imaging studies at the practice site can be modified to include additional rules. For example, a rule may be added to the existing network server to push all new uncompressed imaging studies to the inbox data module 316 on the secure web server 104. The secure web server 104 can then be modified to delivery similar functionality of the system 100 to the practice. The modification to the existing network server provides the practice with functionality similar to system 100 as described herein.

The uncompressed information data module 318 on the uncompressed information server 106 and on the secure web server 104 may be provided with pre-determined storage capacity. The pre-determined storage capacity on both servers may be the same or different. Based upon the pre-determined storage capacity, the uncompressed information data module 318 may reach the pre-determined capacity. If capacity is reached, then new imaging studies cannot be stored in the uncompressed information data module 318. To prevent reaching storage capacity, the uncompressed information data module 318 deletes imaging studies using a first in, first out (“FIFO”) protocol. However, imaging studies on the uncompressed information data module 318 may be deleted according to other protocols as discussed below.

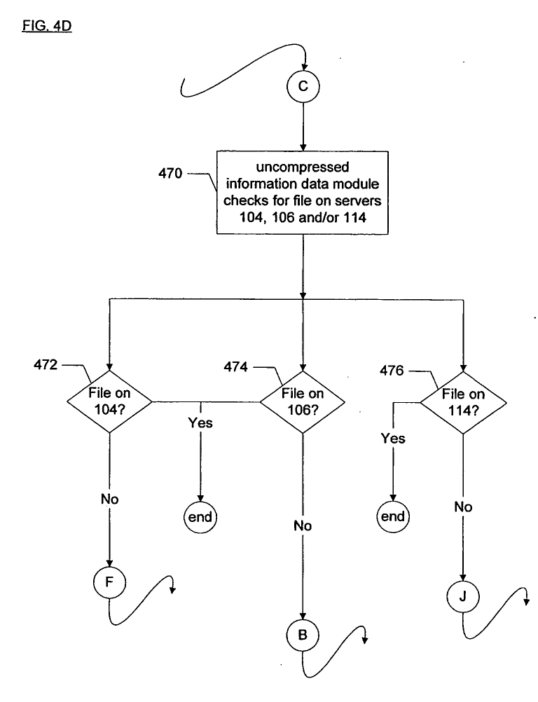

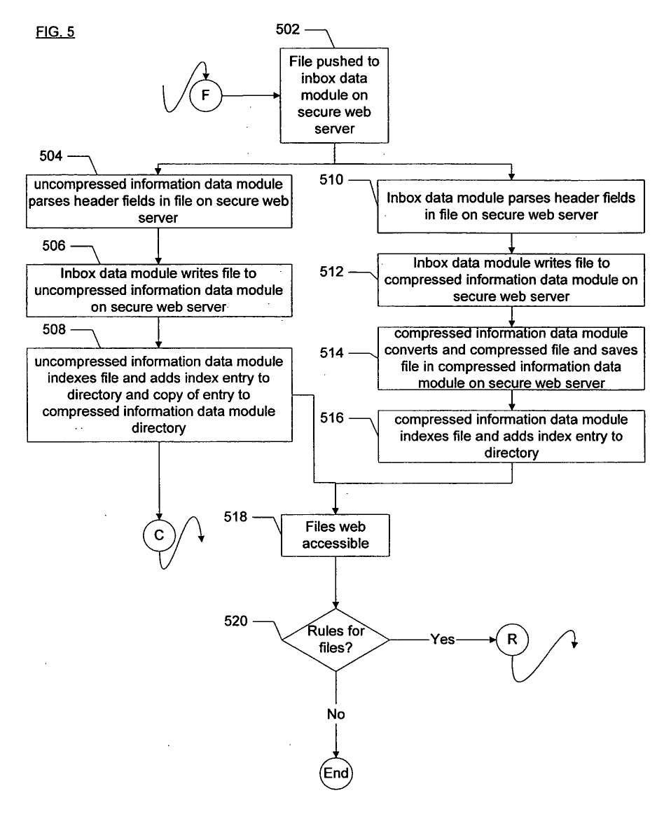

A flow diagram showing one example of a maintenance routine of the uncompressed information server 106 is shown in FIG. 6. As indicated by block 600, the uncompressed information server 106 may approach its capacity to store imaging studies. The user may choose to increase the capacity of the uncompressed information data module 318 by contracting for additional storage capacity as indicated by block 602. However, the user may not want to or need to increase the storage capacity of the uncompressed information data module 318. For example, a small practice may be able to retain years of data with the pre-determined storage capacity. Therefore, to ensure the functionality of the uncompressed information server 106, imaging studies are routinely deleted from the uncompressed information data module 318 to provide storage capacity for newer imaging studies. Selected imaging studies are deleted from the uncompressed information data module 318 on the uncompressed information server 106 when the stored amount of the saved imaging studies reaches a certain predetermined capacity or the high water mark. For example, the user can select 90% as the high water mark before the uncompressed information data module 318 on the uncompressed information server 106 begins to purge the old file as indicated by block 600. The user can select any level for the high water mark. This disclosure uses 90% only by way of example. Once the uncompressed information data module 318 on the uncompressed information server 106 reaches 90% capacity, the uncompressed information data module 318 selects the oldest study either by last accessed date or by date created, depending on the practice site's 102 specifications as indicated by block 606.

The uncompressed information data module 318 on the uncompressed information server 106 compares the selected study with the studies on the compressed information data module 320 on the secure web server 104 as indicated by block 608. As indicated by block 610, the uncompressed information data module 318 determines whether a correlating imaging study is found. If a selected imaging study from the uncompressed information server 106 correlates to an imaging study on the secure web server 104, then the uncompressed information data module 318 on the uncompressed information server 106 purges the selected imaging study in the uncompressed information data module 318 on the uncompressed information server 106 as indicated by block 612. After each imaging study is purged, the uncompressed information data module 318 checks the capacity level as indicated by block 614. If the capacity level reaches or is lower than a predetermined low water mark, then the uncompressed information data module 318 has finished purging imaging studies to ensure continued functionality as indicated by block 614. The predetermined low water mark, by way of example can be 70%. Thus, the uncompressed information data module 318 will continue to purge imaging studies until the capacity is less than or equal to 70% full.

The uncompressed information data module 318 may not find a correlating imaging study in the compressed information data module 320 on the secure web server 104 as indicated by block 610. If no correlating imaging study is found, then the uncompressed information data module 318 on the uncompressed information server 106 pushes a copy of the imaging study to the inbox data module 316 on the secure web server 104 as indicated by block 616. The imaging study is then processed by the inbox data module 316 on the secure web server 104 as detailed previously. Accordingly, the next time the imaging study is selected for purging from the uncompressed information data module 318 on the uncompressed information server 106, a correlating study will be found, and the imaging study will be purged from the uncompressed information data module 318.

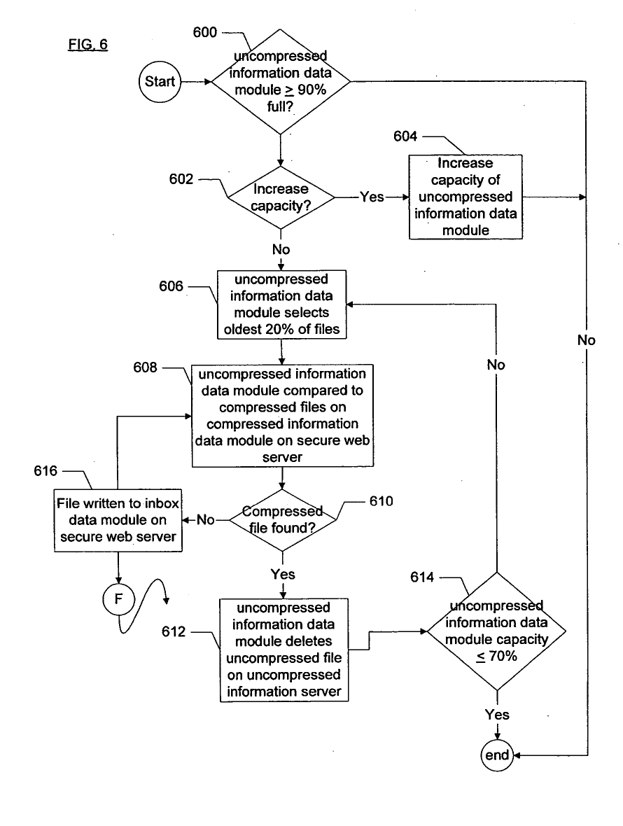

The user of the system 100 may want to access a list of imaging studies that were performed on the present day. Additionally, the user may want to be provided with a listing of imaging studies previously taken for a patient that had the imaging study taken on the present day. For example, a patient may present to a physician for follow up care after an implant as placed in the patient. The physician may request that an imaging study be performed. The physician may also wish to see imaging studies taken previously to allow comparison. Therefore, the physician may want to be provided with a list that contains the imaging study performed today and the available imaging studies previously performed. A flow diagram showing one example of a daily imaging list being created is shown in FIG. 7. In block 700, the daily patient list data module 324, the secure web server 104 and the uncompressed information server 106 can regularly scan the uncompressed information data module 318 and the compressed information data module 320 to search for imaging studies with a study date of the current day. At block 702, the daily patient list data module 324 determines whether a new imaging study exists. For each file found in the respective data module, an entry is created correlating to the new imaging study as indicated by block 704. At block 706, the entry is added to the today list of patient imaging studies. This process creates a list of all patients with a study date of the current day, therefore providing a list of that day's imaging studies.

The daily patient list data module 324 further includes a list of prior imaging studies for a patientID of each imaging study with a study date of the current date. The daily patient list data module 324 parses the patientID from the imaging study with a study date of the current day as indicated by block 708. Using the patientID, the daily patient list data module 324 on the uncompressed information server 106 searches the study list data module 326 on the uncompressed information server 106 as indicated by block 710. At block 712, the daily patient list data module 324 determines whether a matching imaging study is found. For each imaging study found, the daily patient list data module 324 adds an entry to the today list for the particular patientID as indicated by block 714. A listing of all historical imaging studies for a particular patient is then created as indicated by block 716. In an embodiment, the user can specify that the daily patient list data module 324 may limit the historical imaging studies to a predetermined number. The daily patient list data module 324 on the secure web server 104 operates substantially similar to the daily patient list data module 324 on uncompressed information server 106 as described above. However, the daily patient list data module 324 on the secure web server 104 searches both the uncompressed information data module 318 and the compressed information data module 320 on the secure web sever 104. The daily patient list data module 324 continues to scan the study list data module 326 until no more matching imaging studies are found for a particular patientID. The daily patient list data module 324 on the secure web server 104 contains a list of all imaging studies with a study date of the current day and imaging studies on the compressed information data module 320 and uncompressed information data module 318 on the secure web server 104. The daily patient list data module 324 on the uncompressed information server 106 contains a list of the imaging studies on the compressed information data module 320 on the secure web server 104 and the uncompressed information data module 318 on the uncompressed information server 106.

In an embodiment, the daily patient list module 324 can scan the respective servers at affiliated practice site 102. By scanning the server at an affiliated practice site 102, the user can have a listing of all imaging studies performed on that day and their historical imaging studies existing at each practice site 102.

To provide a list of all patients and a list of all imaging studies on the uncompressed information server 106 and the secure web server 104 existing at practice site 102 and all affiliated practice sites 102, a study list data module 326 may be used. The study list data module 326 can be configured to scan all data modules at a practice site 102, all data modules at an affiliated practice site 102, selected data modules only and/or data modules based upon certain criteria. Thus, a study list data module 326 may contain a listing for each patient at a practice and any imaging study contained within the practice that meet certain criteria. The study list data module 326 can be configured to function in a similar manner as the daily patient list data module 324. The study list data module can additionally be configured by other criteria, such as physician, primary practice office, pre/post/non-operative and the like. The lists generated by the study list data module 326 are different from lists generated by the search data module 328 to be discussed below. The study list data module 326 provides the user with a list that is created using pre-selected user defined search criteria. The list created by the study list data module 326 can be automatically updated by the system 100. For example, searches that are regularly run can be saved in the study list data module 326 and retrieved as needed. The list created by using pre-determined search criteria can save time for users because the user does not have to formulate and enter search criteria each time the user want to runs view a particular list. The search list data module 326 can increase efficiency as the user does not have to wait for a search to run.

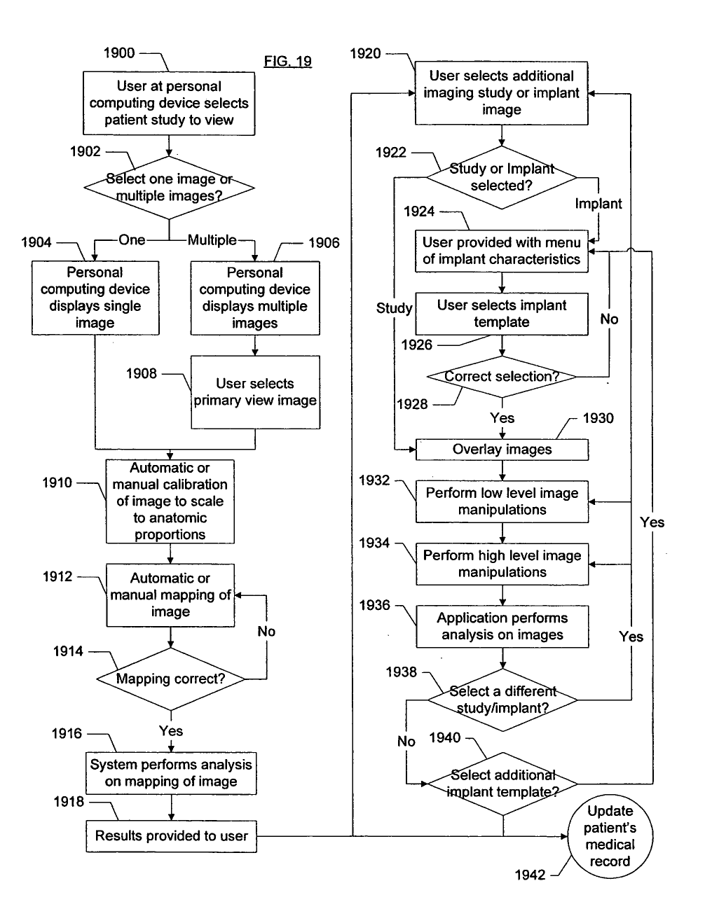

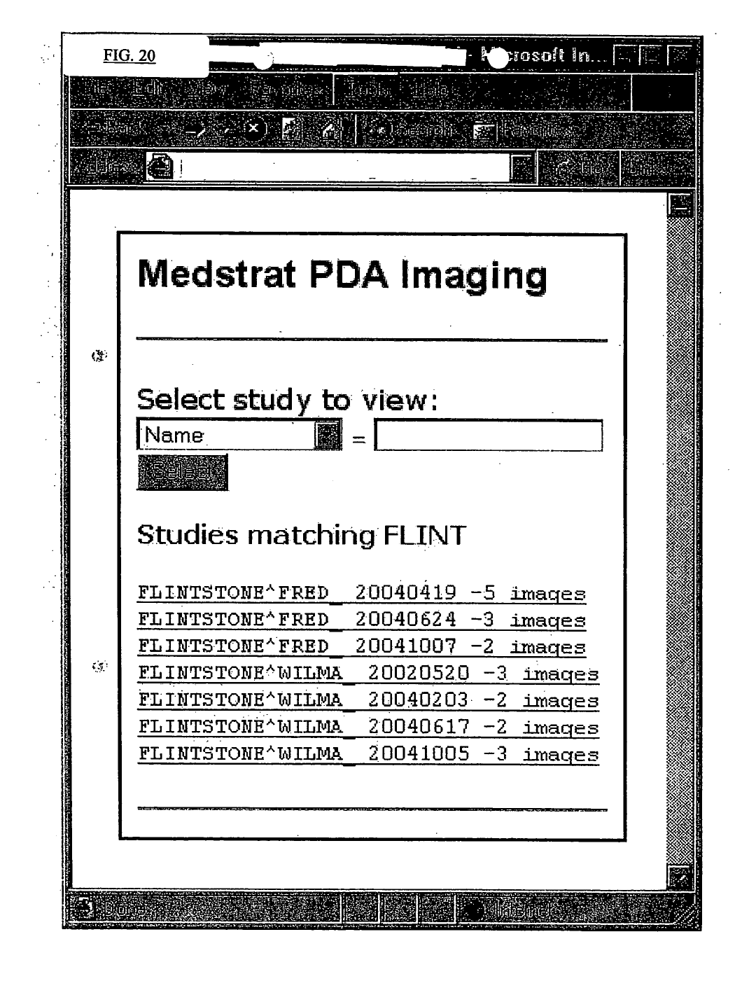

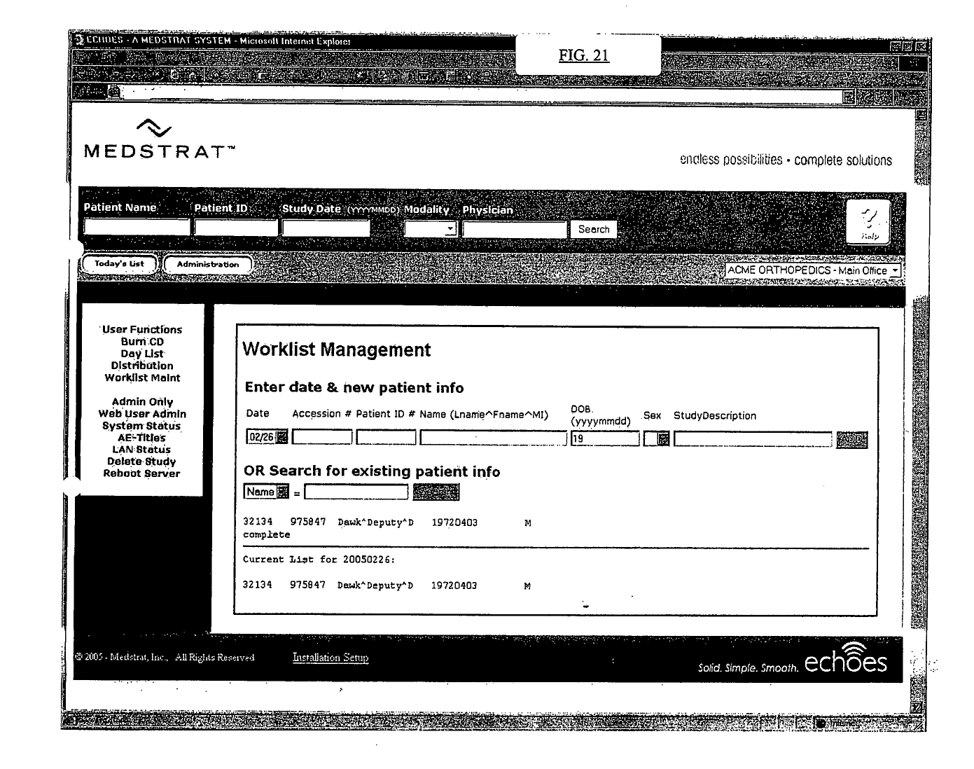

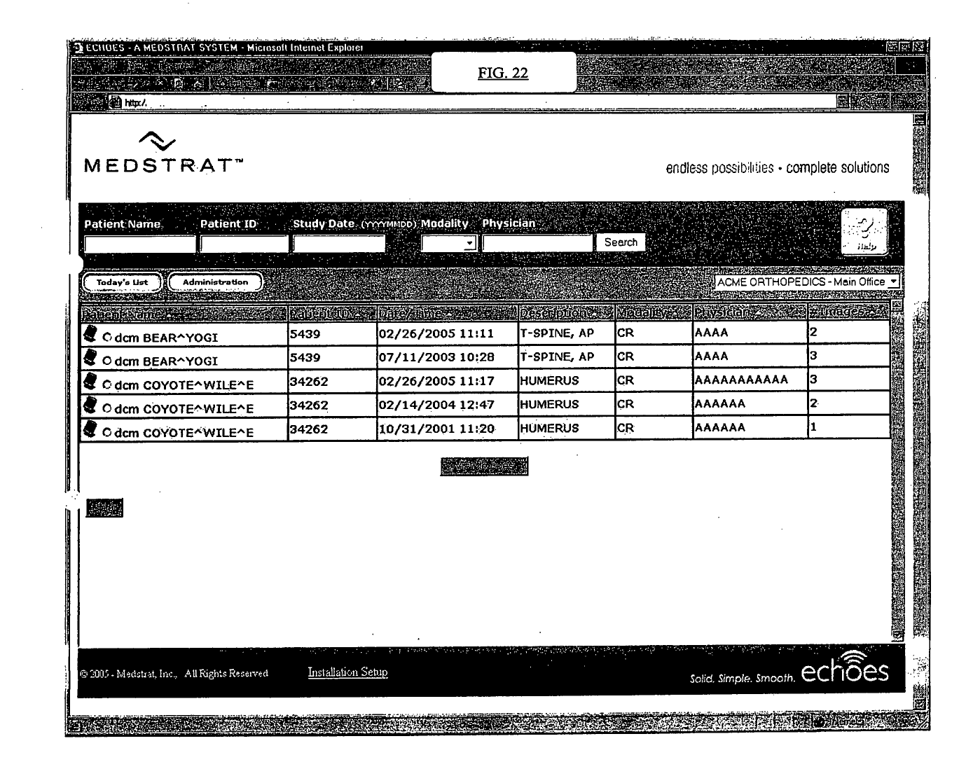

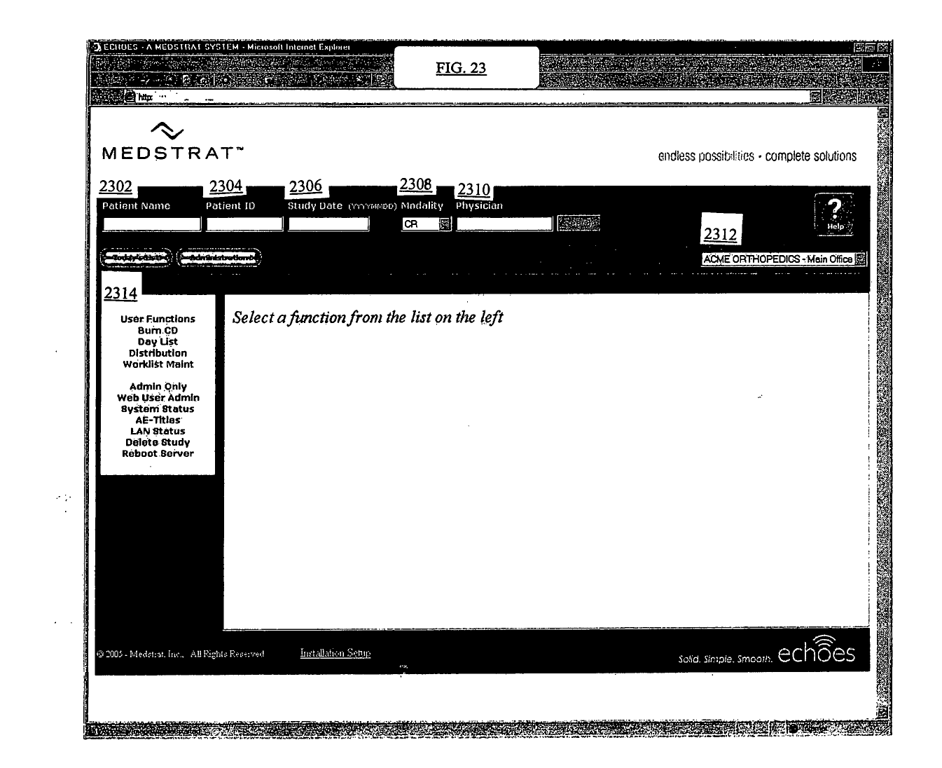

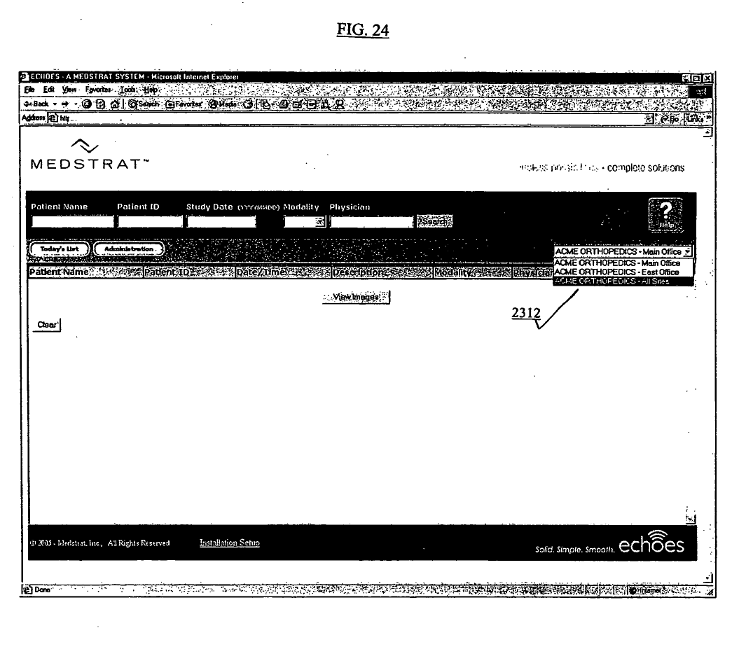

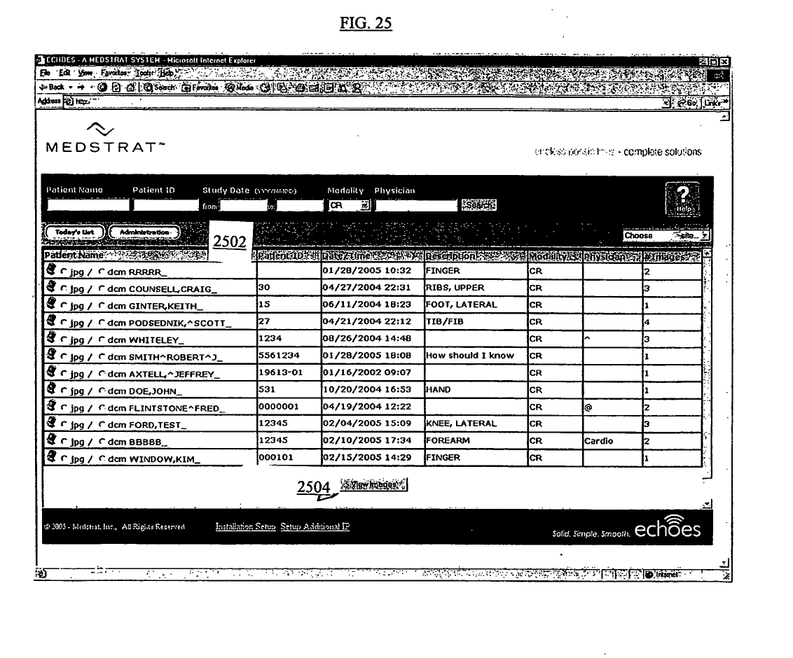

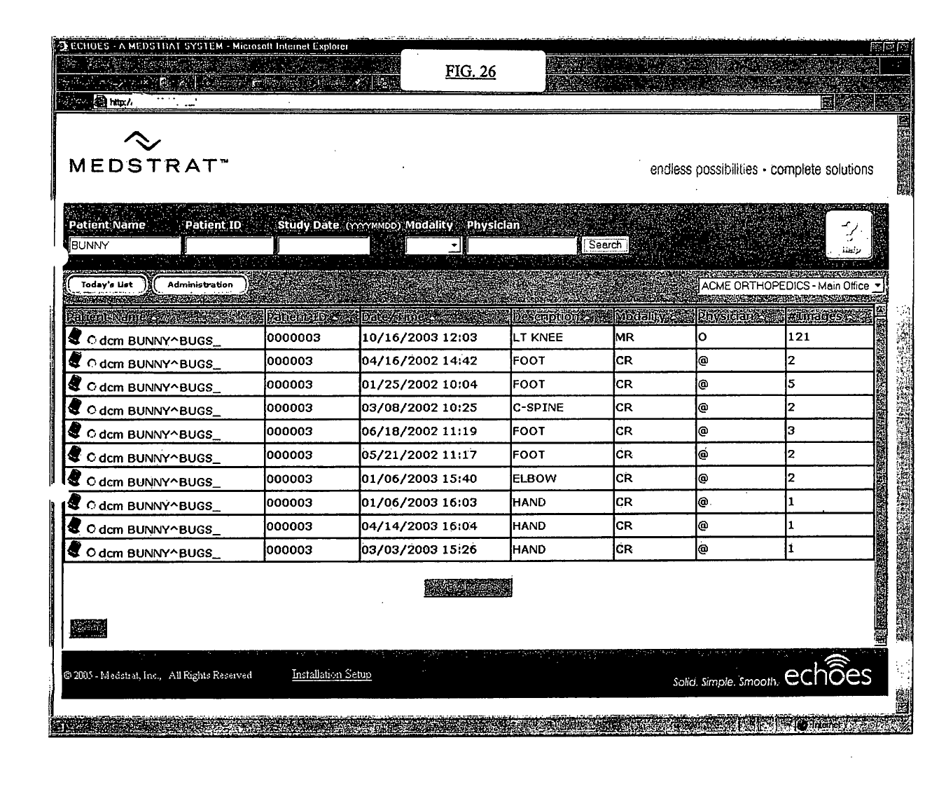

To allow the user to search all or selected imaging studies for a particular imaging study, patient or listing, a search data module 328 may be used. FIG. 23 shows one example of a screen shot of the applet presented to the user to search and/or select from available imaging studies according to the present disclosure. It should be appreciated that other suitable configurations are available in accordance with the present disclosure. A search data module 328 allows the user to enter particular information, such as a patient name as indicated by 2302, patientID as indicated by 2304, study date as indicated by 2306, imaging modality as indicated by 2308, physician as indicated by 2310, practice site as indicated by 2312 and as shown in FIG. 24, birth date or other stored values. The search data module 328 can search the list of one, multiple or all of the data modules to retrieve a list of matching imaging studies. Additional options may be available to the user, as indicated by 2314. FIG. 25 shows one example of a screen shot of the retrieved list of imaging studies matching the search criteria according to the present disclosure. It should be appreciated that other suitable configurations are available in accordance with the present disclosure. The applet can display the retrieved study list as indicated by 2502 in FIG. 25. The retrieved study list can display imaging studies in all available compression formats. To view a selected imaging study, the user may select an imaging study and request the imaging study to be displayed, as indicated by 2504. FIG. 26 shows another example of a screen shot displaying a retrieved list according to the present disclosure. FIG. 27 shows another example of a screen shot displaying a retrieved list, where the retrieved list is selected by study date. FIG. 28 shows one example of a screen shot displaying a retrieved list of imaging studies for a patient as requested from an electronic medical record.

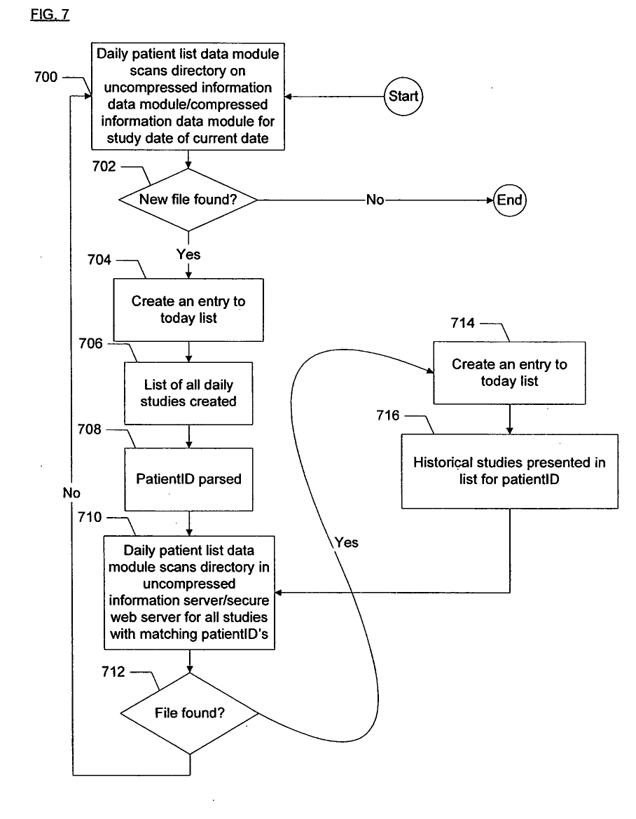

Referring back to block 450 in FIG. 4C and block 520 in FIG. 5, rules may be present on the uncompressed information server 106 and the secure web server 104 that require additional processing of imaging studies on the respective servers. A flow diagram showing a method of rules to be processed by the uncompressed information server 106 and/or the secure web server 104 is shown in FIG. 8. Several examples of rules as shown by blocks 802-806 are provided. If the respective data module finds a processing rule for the imaging study, then the rule is processed, otherwise the processing is complete as indicated by block 800.

As indicated by block 802, a rule may exist that causes an imaging study to be pushed to a particular personal computing device 110. This rule allows the imaging study to be immediately available on a specified personal computing device 110 without a user having to request the imaging study. As indicated by block 804, a rule may exist to push the imaging study to another server. Other rules may also exist, as illustrated by block 806.

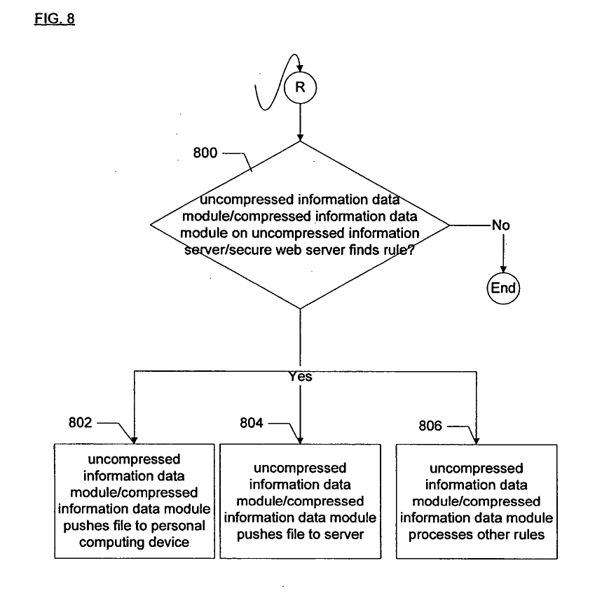

A flow diagram showing one example of imaging studies being stored and processed by the remote backup server 114 is shown in FIG. 9. If a copy of an imaging study does not exist on server 114, then a copy of the uncompressed imaging study is pushed to the remote backup server 114 for remote backup and recovery as indicated by block 476 in FIG. 4D and block 900 in FIG. 9. The uncompressed imaging study is written to the inbox data module 316 on the remote backup server 114. Uncompressed imaging studies in the inbox data module 316 are processed by remote backup server 114 in a similar manner to the processing of imaging studies in the inbox data module 316 on the uncompressed information server 106. The imaging study in inbox data module 316 is available to be processed once its writing is complete. Each imaging study contains header fields as discussed above. The header fields provide information that allows the remote backup server 114 to properly store and index the imaging study. The inbox image data module 316 on the remote backup server 114 parses the header fields as indicated by block 902. The inbox data module 316 then writes the imaging study to the uncompressed information data module 318 as indicated by block 904. The uncompressed information data module 318 utilizes the information parsed from the imaging study to create an index for the imaging study. The index entry is then added to a list in the uncompressed information data module 318 as indicated by block 906.

As indicated by block 908, the uncompressed information data module 318 can push copies of the imaging study to various servers. Pushing copies of the imaging study allows for redundant remote backup of the imaging studies. Pushing copies of the imaging study also allows services to be performed with the imaging study without affecting the backup copy of the imaging study. Additionally, services such as providing imaging studies for educational purposes and the like can be accomplished by pushing copies of the imaging study. The uncompressed information data module 318 on remote backup server 114 pushes a copy of the imaging study to the inbox data module 316 on the remote backup server 116 as indicated by block 910. The uncompressed information data module 318 on remote backup server 114 pushes a copy of the imaging study to the inbox data module 316 on the production server 118 as indicated by block 912. The uncompressed information data module 318 on remote backup server 114 pushes a copy of the imaging study to the inbox data module 316 on the clinical research server 120 as indicated by block 914. The uncompressed information data module 318 on remote backup server 114 checks whether a command exists to push a copy of the imaging study to the individual server 122 as indicated by block 916. Because not all users and/or patients of the system 100 may request to have additional copies of the imaging studies available on another server, remote backup server 114 first checks whether the user requested to have the file pushed to the individual server 122. By not transmitting unnecessary files to the individual server 122, network resources can be saved and allow the system 100 to perform more efficiently. If a command to push the imaging study exists, then the uncompressed information data module 318 on remote backup server 114 pushes a copy of the imaging study to the inbox data module 316 on the individual server 122 as indicated by block 918. According to this embodiment, at block 920, the method of remote data backup at the remote backup server 114 is complete.

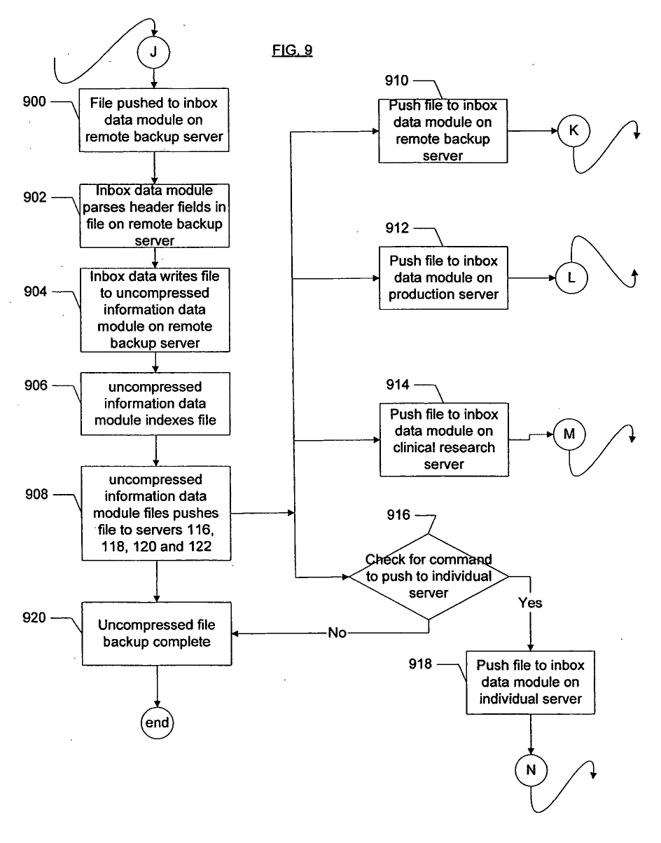

In FIG. 10A, an embodiment of a method of redundant data backup at the remote backup server 116 is shown. Imaging studies in the inbox data module 316 are processed on the remote backup server 116 in a similar manner to the processing of imaging studies in the inbox data module 316 on the remote backup server 114. The imaging study in inbox data module 316 is available to be processed once its writing is complete. The inbox data module 316 on the remote backup server 116 parses the header fields as indicated by block 1000. The inbox data module 316 writes the imaging study to the uncompressed information data module 318 on the remote backup server 116 as indicated by block 1002. The uncompressed information data module 318 utilizes the information parsed from the imaging study to create an index for the imaging study. The index entry is added to a list in the uncompressed information data module 318 as indicated by block 1004. According to a method of redundant data backup in this embodiment, at block 1006, the method of remote data backup at the remote backup server 116 is complete.

A flow diagram showing one example of an imaging study being stored and processed by the production server 118 is shown in FIG. 10B. In block 1010, imaging studies are written to the inbox data module 316. The imaging studies written to the inbox data module 316 can be processed by the uncompressed information data module 318 and/or the compressed information data module 320 on the production server 118.

Imaging studies in the inbox data module 316 are processed on the production server 118 in a similar manner to the processing of imaging studies in the inbox data module 316 on the remote backup server 114. The imaging study in inbox data module 316 is available to be processed once its writing is complete. The inbox data module 316 on the production server 118 parses the header fields as indicated by block 1012. When the inbox data module 316 parses the header fields, the inbox data module 316 reads the information contained therein. The information in the header fields provides the information that allows the imaging study to be properly indexed and stored. The inbox data module 316 writes the imaging study to the uncompressed information data module 318 on the production server 118 as indicated by block 1014. The uncompressed information data module 318 utilizes the information parsed from the imaging study to create an index for the imaging study. For example, utilizing the annotated information, the uncompressed information data module 318 can index the file based upon the patientID, the patient's name, imaging study type, date, etc. The index entry is added to a list in the uncompressed information data module 318 as indicated by block 1016. The list allows the imaging study to be retrieved by the user. The index entry may be added to the study list data module 326, where uncompressed and/or compressed imaging studies are present on the production server 118. The list allows for a single searchable list of all imaging studies on the production server 118. As shown by block 1026, the imaging studies on the production server 118 are now web accessible and available to be retrieved and viewed.

In an embodiment, an imaging study in the inbox data module 316 may be processed by the compressed information data module 320. The inbox data module 316 parses out the header fields from the imaging study as indicated by block 1018, and similar to block 1012. The inbox data module 316 writes the imaging study to the compressed information data module 320 on the production server 118, as indicated in block 1020. The compressed information data module 320 converts the uncompressed imaging study into compressed format, where the compressed image is written to the compressed information data module 320 in place of the uncompressed imaging study as indicated by block 1022. The compressed image is then indexed, as indicated by block 1024. The compressed information data module 320 may add a copy of the index entry to the study list data module 326, where uncompressed and/or compressed imaging studies are present on the server. The list allows for a single searchable list of all imaging studies on the production server 118. As shown by block 1026, the imaging studies on the production server 118 are now web accessible and available to be retrieved and viewed.

Referring now to FIG. 10C where in an embodiment, a method of preparing imaging studies on a clinical research server 120 is shown. In block 1030, imaging studies are written to the inbox data module 316. The uncompressed information data module 318 and/or the compressed information data module 320 on the clinical research server 120 then process the imaging studies written to the inbox data module 316.

The contents of the clinical research server 120 are intended to aid in the teaching of medical students, interns, residents and the like. Such a database can also be useful for continuing medical education. Additionally, such a server creates a large and continually growing database of imaging studies.

Because a traditional imaging study may contain confidential PHI, an imaging study should have all the PHI removed to prevent disclosing the PHI to the public. Removing the PHI from the imaging study may also be required by the Health Insurance Portability and Accountability Act (“HIPAA”). HIPAA has various requirements regarding PHI. The inbox data module 316 removes all PHI from an imaging study as indicated by block 1032. As discussed above, each of the header fields is marked to identify whether the field contains PHI. For each field that is marked as containing PHI, the field is removed from the imaging study. Thus, an imaging study is provided with all the PHI removed. Then an indexing code is assigned to the imaging study as indicated by block 1034. The code allows the imaging study to be indexed and retrieved even though all PHI has been removed.

The inbox data module 316 on the clinical research server 120 parses the remaining header fields from the imaging study as indicated by block 1036. The inbox data module 316 then writes the imaging study to the uncompressed information data module 318 on the clinical research server 120 as indicated by block 1038. The uncompressed information data module 318 utilizes the information parsed from the imaging study to create an index for the imaging study as indicated by block 1040. The index entry is added to a list in the uncompressed information data module 318. A copy of the index entry may be added to the study list data module 326, where uncompressed and/or compressed imaging studies are present on the server. The list allows for a single searchable list of all imaging studies on the clinical research server 120. As shown by block 1050, the imaging studies on the clinical research server 120 are now web accessible and available to be retrieved and viewed.

The uncompressed imaging study in the inbox data module 316 may be processed by the compressed information data module 320. The inbox data module 320 parses out the remaining header fields from the imaging study as indicated by step 1042. The inbox data module writes the imaging study to the compressed information data module 320 as indicated by block 1044. The compressed information data module 320 converts the uncompressed imaging study from the uncompressed format to the compressed format. The compressed image is stored in the compressed information data module 320 as indicated by block 1046. The compressed image is then indexed. The index entry is added to a list in the compressed information data module 320 as indicated by block 1048. The compressed information data module 320 may add a copy of the index entry to the study list data module 326, where uncompressed and/or compressed imaging studies are present on the server. This allows for a single searchable list of all imaging studies on the clinical research server 120. As shown by block 1050, the imaging study on the clinical research server 120 is now web accessible. A user can retrieve and view an imaging study on the clinical research server 120. In an embodiment, access to the imaging studies on the clinical research server 120 may be controlled by a separate user authentication method. For example, the user accounts data module 322 on the clinical research server 120 may have different user accounts to access the imaging studies on the clinical research server 120. The user account data module 322 on the clinical research server 120 may maintain and record the user account's access to the clinical research server 120. The clinical research server 120 may bill the user account or verify a membership for accessing the imaging studies on the clinical research server 120.

A flow diagram showing one example of an imaging study being stored and processed by the individual server 122 is shown in FIG. 10D. In block 1060, an imaging study is written to the inbox data module 316 where a proper command exists (see block 916 in FIG. 9). The imaging study written to the inbox data module 316 can be processed by the uncompressed information data module 318 and/or the compressed information data module 320 on the individual server 122.

The imaging study in the inbox data module 316 is processed on the individual server 122 in a similar manner to the processing of the imaging study in the inbox data module 316 on the remote backup server 114. The imaging study can be processed by the inbox data module 316 once the writing process is complete. The inbox data module 316 on the individual server 122 parses the header fields as indicated by block 1062. The inbox data module 316 writes the imaging study to the uncompressed information data module 318 on the individual server 122 as indicated by block 1064. The uncompressed information data module 318 utilizes the information parsed from the imaging study to create an index for the imaging study. The index entry is added to a list in the uncompressed information data module 318 as indicated by block 1066. The index entry may be added to the study list data module 326, where the uncompressed and/or compressed imaging studies are present on the server. This allows for a single searchable list of all imaging studies on the individual server 122. As shown by block 1026, the imaging study on the individual server 122 is now web accessible. The user can retrieve and view the imaging study.

In an embodiment, an imaging study in the inbox data module 316 may be processed by the compressed information data module 320. The inbox data module 316 parses out the header fields from the imaging study, as indicated by block 1068. The inbox data module 316 writes the imaging study to the compressed information data module 320 on the individual server 122, as indicated in block 1720. The compressed information data module 320 converts the uncompressed imaging study from the uncompressed format into the compressed format. The compressed image is written to the compressed information data module 320 in place of the uncompressed imaging study as indicated by block 1072. The compressed image is then indexed, as indicated by block 1074. The compressed information data module 320 may add a copy of the index entry to the study list data module 326, where uncompressed and/or compressed imaging studies are present on the server. This allows for a single searchable list of all imaging studies on the individual server 122. As shown by block 1076, the imaging study on the individual server 122 is now web accessible. The user may retrieve and view the imaging study.

The service provider administrative and diagnostic server 112 allows a service provider of system 100 to remotely monitor the secure web server 104 and the uncompressed information server 106 at the practice site 102. The service provider administrative and diagnostic server 112 can remotely log system performance, user statistics, monitor and record the syslog from the secure web server 104 and/or uncompressed information server 106. The service provider administrative and diagnostic server 112 can also monitor and record information from the remote backup server 114, the remote backup server 116, the production server 118, the clinical research server 120, the individual server 122 and the redirector 124. The service provider administrative and diagnostic server 112 can therefore perform audits for each practice site 102, for each user or for each server. Connecting with a server allows the service provider administrative and diagnostic server 112 to monitor system usage and verify a practice site's 102 or user's compliance with their terms of service. The audit further allows the user to determine the users who accessed the service, users who accessed the imaging study, imaging studies accessed by the user, services accessed by the user, etc.

The service provider administration and diagnostic server 112 may need to access a server when a network connection is unavailable. The network connection may be unavailable, for example, because the connection to the Internet at practice site 102 is not properly functioning or unavailable. The service provider administrative and diagnostic server 112 can connect to the secure web server 104 and/or the uncompressed information server 106 by using an analog telephone line. Where the network is available, the service provider administrative and diagnostic server 112 can log into the secure web server 104 and/or the uncompressed information server 106 via the network. The service provider administrative and diagnostic server 112 can also remotely log into the secure web server 104 and/or the uncompressed information server 106 as if the service provider administrative and diagnostic server 112 were present at the practice site 102. By logging into the secure web server 104 and/or the uncompressed information server 106, the service provider administrative server 112 can provide more efficient diagnostic, administrative and/or technical support to the practice site 102.

The service provider administrative and diagnostic server 112 can remotely monitor and mange the software residing on the secure web server 104 and/or the uncompressed information server 106 at a practice site 102. This provides the ability for the server provider of system 100 to determine what software version a practice site is running, as well as allow the service provider administrative and diagnostic server 112 to push upgrades, patches and/or new software to practice site 102.

The service provider administrative and diagnostic server 112 manages and maintains the listing and list for all practice sites 102 as well as the secure web servers 104 and/or uncompressed information server 106 present at those locations. Therefore, as a practice site 102, practice site affiliation or users are added or removed, the service provider administrative and diagnostic server 112 updates each server to ensure proper functionality of the system 100. The service provider administrative and diagnostic server 112 can push the information to all appropriate servers in system 100. For example, the service provider administrative and diagnostic server 112 can push the information to the redirector 124 to provide the redirector 124 with a current listing of valid servers the user has access for. The service provider administrative and diagnostic server 112 can also push the information to the secure web server 104 and/or the uncompressed information server 106 at practice site 102.

The service provider administrative and diagnostic server 112 allows the service provider for system 100 to remotely access imaging studies and restore lost, damaged or misplaced imaging studies at the practice site 102. For example, the service provider administrative and diagnostic server 112 can communicate with the uncompressed information server 106 and/or the secure web server 104 at the practice site 102 to determine what fails are lost, damaged or misplaced. In an embodiment, practice site 102 can inform the service provider that one or more specified imaging studies are lost or damaged. The service provider administrative and diagnostic server 112 can communicate with the remote backup server 114 or the remote backup server 116 and push the specified imaging studies to the practice site 102. The service provider administrative and diagnostic server 112 can also move a specified file, or reassign a specified file to a different patient where an imaging study was misplaced.

The service provider administrative and diagnostic server 112 can also act as an e-mail gateway for clients using the e-mail features of the system 100. The e-mail gateway allows users of system 100 to communicate with users of other systems through e-mail.

Access to servers 118, 120 and 122 can be obtained through personal computing device 110. Clinical research server 120, because it does not contain confidential PHI can optionally be made available for general viewing without the username and/or password authentication. Server 120 may optionally contain advertisements. Server 120 may optionally require a subscription for access.

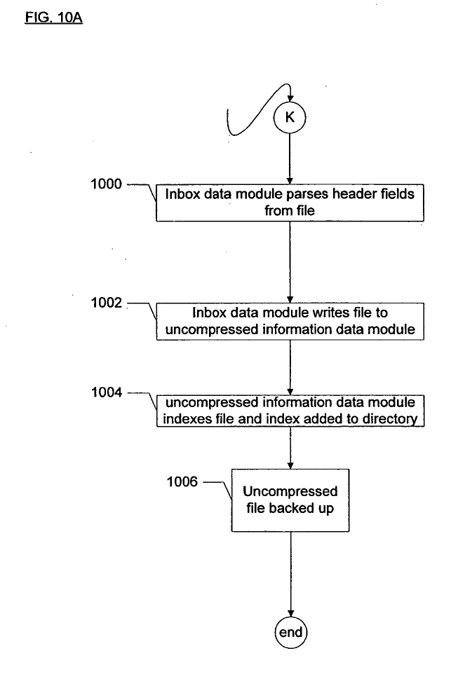

The user at a personal computing device 110 that is located at a practice site 102 can access the uncompressed information server 106 and the compressed imaging studies on the secure web server 104 through the network 130. An embodiment of this method is shown in FIG. 11A. FIG. 11B provides a flow diagram where there are affiliated practice sites 102.

The user seeking to access a list of imaging studies, may obtain access to an imaging study on the uncompressed information server 106 from a personal computing device 110 as indicated by block 1100. The user, using input devices 214 can start an application, such as an applet for example. This might include clicking an icon displayed on a desktop of the output device 218 of the personal computing device 110. The icon may start an applet that opens a web browser. The web browser may provide the user with a web interface as indicated by block 1102. The web interface can connect the user at the personal computing device 110 to the uncompressed information server 106 as indicated by block 1104. In an embodiment, the icon may execute a program that is stored in the memory device 208 of the personal computing device 110.

The web interface may open a first page that prompts the user to enter their username and password as indicated block 1106. Once the user enters their username and password, a data packet with the username and password is transmitted from the personal computing device 110 to the uncompressed information server 106 where the user accounts data module 322 verifies the username and password as indicated by block 1108. If the user accounts data module 322 cannot verify the supplied username and password, the web interface can return a prompt to re-enter the username and password, or in another embodiment, the applet can terminate as indicated by block 1110.

The user accounts data module 322 verifies that the username is not already in use on the system. If the username is already in use on the system, the web interface may return a prompt to enter another username and password, or, in another embodiment, the applet can terminate as indicated by block 1112.

As indicated by block 1114, the applet verifies the access level a particular user has on the system 100. For example, the level of access granted to the user may include full access to all imaging studies and add-on services in the system 100 to read-only access of one or more selected imaging studies. The applet determines whether registered affiliated practice sites 102 exist as indicated by block 1116. If there are no registered affiliated practice sites 102, then the uncompressed information data module 318 provides the user with a searchable list of all the uncompressed and compressed imaging studies that the username has access for as indicated by block 1118. The available imaging studies are selected from the uncompressed information data module 318 on the uncompressed information server 106, the compressed images present in the compressed information data module 320 on the secure web server 104 on the uncompressed information server 106.

When the applet determines that a registered affiliated practice site 102 exists, the uncompressed information data module 318 of the uncompressed information server 106 can connect to the secure web server 104 at an affiliated practice site 102 as indicated by block 1120 in FIG. 11B. The user accounts data module 322 on the secure web server 104 at the affiliated practice site 102 then verifies the authorization and access for the particular username as indicated by block 1122. The compressed information data module 320 can return a list of imaging studies accessible by the username as indicated by block 1124. In an embodiment, the user can select to view the today list as previously described. FIG. 22 shows one example of a screen shot illustrating the today list according to the present disclosure. It should be appreciated that other suitable illustrations are available in accordance with the present disclosure. In an embodiment, the user can be provided a list from the uncompressed information data module 318 on the uncompressed information server 106.

To enable the user at a personal computing device 110 who is not located at a practice site 102, or an affiliated practice site 102, to connect to the secure web server 104 a practice site 102, a redirector 124 may be used. The redirector 124 provides simplicity, security and other features to the system 100. The redirector 124 is a network computing device such as a server that may contain a software application that intercepts requests for remotely provided services and sends the requests to the appropriate computer in the system 100. The redirector 124 may be required by the user of a personal computing device 110, where the personal computing device 110 is outside of the practice site 102 or affiliated practice sites 102. The redirector 124 may accept connections from personal computing devices 110, and pass them on, through a different connection, to the next stage in the link, such as secure web server 104 at practice site 102. Redirector 124 serves as a barrier between the personal computing devices 110 and the user requested secure web server 104. Redirector 124 is utilized because it provides for simplified access to the secure web server 104 at practice site 102.

In an embodiment, because of potential security risks, to control access across the system 100 and to provide a simplified method of accessing a practice site 102 remotely, one may use a redirector 124. A practice site 102 may not want to publish the internet address of a secure web sever 104, and may not want a personal computing device 110 to connect directly to the secure web server 104. Therefore, the use of one or more redirectors 124 is employed. Redirectors 124 pass the connection on to the secure web server 104, allowing a practice site 102 to hide the address of the secure web server 104 from the client users.

Redirector 124 can be connected to other redirectors 124 (in a cascaded configuration). Redirector 124 gives personal computing device 110 secure access to a wide range of servers. Typically, the connection is made secure by the redirector 124. For example, a Java applet may be used. The program prevents access to all local and network resources except the requested server that directly supports the applet.

Depending on the user accessing redirector 124, security for each secure web server 104 can be varied. For example, security choices can include no modification or direct pass-through from the personal computing device 110 to the secure web server 104, personal computing device 110-side encryption, secure web server 104-side encryption or encryption on all data flowing between the personal computing device 110 and the secure web server 104.

A flow diagram generally showing a method of accessing imaging studies at a practice site 102 from a personal computing device 102 is shown in FIG. 11C. A personal computing device 110 may gain access to the secure web server 104 as indicated by block 1130. The user accessing redirector 124 from the personal computing device 110, using input devices 214 can open up a web interface and enter the site location, such as a website address, to display a web interface with the redirector 124 as indicated by block 1132.

The web interface may open a first page that prompts the user to enter their username and password as indicated by block 1134. Once the user enters their username and password, a data packet with the username and password is transmitted from the personal computing device 110 to the redirector 124 where the user accounts data module 322 verifies the username and password as indicated by block 1138. If the user accounts data module 322 cannot verify the supplied username and password, the web interface can return a prompt to re-enter the username and password, or in another embodiment, the applet can terminate as indicated by block 1138.

The user accounts data module 322 verifies that the username is not already in use on the system 100 as indicated by block 1140. If the username is in use, the web interface can return a prompt to enter another username and password, or, in another embodiment, the applet can terminate.

The user accounts data module 322 of the redirector 124 determines those secure web servers 104 that the username can access as indicated by block 1142. Where the username has no access, the applet can terminate. For each secure web server 104 that the username has access to, a selectable option is provided to the user at personal computing device 110 as indicated by block. If the username is only associated with a single practice site 102, the redirector can pass the user over directly to the secure web server 104. Where the username has access to more than one practice site 102, the user is provided with a list of available practice sites 102 as indicated by block 1144. The user can select one of the available practice sites 102 as indicated by block 1146. The redirector 124 can pass the user to the selected practice site 102, connecting the personal computer device 110 to the secure web server 104 at the selected practice site 102 as indicated by block 1148.

The selected practice site 102 then verifies the user's access level as indicated by block 1150. Once the access is verified, the user is provided with a list of all imaging studies the user may access on the secure web server 104 as indicated by block 1152.

To ensure the proper viewing of an imaging study, it may be useful for the system 100 to prompt the user at a personal computing device when attempting to view an imaging study to ensure proper functionality of the equipment. It may also be useful for the system 100 to prompt the user at a personal computing device 100 that they may be viewing PHI, and that adequate and proper precautions should be utilized when viewing and offering for view, data contained within the system 100.

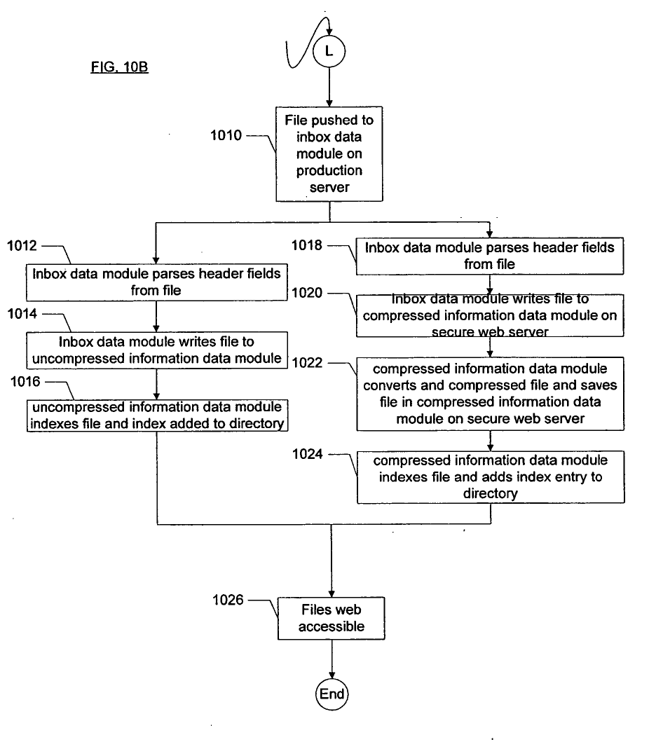

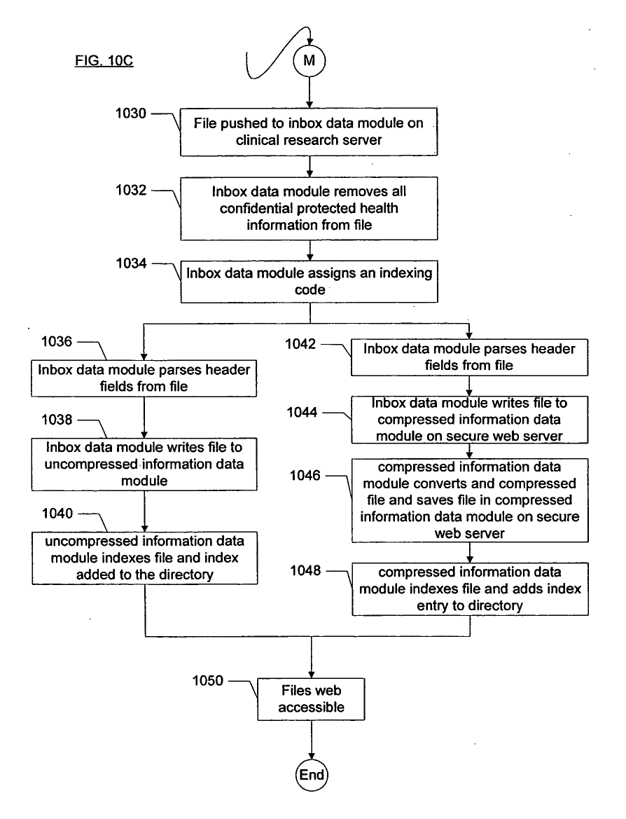

A flow diagram showing one example of a method of providing warnings to the user viewing medical images is shown in FIG. 12. In an embodiment, the user may want to ensure proper functionality of an output device 218 of the personal computing device 110. Verification of the functionality of the output device 218 can help to ensure proper readability of the imaging studies.

The user may request access to an imaging study by using the personal computing device 110 as indicated by block 1200. When requesting an image, the user may first be provided with a warning message as indicated by block 1202. In an embodiment, when the user first logs onto the system they may be provided with a warning message. Such a message may include information reminding the user that the information within the system may contain PHI and is subject to HIPAA requirements. The warning message may require the user to accept the message before proceeding as indicated by block 1204. In an embodiment, the warning message may be presented to the user on the same screen as the user prompt for the username and password.

Once the user selects an image they want to view, the system 100 may provide the user with another warning message as indicated by block 1206. Such a warning message may inform the user of the limitations, if any, of viewing a medical image in a digital format as indicated by block 1208. In an embodiment, the warning message may provide information about the output device 218. Such a warning may include a message about whether the output device 218 is displaying the imaging study properly as indicated by block 1210. The user may be required to acknowledge whether the output device 218 is functioning properly before proceeding. In an embodiment, one or all of these warning messages may be displayed with the initial prompt screen where the user enters their username and password.

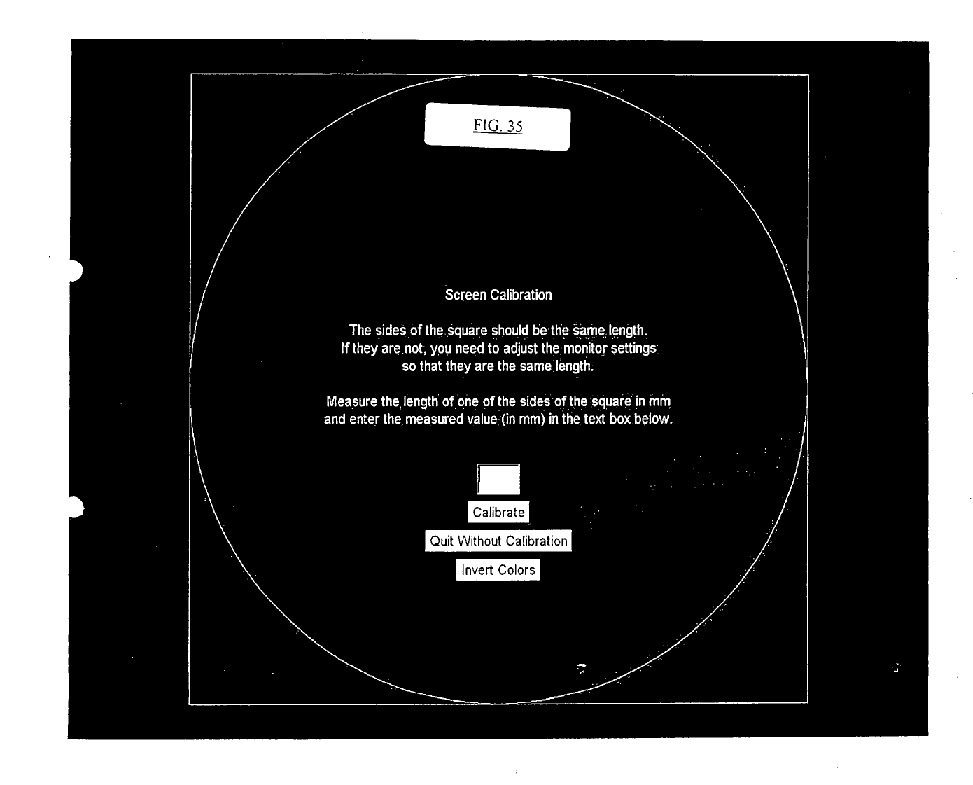

If the output device 218 is functioning properly, the warning message is removed, and the user can view the whole imaging study as indicated by block 1212. The system 100 may provide the user with a test pattern or other confirmation application to ensure that output device 218 continues to function properly throughout its use as indicated by block 1214 and as indicated by test pattern 3630 in FIG. 36. The test pattern or confirmation application can also ensure compliance by the user by reminding them of the proper way to view the imaging study on the output device 218. Such a test pattern or application can include various color and/or grayscale test images that may present before, during or after an image is presented on the output device 218. The test images allow the user to verify whether output device 218 is properly configured to display the images in a manner that is consistent with the intended use of the images. The user may also be presented with an option to terminate the viewing of an image based upon the presentation of the test image.

Once the image is displayed on output device 218, the user may be presented with additional options. FIG. 36 is a screen shot illustrating various menu options available while displaying imaging studies. It should be appreciated that other suitable displays, configurations and options are available in accordance with the present disclosure. Such options may include enlargement or reduction of images, rotation of images around an axis, contrast and brightness ratios, adding color, lines, text and images to the image on the output device 218. It should be noted that the options listed above are only some examples of options that can be offered to the user. These examples are not meant to limit the manipulations, variations and functions commonly associated with digital radiography, and as such they are incorporated here by reference, whereby the user can additionally be presented with such options.

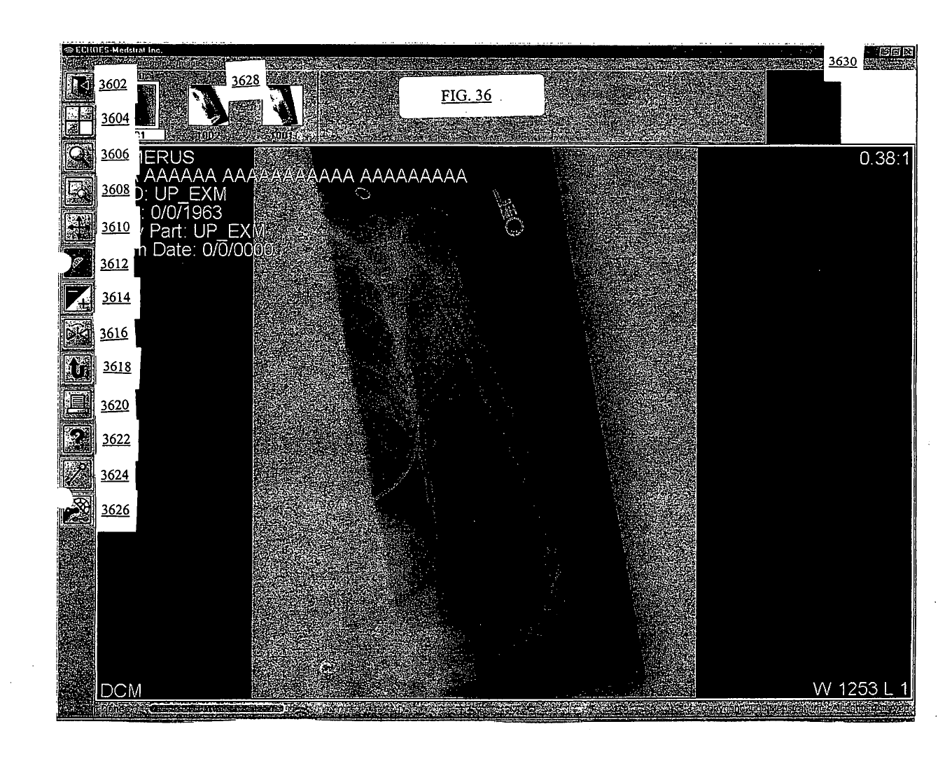

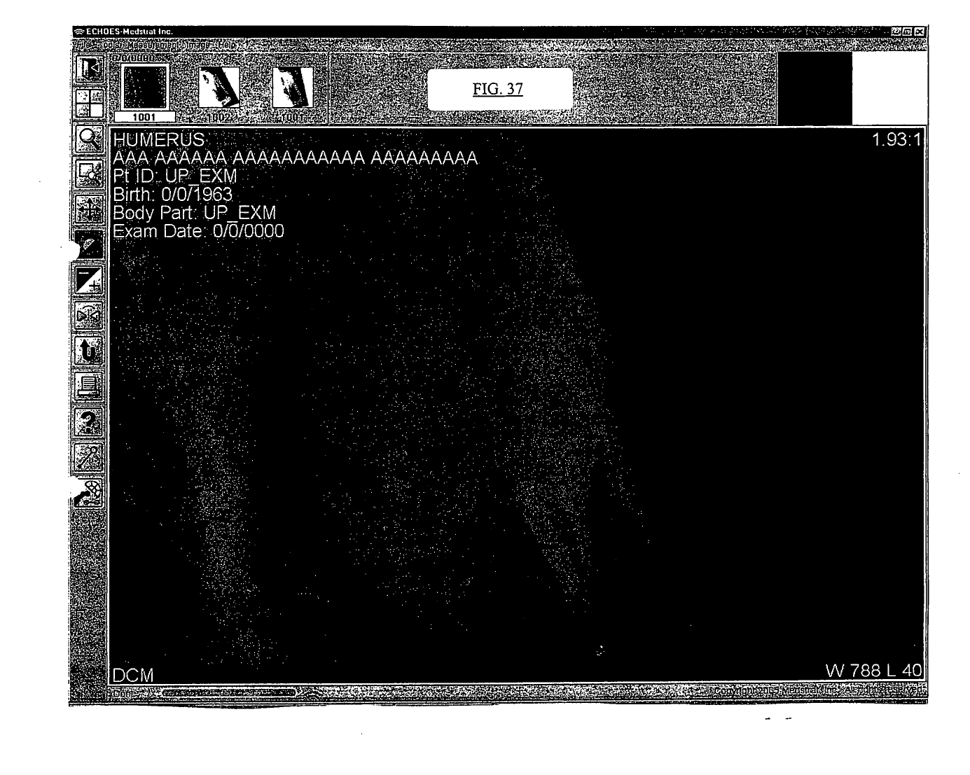

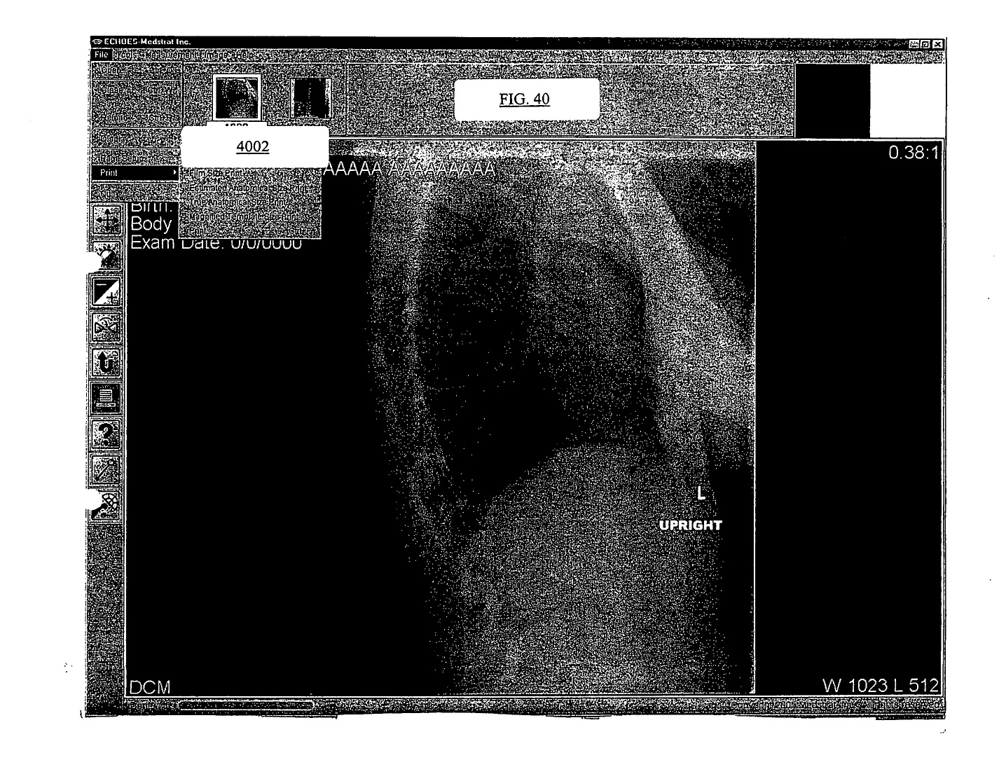

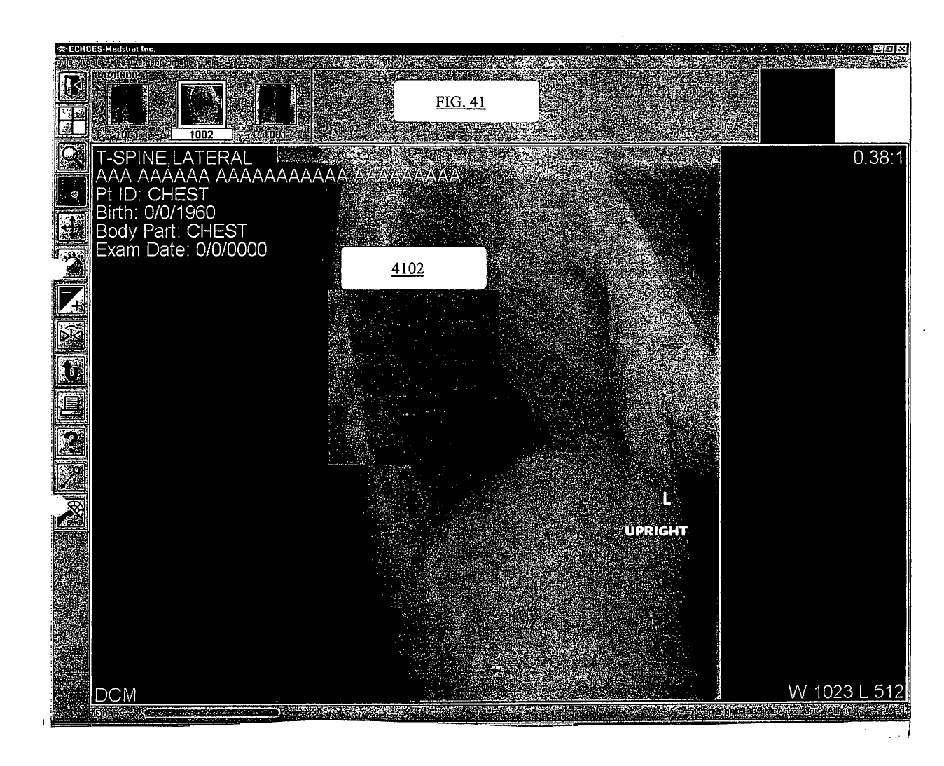

The user at personal computing device 110 may be presented with a number of additional menu options. For example, menu options may include features such as returning to the list as indicated by thumbnail 3602; the number of images to display as indicated by thumbnail 3604; zoom in/out of the entire image as indicated by thumbnail 3606; magnification of a selected area as indicted by thumbnail 3608; panning the image as indicated by thumbnail 3610; window/leveling as indicated by thumbnail 3612; invert image as indicated by thumbnail 3614; image rotation/flip as indicated by thumbnail 3616; reload the current image as indicated by thumbnail 3618; print image as indicated by thumbnail 3620; help as indicated by thumbnail 3622; measurement and mapping tools as indicated by thumbnail 3624; template selection and analysis as indicated by thumbnail 3626; image selection as indicated by thumbnail 3628; as well as additional menu options not illustrated, such as cross referencing, study comparison, multi-archive uncompressed imaging study query, multi-archive compressed imaging study query, cine loop, key image, annotation, user lever hanging protocols, multi-monitor, on-screen thumbnails, active image slice tracking, multi-level security, open virtual viewers at a click of a button, open a new exam or imaging study in place of a currently opened study, etc. FIGS. 37, 38, 39, 40, 41, 42, 43 and 44 are screen shots illustrating the execution of selecting one of the various menu options available while displaying imaging studies. It should be appreciated that other suitable displays, configurations and options are available in accordance with the present disclosure. FIG. 37 shows an enlargement of an imaging study. As shown by 3802 in FIG. 38 various display options are shown. For example, as discussed below, the user can display an imaging study in the film size or calibrate the imaging study to display the imaging study in anatomical size. FIG. 40 shows various options for printing the imaging study. For example, as indicated by 4002, the user can select to print the imaging study as the same size as the film, as the anatomical size of the imaged object, etc. As indicated by 4102 in FIG. 41, a screen shot of selected part on an imaging study magnified by the magnification tool 3608 is shown. In addition, the user may send a copy of the imaging study to another user; send notification, and/or a link to the imaging study to a non-authorized user. The user may include proper instructions on how to gain access to the image.

Where the imaging studies do not appear to be properly displayed, the user is prompted to correct the display as indicated by block 1216. If the user can correct the display, then the warning message is removed and the entire imaging study is presented to the user. However, it may be necessary for the user to access the imaging study even when the display is not functioning properly. In such a case, the user may be presented with an option to override the warning message and have full access to the imaging study as indicated by block 1218. In an embodiment, when the user overrides the warning, the output device 218 may include a warning message reminding the user that the output device is not functioning or displaying properly.

It may be useful or necessary for the user at a practice site 102 to provide access to another user such as a physician, a vendor or manufacturer representative or a health care service provider to view one or all of the imaging studies contained within a practice. For example, it may be necessary to grant access to an imaging study to a non-affiliated physician, other health care or health service providers or vendor and/or manufacturer representative. For example, a practice may add a new physician, or a patient may need a referral to another physician who may need access to an imaging study. Therefore, the user may wish to grant access to view such imaging studies.

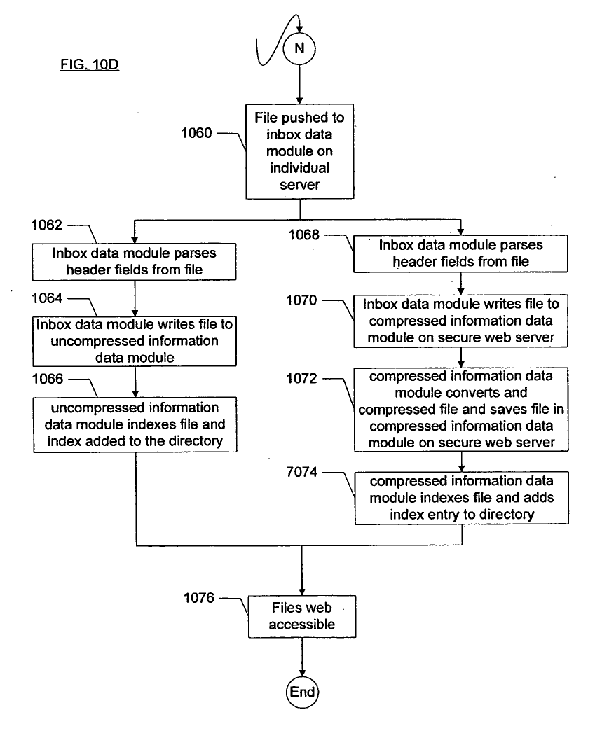

A flow diagram showing one example of the user granting access to an imaging study to a new or other user is shown in FIG. 13. In block 1300, the user at personal computing device 110 may be viewing an imaging study. The user may wish to grant access to that study to another. In an embodiment, the user at personal computing device 110 may be in an administrative menu, and may wish to add, modify, change or delete the user. It should be noted that FIG. 13 is provided only as one example of granting access to an existing user and creating a new user.

The user is provided with a menu of options on the output device 218 as indicated by block 1302. The user can select an option such as add, change, modify, delete or grant user access to an imaging study or imaging studies. In this example, the user can select grant access to an imaging study as indicated by block 1304. The user can select local access, such as users within the practice, or the user can request the list of users for the system 100. The user accounts data module 322 can then return a list of available another users to the user as indicated by block 1306.

The user at the personal computing device 110 can search for a particular another user as indicated by block 1308. Where another user is found to exist in the user accounts data module 322, the user at the user accounts data module 322 can select another user as indicated by block 1310. Access level and user rights are assigned to another user at that time regarding access to the particular file or imaging studies as indicated by block 1312. The user can grant access to the another user as indicated by block 1314. In an embodiment, when the another user is granted access, the user accounts data module 322 updates the user accounts data module 322 on each server where the another user has authorized access. The user accounts data module 322 can also update the user accounts data module 322 on the redirector 124.

Where user at personal computing device 110 fails to find the another user, the user can select to add a new user as indicated by block 1316. A new user can be added to the system in a number of different ways. For example, a new user can be added to the system by the user with the proper authority to do so. In an embodiment, a new user can be added to the system by the service provider. The new user account information is then pushed by the service provider administrative and diagnostic server 112 to the user accounts data module 322 at practice site 102. In an embodiment, the user can enter the new user's information. The user can then set access level and user rights to the new user as indicated by block 1318. The user may wish to verify the new user, such as reviewing the new user information, sending a test email or other such ways to verify the validity of the new user as indicated by block 1320. The user can then select to grant access to the new user as indicated by block 1314. In an embodiment, when the new user is granted access, the user accounts data module 322 updates the user accounts data module 322 on each server where the new user has authorized access. The user accounts data module 322 can also update the user accounts data module 322 on the redirector 124. The user is provided with an option on whether or not to generate a message to the new or another user that imaging studies are available for accessing as indicated by block 1322. The user can selects to have the system 100 generate an email to the new or another user as indicated by block 1324.

Add-on services may be provided to the user via electronic and non-electronic means. The services may be resident at elements attached to system 100 at practice site 102, resident as software on the secure web server 104 or the uncompressed information server 106, located remotely, connected to production server 118 or reside on production server 118.

Several examples of add-on services are provided below. However, these examples are not meant to limit the scope of the add-on services. Such services may include the ability to print images on film or laser. Because many offices are going film-less, the likelihood that a practice site 102 will be without a film printer is increasing. However, because there are still reasons where a hard copy film is used, it is preferred to have the ability to generate the hard copy film. It would therefore be advantageous that from a personal computing device 110, the user can select to print an image in either laser or film format. If the practice site has such a printer, then printing can be performed locally. However, where such a printer is not present at the practice site 102, a data packet is sent to the production server 118. In response, the production server 118 extracts the requested study from its database and prints the imaging study. Production server 118 can additionally format and produce proper mailing information for the film.

In another example of an add-on service, practice site 102 may require the ability to scan films to produce digital imaging studies for use on the system 100. Because some offices and hospitals still use films, a need exists to digitize the film. However, as digitized radiography continues to grow, a practice site 102 that does not own a proper scanning device may not see the need to purchase their own film digitizer. Thus, having the ability to digitize the film, but not having to pay for a proper scanning device may be advantageous. In such a case, a film can be sent to a facility where the film is scanned, digitized into an uncompressed, digital medical imaging compliant format and pushed to the inbox data module 316. Accordingly, a practice site 102 can then have an imaging study available in digital format for use.

Additional services may include applications to analyze an image and provide information to the physician and patient. Additionally, any third party software package can be loaded up on a server at practice site 102 or on the production server 118. Such software might include software to facilitate bone mineral density analysis, fracture analysis, disease state analysis and other such programs.

A practice site 102 may not purchase valuable software programs due to the expense. Therefore, by having the software program available as an add-on service located remotely on or at the production server 118, a practice site 102 may include such features in their practice. Such add-on services may be available without additional expense, for a fee-per-use or at a subscription rate.

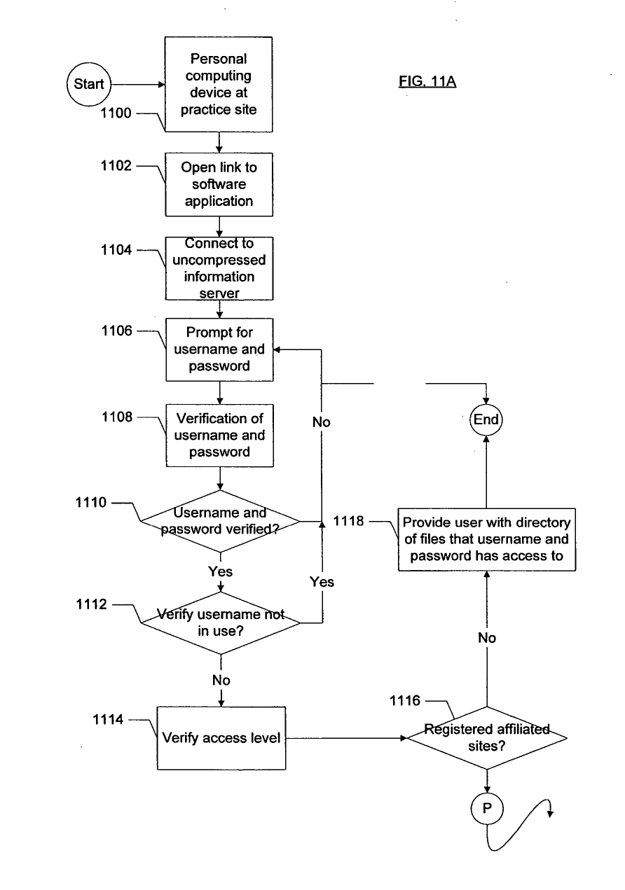

A flow diagram showing one example of a method of using and billing for add-on services is shown in FIG. 14. The user at personal computing device 110 may be reviewing an imaging study as indicated by block 1400. The user can be provided with a list of options as indicated by block 1402. The options may include add-on features. The user can then select on an appropriate add-on feature to perform on the selected imaging study as indicated by block 1404.

Once the user selects the add-on service, the user accounts data module 322 can determine whether the user has proper authorization for the add-on service selected as indicated by block 1406. If the user has the proper authorization, then the uncompressed information server 106 can determine whether the service is available locally, or whether the service is only available via the production server 118 as indicated by block 1408. If the add-on service is available locally, then the add-on service is completed at practice site 102 as indicated by block 1410. Uncompressed information server 106 additionally can check whether the add-on service at practice site 102 may be billed to the practice as indicated by block 1412. If the practice site 102 is billed for the service, then the uncompressed information server provides billing for the add-on services as discussed below. After the add-on service is completed, the results may be provided to the user as indicated by block 1428.

If at block 1408, the uncompressed information server 106 determines the add-on service is performed by the production server 118, then a command is sent via the network 128 to the production server 118 as indicated by block 1414. For each command sent to the production server 118, the production server 118 makes a record as indicated by block 1416. The record may include such things as the service provided, the requesting practice site and the requesting user. On a pre-determined basis, the production server 118, generates a bill to the practice site 102 for the fees associated with the request as indicated by block 1418. In an embodiment, production server 118 can automatically debit an account pre-authorized by practice site 102 for fees associated with the services. An embodiment may include subscription services that pre-paid.

The bill generated by production server 118 can include the license and usage fee for the service requested. The license and usage fee can vary for each service requested. This type of billing method does not require the user to pay an upfront license fee. This allows a practice site 102 to pay for the services as they are used.

System 100 allows for a variety of payment options based upon the discretion of the service provider and the practice site. In all cases, where a fee is associated with the add-on service, the user is charged for every requested service that is performed. Billing systems can include pre-paid services, where a practice site, pays for expected usage before the services are rendered. Production server 118 can also generate a bill each time a service is requested or after a pre-determined time, cost or number of requests are performed. Automatic billing methods may also include such options as direct debit, credit card and other such billing methods. The bill is provided to the user as indicated by block 1420.

Additionally, where the services performed by production server 118 are reimbursable by a patient's insurance company, production server 118 can generate an insurance claim form and transmit electronically or prepare for standard mail. This may allow for a more efficient billing system and may decrease the time it takes to receive reimbursement for a service.

The user command may be for one or multiple services to be performed. Each service requested may require one or more applications to be utilized by production server 118. The production server 118 reads the patientID and study# for the requested add-on service as indicated by block 1422. The production server 118 then retrieves the matching study as indicated by block 1424. The add-on service is performed on the requested imaging study as indicated by block 1426.

The results can then be provided to the user as indicated by block 1428. For example, the production server can push the results to the other imaging studies data module 322 on the uncompressed information server 106 at practice site 102.

In an embodiment, the user of the system 100 may want to upload or download imaging studies, create an ISO image imaging study and CD, perform partial or full remote data recovery, compare multiple images, and communicate with health care service and supply vendors, such as an implant manufacturer.

The user at personal computing device 110 may have the option to upload or download imaging studies. The user may select the current file in use or may select another file. Using an input device 214, the user may upload a copy of an imaging study to the memory device 208 or storage device 216 connected to the personal computing device 110, provided the user doing so has sufficient access or privileges granted to do so.

The user may further want to store the uploaded file on the uncompressed information server 106, for example. Such an imaging study is first written to the memory 208 of the personal computing device 110. The user then has the option of viewing that file, or pushing a copy to the uncompressed information data module 318 and/or the compressed information data module 320 on the uncompressed information server 106. The user may also provide information to properly index the imaging study.

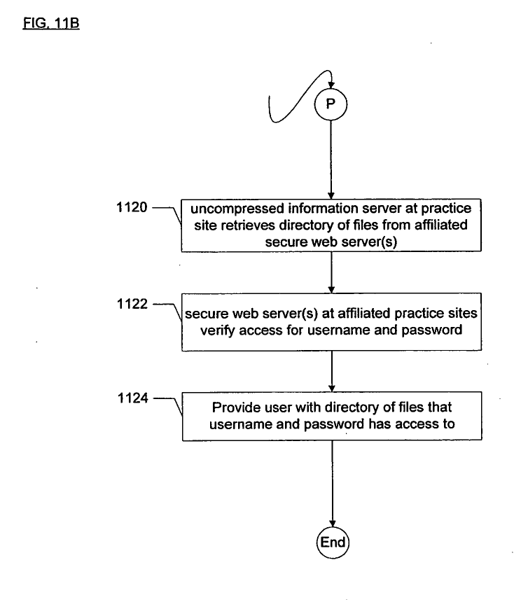

A flow diagram showing one example of a method of creating and copying CD imaging studies is shown in FIG. 15. The user may be able to create an imaging study that is available to be downloaded and burned to a CD. The user can create an image of the CD while on the personal computing device 110 and save it to the uncompressed information data module 318 and/or the compressed information data module 320 on the secure web server 104 or the uncompressed information server 106, depending upon where the user is located.

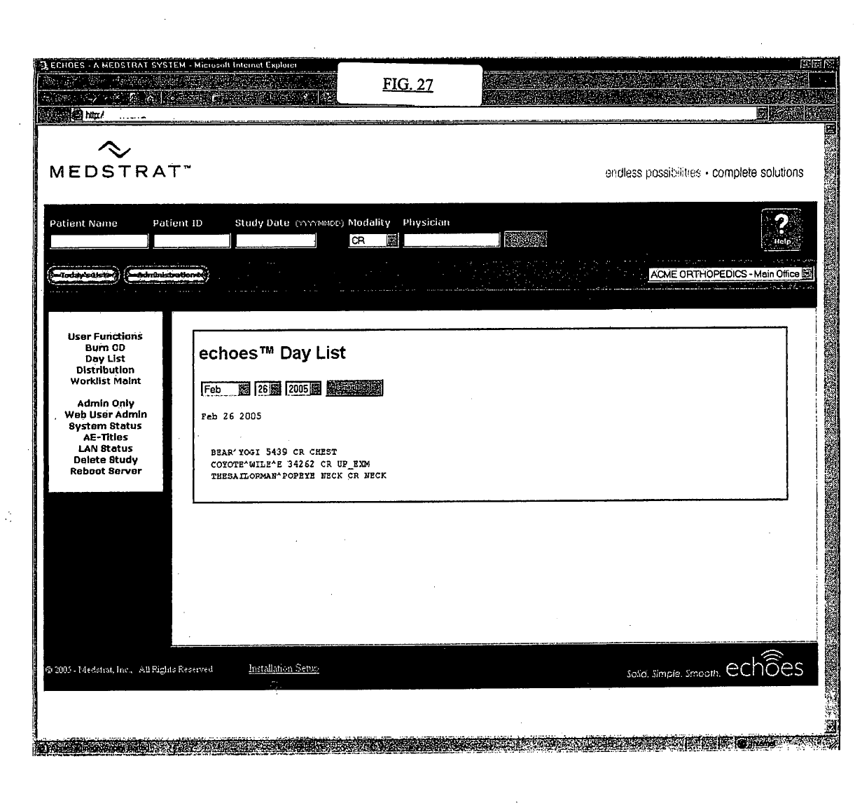

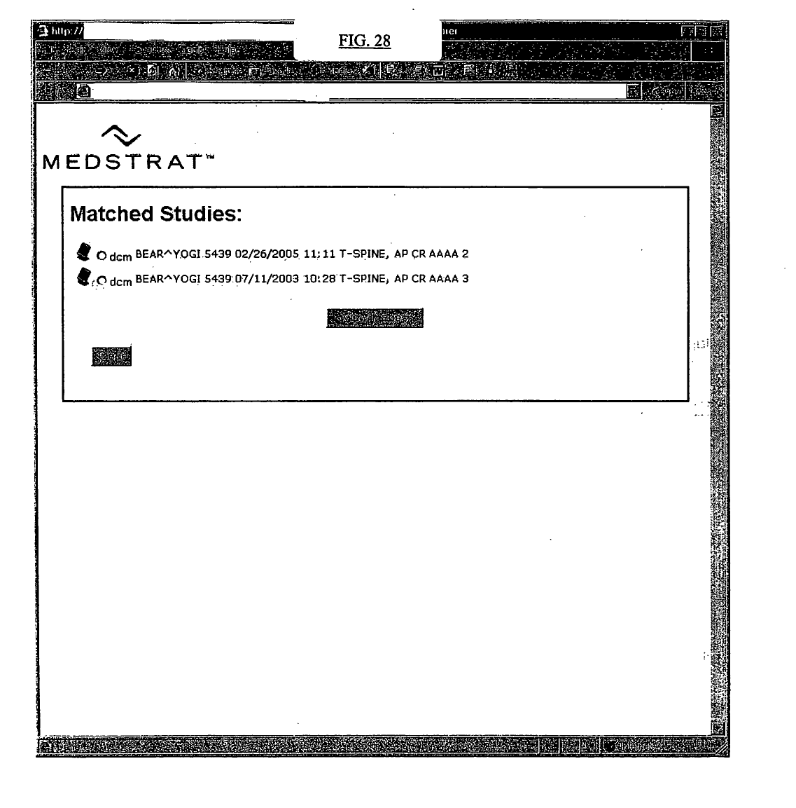

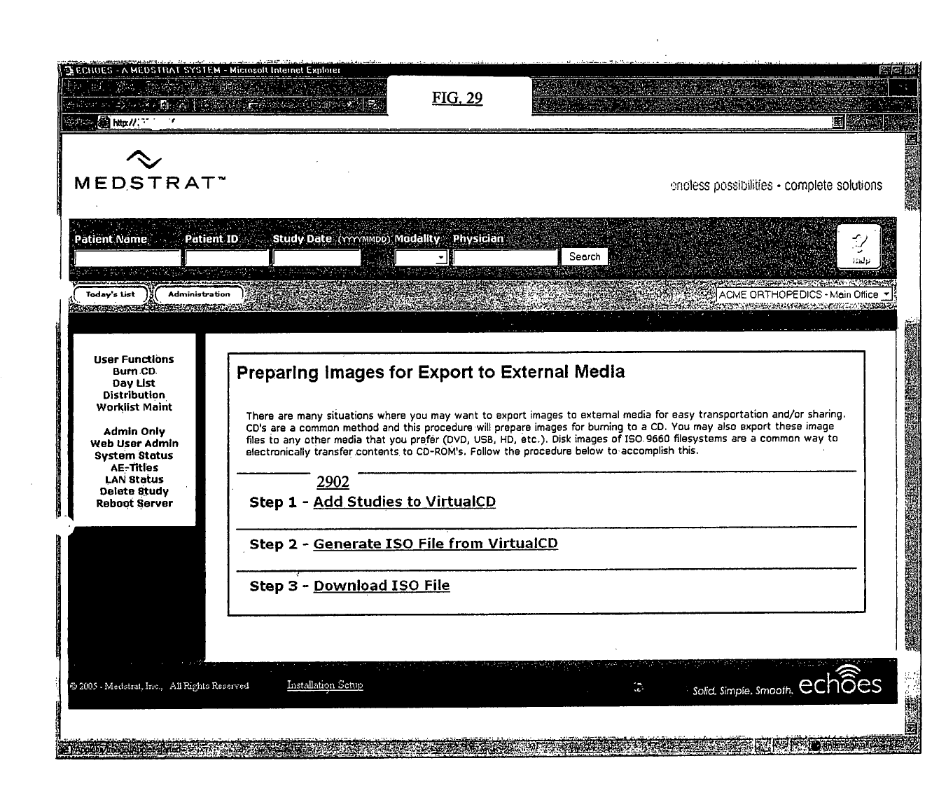

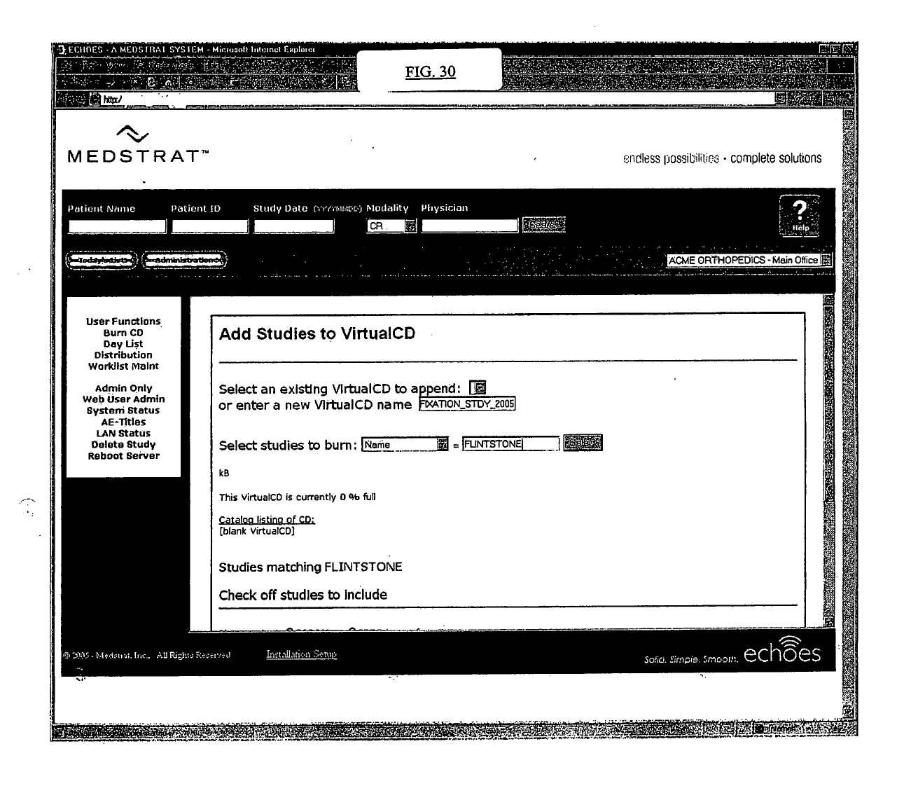

The user at personal computing device 110 may be presented with menu of options. FIGS. 29, 30, 31, 32, 33 and 34 are screen shots showing various points in one example of the creation of a CD file according to the present disclosure. It should be appreciated that other suitable displays and configurations are available in accordance with the present disclosure. In block 1500 and as indicated by 2902, the user selects the option to create a new CD. The user, using input device 214, may select an imaging study to be included in the CD file as indicated by block 1502 and in FIGS. 30 and 31. The imaging study is then copied into the CD file as indicated by block 1504. The user may chose add one or more than one imaging study to the CD file as indicated by block 1506 and by 3202 in FIG. 32. It should be appreciated that other suitable displays and configurations are available in accordance with the present disclosure. Once the user is done adding imaging studies for the CD, the user selects to close the imaging study as indicated by block 1508.

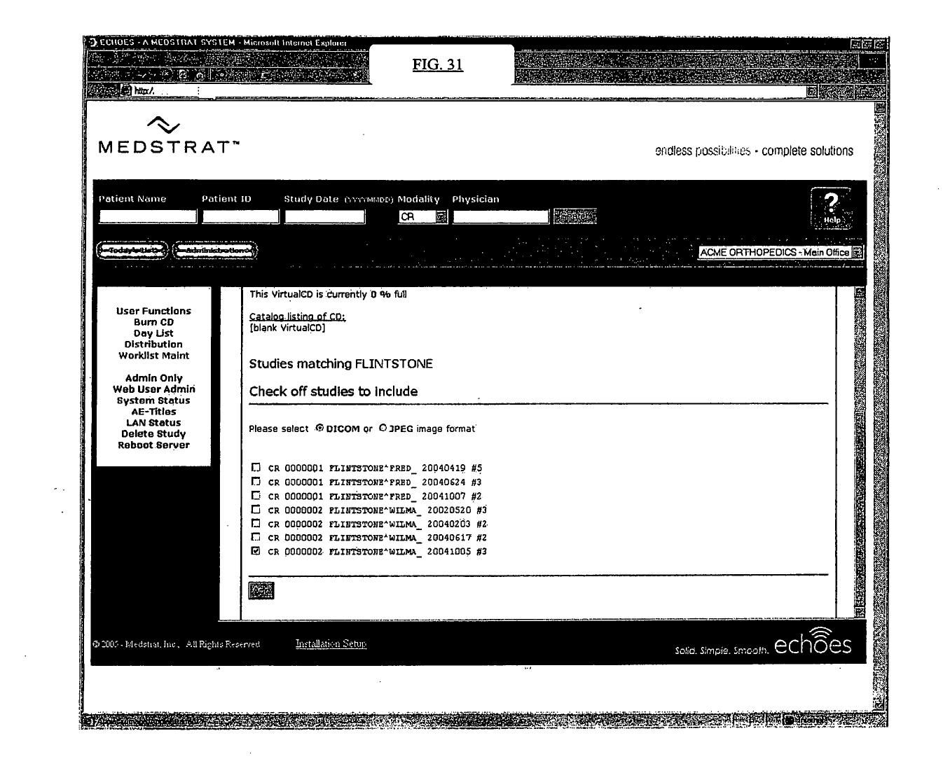

The user may then select to generate an ISO image CD imaging study as shown by 3204 and 3304 in FIG. 33. An ISO image CD imaging study is in an ISO 9660 format. The ISO 9660 format is a standard of the International Standards Organization. Once generated, the ISO image CD imaging study can be written to the uncompressed information data module 318 and/or the compressed information data module 320 on the secure web server 104 or the uncompressed information server 106 as indicated by block 1510. Once the writing is complete, the ISO image CD imaging study is available for later retrieval and downloading as indicated by block 1512.

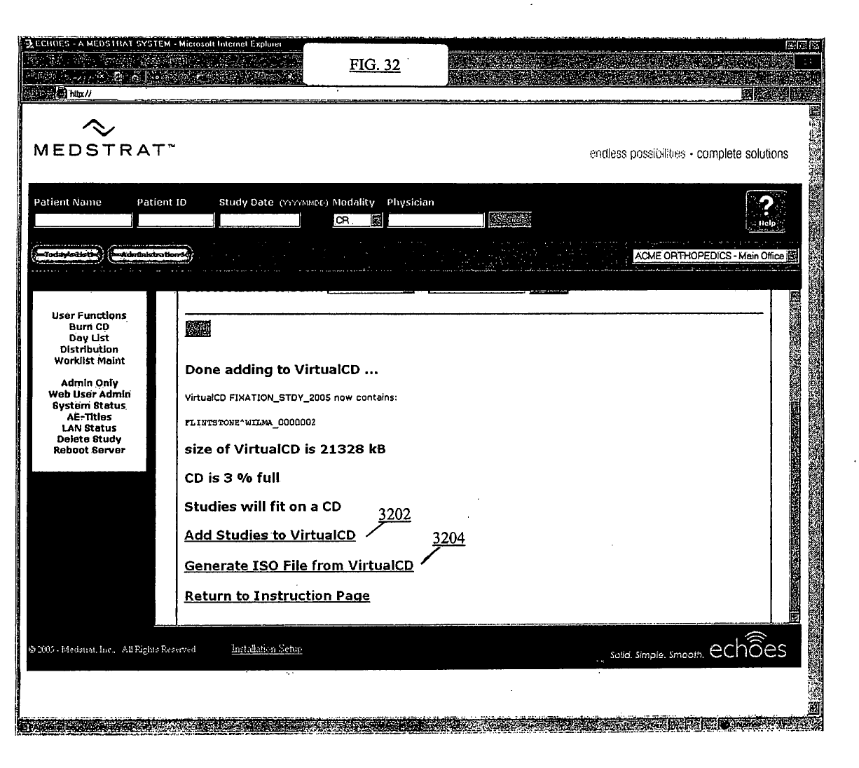

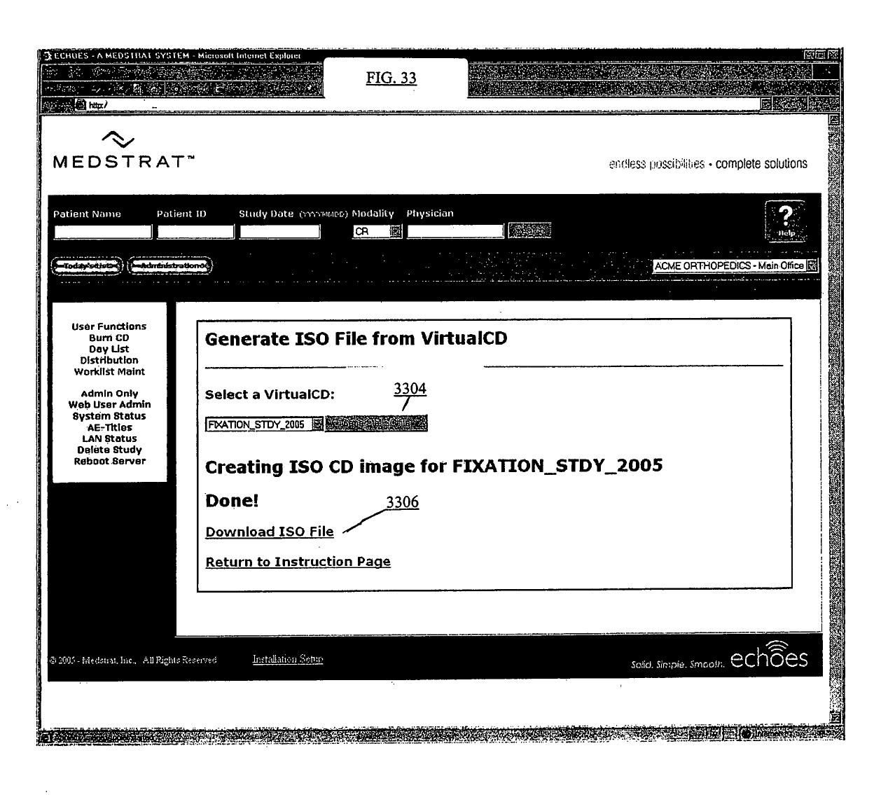

The user at personal computing device 110 can select to download the ISO image CD imaging study to the personal computing device 110 as indicated by block 1514; 3306 in FIG. 33; and 3406 in FIG. 34. The secure web server 104 or the uncompressed information server 106 then downloads the ISO image CD imaging study to the personal computing device 110 as indicated by block 1516. The user is now able to using commercial third party software and/or hardware to burn the ISO image CD imaging study to a CD as indicated by block 1518. The CD now contains the ISO image CD imaging study and is available for use in any compatible CD reader/player device.

The user on the system 100 may from time to time need to retrieve one study, more than one study, or the entire library of studies from the remote backup server 114 for a variety of reasons. Such reasons can include loss of data, an act of nature and corrupt data in addition to other reasons. Therefore, the user at personal computing device 110 can connect to the remote backup server 114 via network 128 and review the list of studies. The user can then select to retrieve those studies from the remote backup server 114 that are needed. In an alternative embodiment of the present system, the service provider, having knowledge of such lost or corrupt data can perform an automatic push from the remote backup server 114 to replace some or all of the studies.

In an embodiment of system 100, the user at personal computing device 110 may be provided with an application that allows for the comparison of images. The image comparison software allows digital images to be compared and analyzed by the software applications. The software also allows the images to be overlaid on to each other based upon specified criteria. The images can be displayed on output device 218 as a single image or multiple images. Where multiple images are displayed, the output device 218 can display the images in a tiled, cascade, overlaid or in any other appropriate manner.

In an embodiment, where the output device 218 displays multiple images, each image may be selected from one study, or may be selected from different studies. Where the multiple images represent a single study, the user can select or map points on a first or primary image, and then map points on additional images that represent the same points as those mapped on the first image. By mapping the same points on each of the images, one is able to compare and properly analyze each image regardless of the orientation that each image represents. For example, if the first image represents a view from the front, and another image represents a view from the side, performing manipulations and calculations on the front image may not assist the user when viewing the side image. However, by mapping the same points on each image, the user allows the system 100 to translate the information from the front image to the side image and perform the same user request. For example, the user may wish to measure the distance in the horizontal plane of two points by using the front image. To measure the vertical distance, the user may be required to use the side image. By having the points mapped in each image, the software can analyze the distance of the mapped points from the front image as they appear in each of the other images. Accordingly, the user who requests the distance between two mapped points in the first image, can be provided with the distances of those points in each of the another images. In addition, by mapping points in each of the images, when another image or implant is overlaid in one image, the another image or implant can be properly placed in the same position in each of the another images.

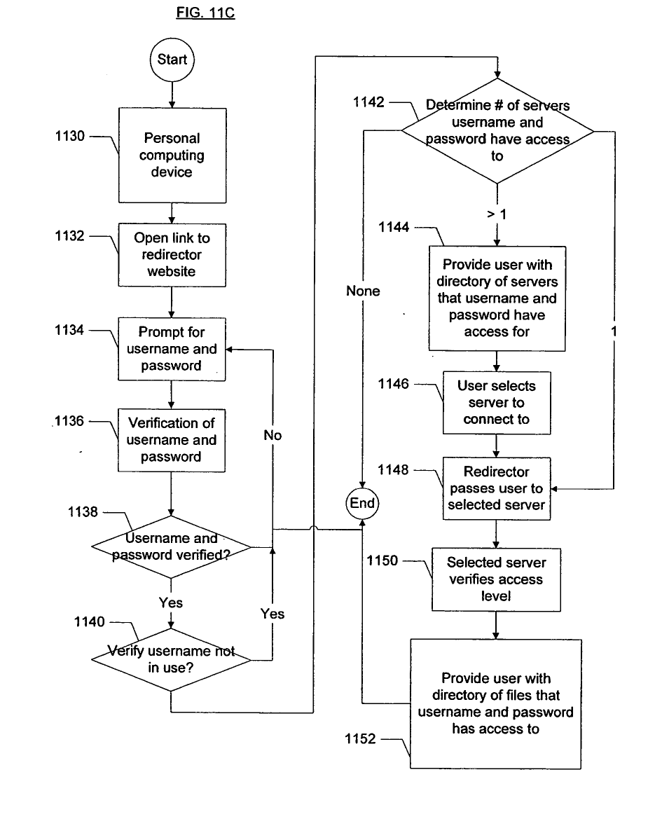

A flow diagram showing one example of selecting and templating an imaging study is shown in FIG. 16. The user at personal computing device 110 can select a particular imaging study to view as indicated by block 1600. The imaging study can be either in an uncompressed or compressed format. As indicated by block 1602, the user can select whether to view a single image or multiple images. The user can select to view a single image as indicated by block 1604. Where the user selects to view multiple images as indicated by block 1606, the user can select one image as the primary image as indicated by block 1608. A primary image allows the user to manipulate the image in one view and have the manipulation properly occur in each of the another images. It should be understood, that at any block the user can change which image represents the primary image.

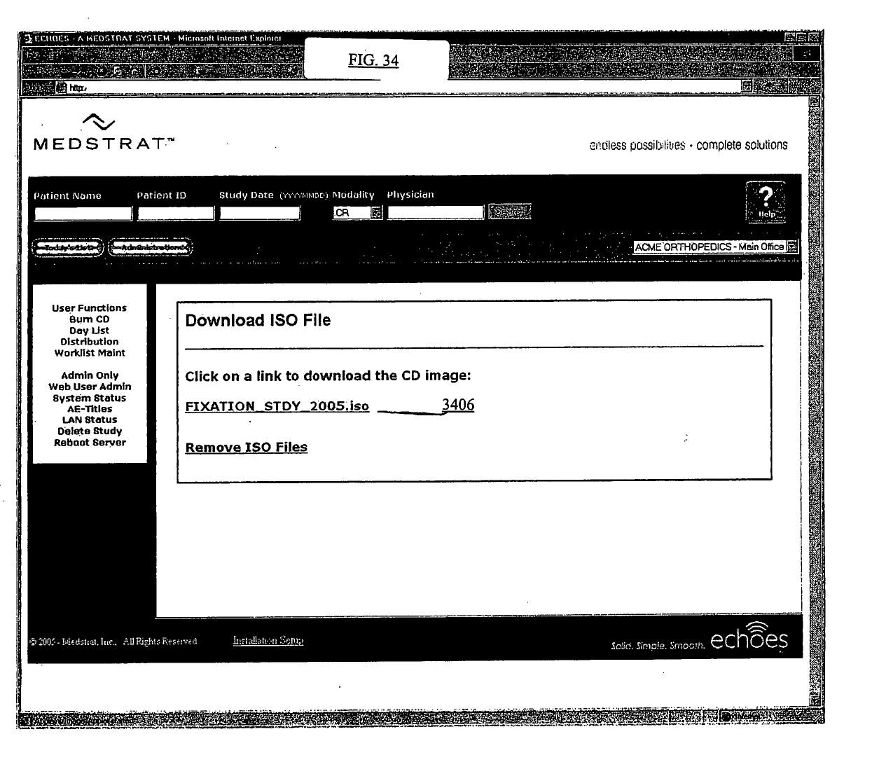

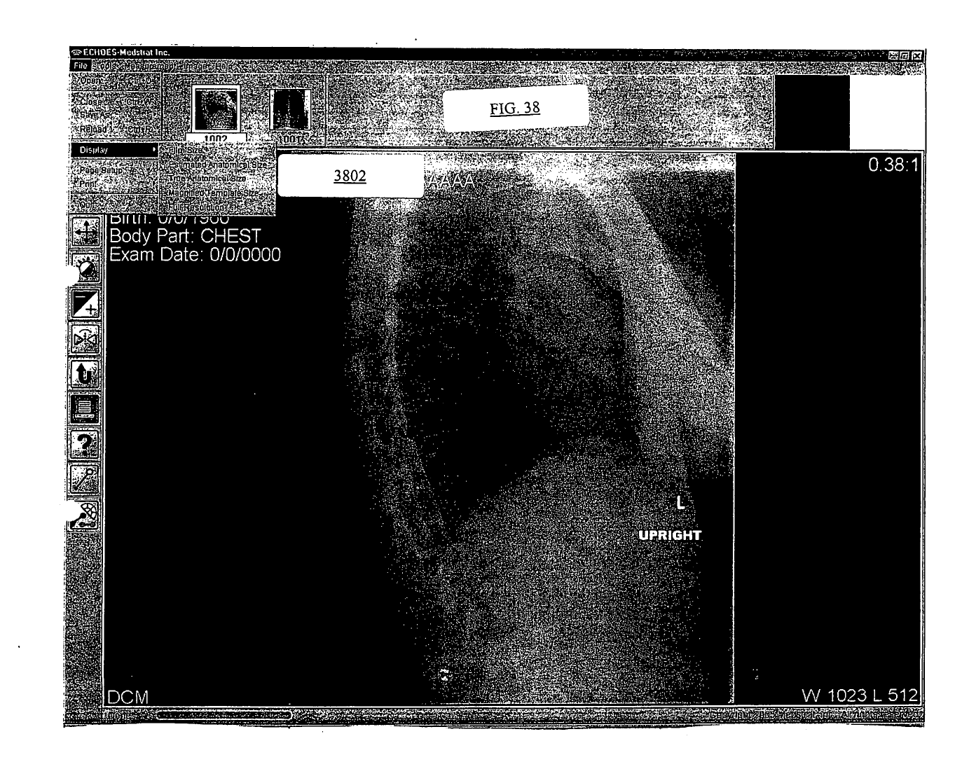

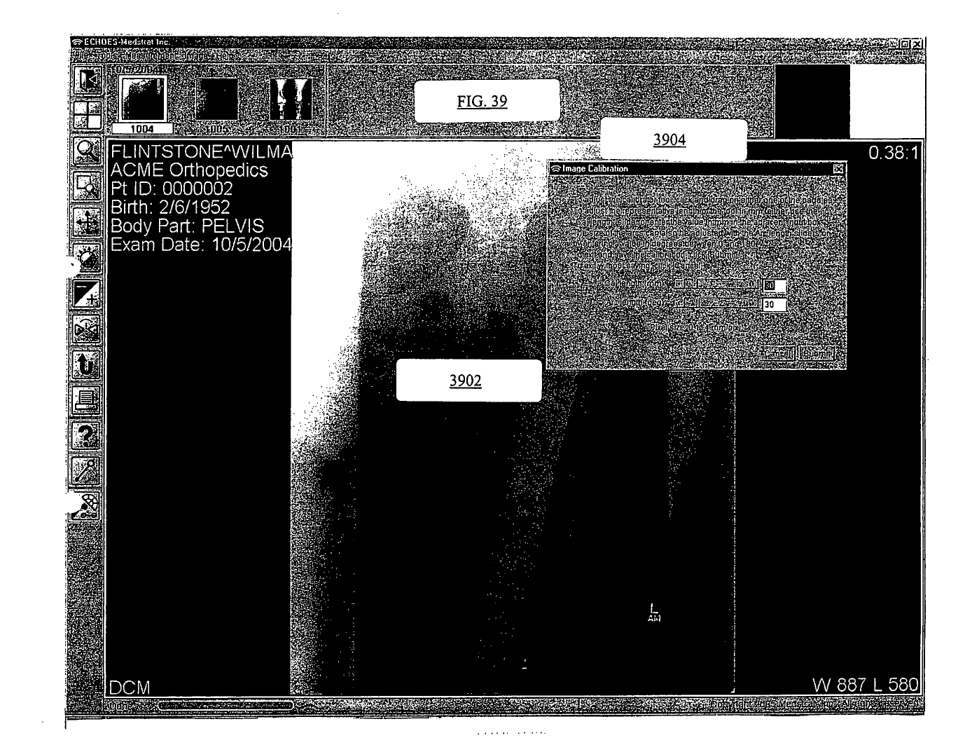

The image is then calibrated as indicated by block 1610. There are many ways to calibrate an image. For example, an object with a known measurement can be placed into the field while an imaging study is being captured. The measured amount of the known object in the imaging study can be compared to the actual known measurement of the object. FIG. 39 shows a screen shot of one example of calibrating the imaging study by using the object with the known measurement. A tool to measure the object with the known measurement is indicated by 3902. The system 100 may provide a prompt to enter the measured amounts of the known object as indicated by prompt 3904. The percentage of enlargement can be calculated by using the difference between the measured value and the known value. The scale ratio of the image can then be adjusted to reflect the actual anatomical size of the body part. In an embodiment, the header fields of the imaging study contain the distance of the X-Ray source to the film plate, and the distance from the body part to the film plate. Using these distances, the percentage of enlargement can be calculated. Where the distances are automatically provided, the system 100 can automatically perform the calculations. Where the header fields do not contain such information, the system 100 can prompt the user to enter the distances. Once the distance amounts are entered, system 100 can calculate the enlargement percentage or ratio represented by the shadow image, and then calibrates the image to represent the actual anatomical size of the object imaged. If the user registers the physical settings of the display of the output device 218 via the user interface, which solicits measurements of known objects from the user, the image may be displayed on the output device 218 in anatomic size. FIG. 35 shows one example of a screen shot according to the present disclosure illustrating the registration of the physical setting of the display. It should be appreciated that other suitable displays and configurations are available in accordance with the present disclosure. This also allows the user to enlarge or reduce and image while maintaining the anatomical scale of the image. This allows the user to use anatomic-scale physical glycene templates or digital templates to overlay on the digital image of the anatomy. Similarly, a system is used to enable the physical characteristics of an output device 218, such as a printer, to be input to allow anatomic-size printing.

The user can then select various locations on the image. In an embodiment, the system 100 can be configured to recognize certain characteristics of images. Such characteristics may include bone width, joints, fractures and the like. The user or system 100 can map one or multiple points on an image as indicated by block 1612. Where system 100 provides mapping points, the user may add, change, delete, modify or accept the points mapped as indicated by block 1614.

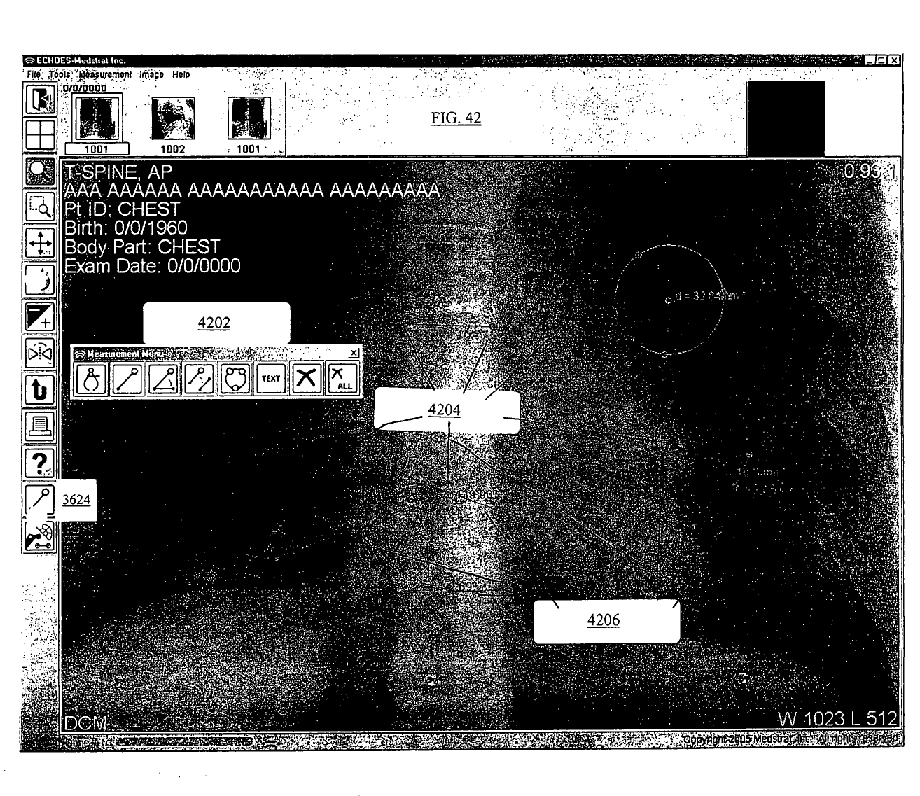

When the mapping is completed, or in an embodiment, as each point is mapped, the system 100 may analyze the mapped points as indicated by block 1616. The user may select to map points on the imaging study by selecting the measurement and mapping tools as indicated by thumbnail 3624. The analysis may include for example, a measurement of the mapped points, an angle, a diameter, etc. as indicated by options box 4202. FIG. 42 shows one example of a screen shot illustrating mapping points on the imaging study as indicated by 4204. These results may be provided to the user as indicated by 4206. The results may be provided in a graphical, numerical or other usable format as indicated by block 1618.

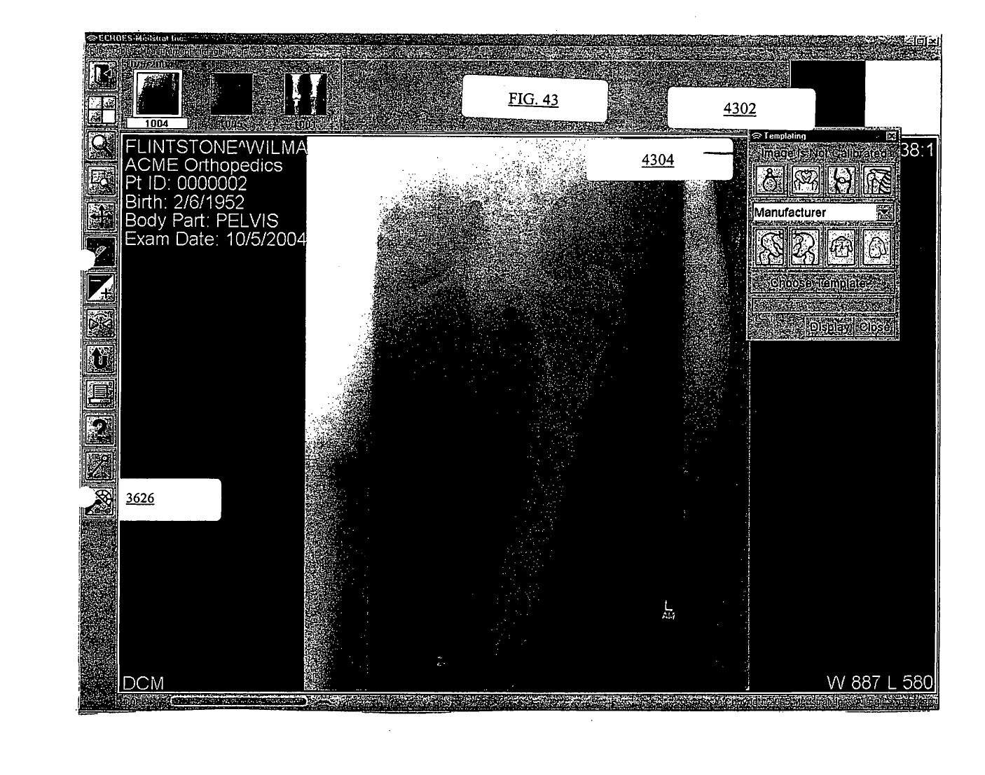

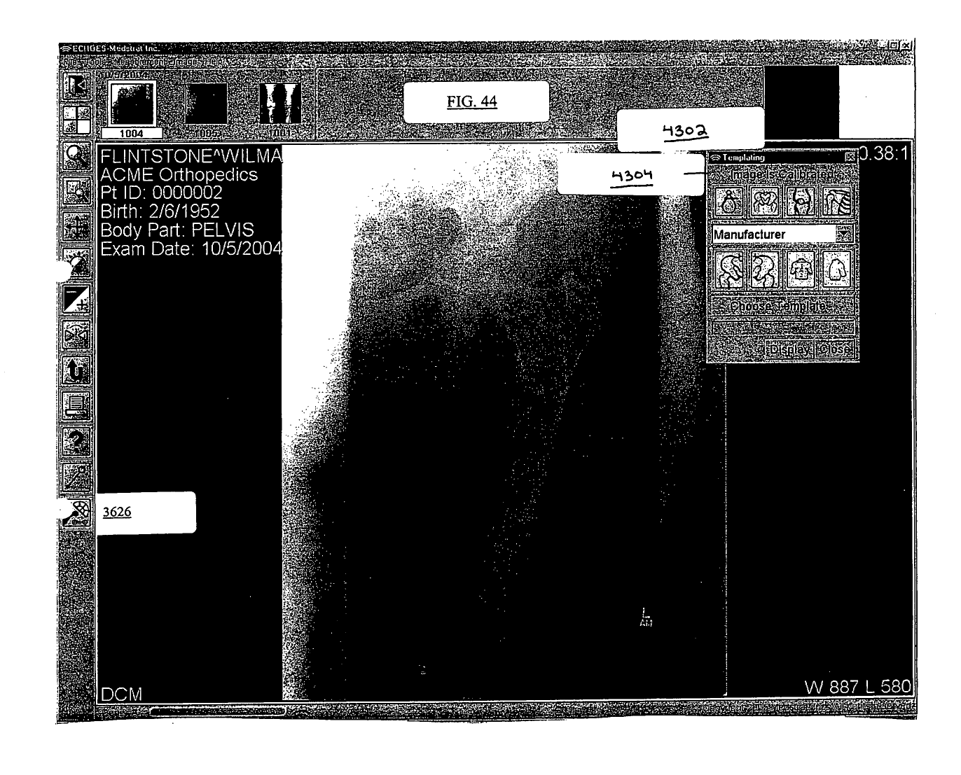

At block 1620, the user may select an implant template. For example, the user by open a prompt for selecting the implant template by selecting the template selection and analysis option as indicated by thumbnail 3626 in FIGS. 36, 43 and 44. The system 100 may display a prompt 4302 to aid the user in selecting the implant template. The prompt 4302 provides notification to the user informing the user whether the imaging study has been calibrated, as indicated by notification 4304 in FIGS. 43 and 44. In an embodiment, based upon information parsed from the header fields and from the mapped points, the system 100 may suggest an implant for use. The collection of templates available for use is stored in the template data module 332. The user can search the available templates. For example, the user may search the template data module 332 by manufacturer and type, such as hip, knee, elbow, shoulder, spine, trauma and the like. For each type and manufacturer, the system 100 can further sort the categories by size. Each type may be searchable. For example, searching in “hip” may reveal subcategories such as stem type, liners, acetabular, instrument type and the like. Each subcategory may be further searchable. For example, searching under “stem type” may reveal such subcategories as cemented, porous, revision and the like. It should be understood, the search order for implant templates may occur in any arrangement. Accordingly, the user may start the search by selecting a hip implant, a size and then select a stem type. Such a selection may reveal a list of all available implant templates from all manufactures corresponding to a hip implant of a particular size with a particular stem type.

Because the imaging study has been properly calibrated, an implant template can be imported without having to alter the template characteristics, such as size, for the proper use. In block 1622, the template image can be overlaid on the imaging study. Where the user has selected to view multiple images and has mapped the points for the multiple images, the template image can be imported into the multiple images. Where the multiple images represent a different view, the template image corresponding to the different view of the multiple images can be used. At this block, or after any block, the user can optionally select to change the implant template image selection, as well as the implant size, or any of the other selection regarding the implant.

As indicated by block 1624, a template, such as a Medstrat image template (.mit) file is used. A .mit file allows the user the associate selected map points on the image with selected points in the .mit file. By associating one or more map points with the mit, the user can then lock the template image to one or more points on the image. For example, where an implant is being sized and fitted, the user may want to create several map points to represent a bone contained in the image. The .mit can then be associated with the map points. A may accept or reject the associate map points between the .mit and the image as indicated by block 1628. Once the mapped points are accepted, the .mit and image can be locked as indicated by block 1630. As the .mit is manipulated, it remains locked to the specific map points.

The user may want to manipulate the images. The user can change enlarge or reduce the display of the images. It should be noted, that when the image is enlarged or reduced, both the imaging study and the template image are enlarged or reduced with the same scale ratio. The user can also rotate an image around its axis.

The user of the present system may at any time select to perform high level or low level image manipulations. In block 1632, the selection of low level manipulations allows the user, using input devices 214 to manipulate either image on output device 218. The low level manipulations are coarse adjustments to allow the user to quickly get an approximate match. One the user believes that the implant template image and the study image are a good match; the selection of high level manipulations can be selected. In block 1634, high level manipulations are possible. High level manipulations are fine or small adjustments to allow for accurate implant selection, such as for size, fit and location. It is also possible in this selection to manipulate individual aspects of the implant template image, such as the size, shape, location or fit of one part of the image implant, while the overall implant template image remains the same.

In an embodiment, where there are multiple views of an imaging study, any manipulation of any image in the primary view, results in corresponding manipulations in the other displayed view. This is advantageous for several reasons. For example, by having more than one view of an implant, the user can more accurately determine whether the implant is proper. A patient's anatomy may dictate one implant size, fit or location in one image view, but in another view, a different implant size, fit or location is called for. It is also advantageous to have more than one view, as it provides the user with additional information in selecting an implant device.

The user can then select whether the current displayed implant template image is correct as indicated by block 1634. If not, the user can go back to any prior block until the user approves the selection. The user can then select to add an additional implant template image as indicated by block 1638. This may be necessary as an implant may comprise multiple components, or where a patient requires multiple implants.

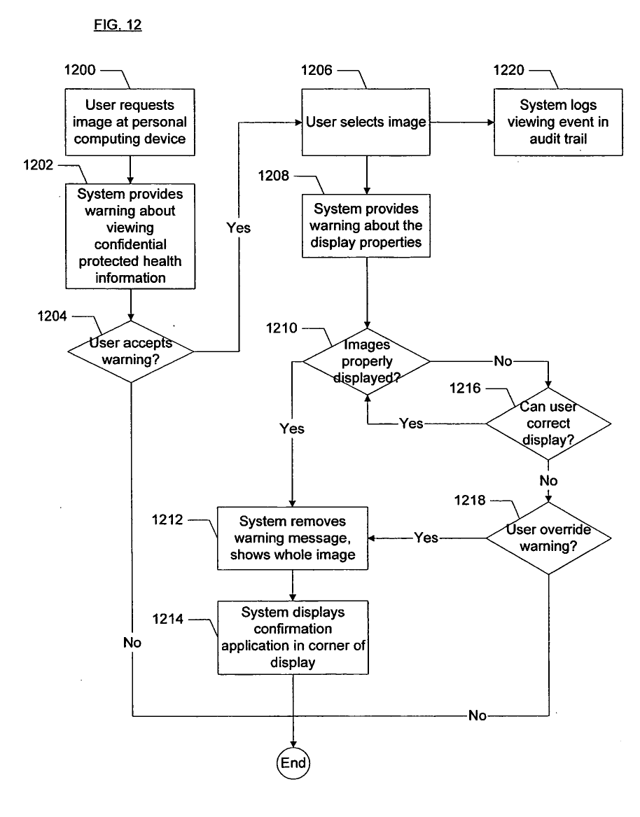

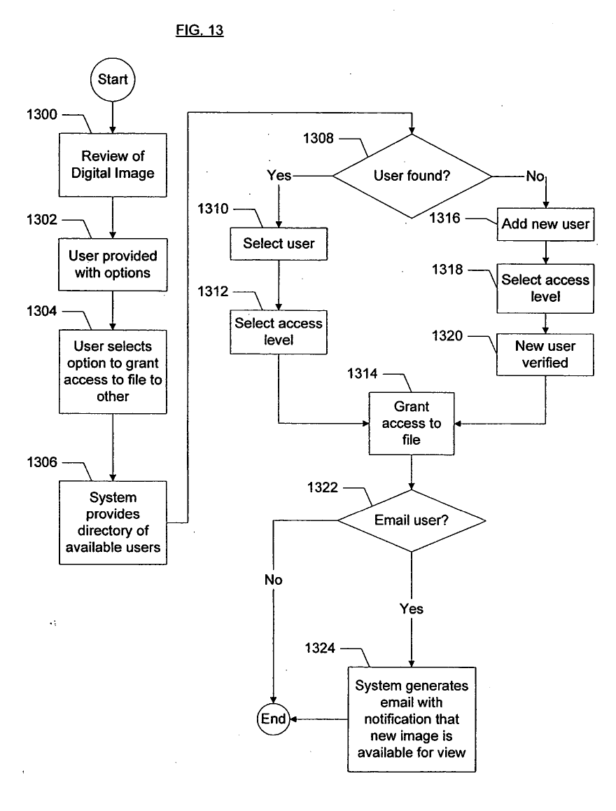

A flow diagram showing one example of recording the templating information, verifying inventory and communicating with an implant vendor is shown in FIG. 17. After the user has completed the implant selection process, the user may record the implant selection and analysis performed. The system 100 can assign a unique reference code to the imaging study. The name of the user who created the overlay is recorded, as well as the current status of the imaging study saved as indicated by block 1700. The status may include “draft,” “final” and the like. The newly created or modified file may be saved in the template saved state and statistical data module 334. The unique reference code allows the user to communicate with an implant vendor, manufacturer and/or distributor, as well as other health care providers without disclosing confidential PHI as required under HIPAA privacy standards.

The system 100 may determine whether the implant, implants and/or other devices are in inventory at the facility where the operation or other procedure will be carried out as indicated by block 1702. If the implant is available in inventory, the system 100 may allow the user to submit a removal request to reserve the implant for a particular patient as indicated by block 1704.

If the implant is not in inventory, the system 100 may allow the user to place an order with the proper vendor, manufacturer or distributor as indicated by block 1706. If the user selects to place an order for the implant, an order request is prepared to be sent along with a redacted patient file to a vendor computer 126 as indicated by block 1708. In an embodiment, system 100 may prepare and transmit an order electronically, directly to the vendor, manufacturer or distributor. Whether the user elects to place an order or not, system 100 can remove all PHI from a patient file as indicated by block 1710. The system 100 may remove all PHI by determining whether the header field contains a tag indicating a field that contains PHI. System 100 can then create a new file without the PHI. The new file may contain the implant selection any analysis performed and the unique reference code associated with that file as indicated by block 1712. This information can then be transmitted to a vendor computer 126 as indicated by block 1714.

The information in the imaging study may be useful to a vendor, manufacturer and/or distributor. The additional information may assist in determining overall all inventory requirements. Additional information may also include inventory status at the operative site, such as a hospital or surgical center.

In an embodiment, vendor computer 126 is capable of receiving information transmitted from the personal computing device 110. The user of the vendor computer 126 may be provided with access to imaging studies contained on the secure web server 104. Thus, the user of vendor computer 126 may be able to template an imaging study from a remote location. The user, such as a physician at practice site 102 can later review the template analysis performed by the vendor representative. If approved, the order may be placed. The remote template analysis allows a vendor representative to become more efficient by reducing travel to practice sites to review an imaging study, performing a template analysis, ordering an implant, and delivering an implant.

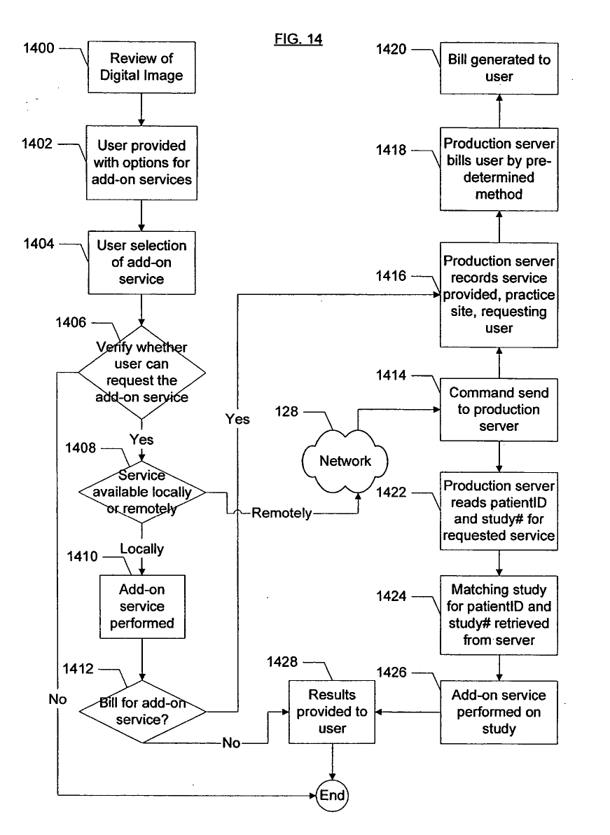

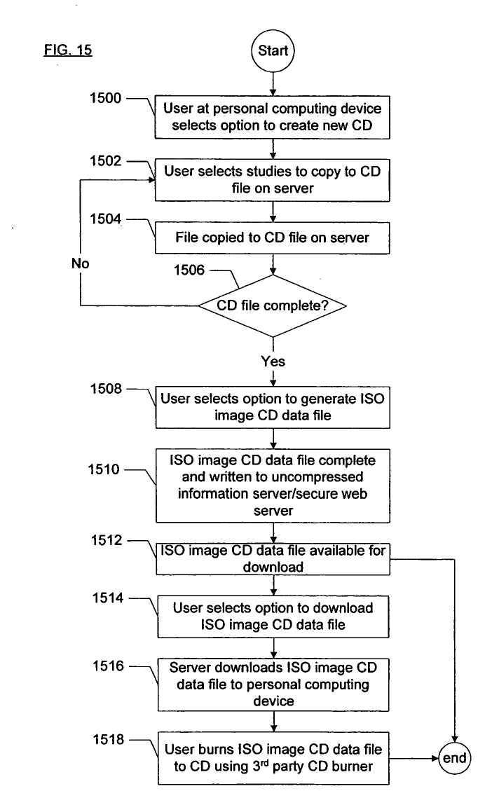

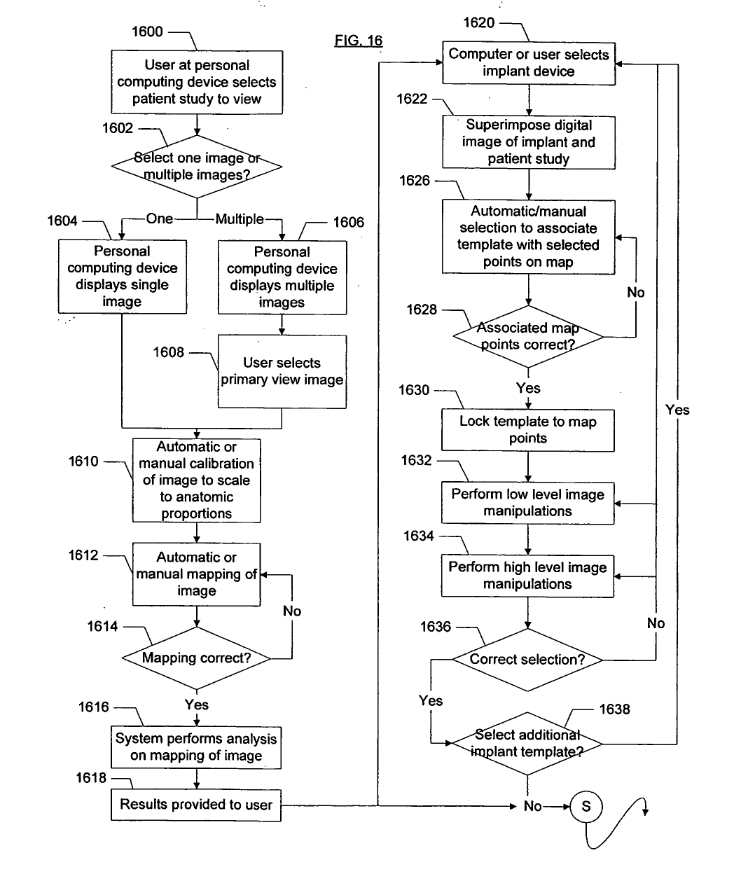

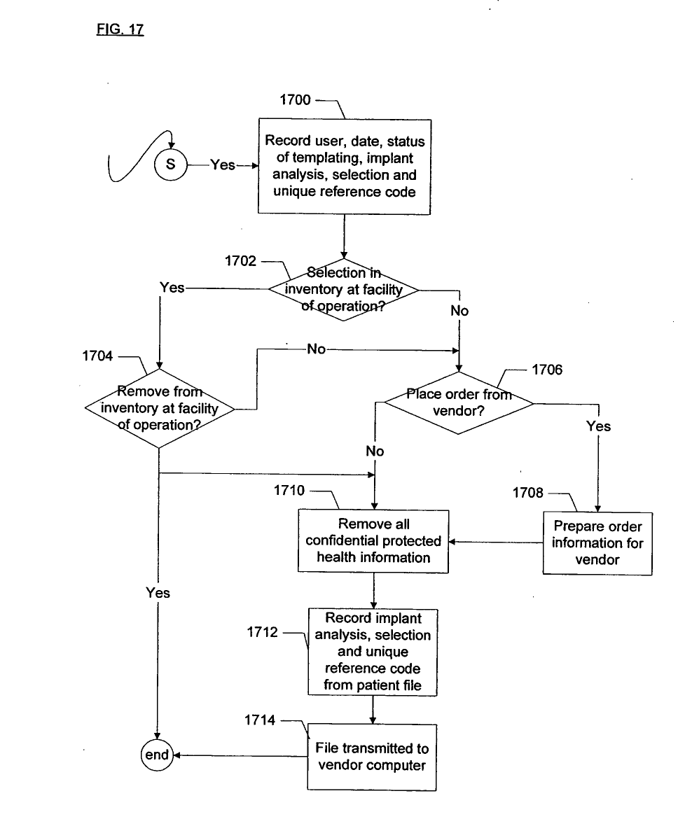

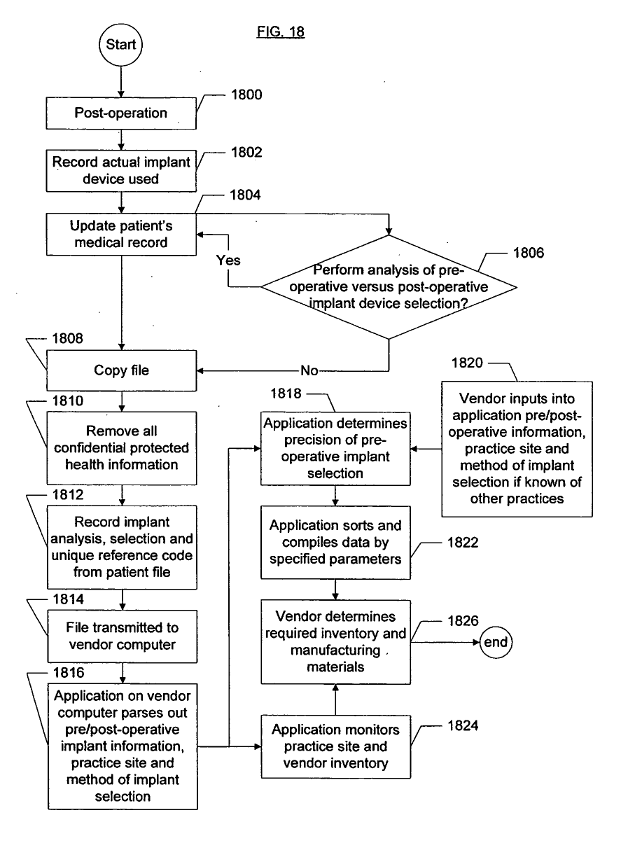

A flow diagram showing one example of a method of performing post-operative implant selection and inventory analysis is shown by FIG. 18. A procedure is performed as indicated by block 1800. The user may then record the actual implant used, along with other information as indicated by block 1802. The other information may include updated measurements. The user may update a patient's record to reflect the added information as indicated by block 1804. The user may also be able to perform analysis of pre-operative versus post-analysis implant selection as indicated by block 1806. The analysis may provide useful information such as the precision of the method of selection. The analysis may allow the user to make a better pre-operative selection in the future. The user may analyze the precision of the selection process for all patients. Accordingly, the user can adjust the selection or ordering accordingly. For example, using a prior method of selecting an implant, the user may have requested ten different sizes and configurations of a particular implant. However, if the user is able to determine the accuracy of the selection process, the user may only need to order two or three different implant sizes or configurations. Therefore, the user may be more efficient in the ordering process and inventory requirements. The user may then update the patient's file with the results of the analysis as indicated by block 1804.

The system 100 can copy the patient's record as indicated by block 1808. All PHI is removed from the copied record as indicated by block 1810. The record contains the updated information, such as the pre- and post-operative implant selection, any implant analysis performed, and the original reference code as indicated by block 1812. This information can then be transmitted to a vendor computer 126 as indicated by block 1814.

The vendor computer 126 may match the post-operative patient record to the pre-operative patient record. At block 1816, the vendor computer 126 may parse out specific information from the patient record. Such information may include the pre- and post-operative implant selection, the practice site and the method utilized to determine the pre-operative implant selection.

The record transmitted to vendor computer 126 allows the vendor computer 126 to perform the same or additional analysis on the information. Additionally, the vendor computer 126 may compare the pre- and post-operative implant selection over all practice sites where that information is available.

When a vendor has pre- and post-operative implant selection information from other medical practices, the user can enter the information into the vendor computer 126 as indicated by block 1820. The user of the vendor computer 126 may also enter any other information into the computer, such as the practice site and the method of implant selection. This information allows the user at the vendor computer 126 to determine the precision of the pre-operative implant selection for any practice, regardless of which system they utilize.

In block 1822, the user can sort and analyze the information in a variety of ways. For example, the vendor computer 126 can provide results to the user that analyzes the precision of implant selection based upon a practice site, physician, implant type, patient age, patient gender, patient weight, method of implant selection and/or by any other parameter available to the user at the vendor computer 126. In an embodiment, the results provided to the user may include inventory levels at each of the different practice sites.

In an embodiment, the vendor computer 126 can monitor the inventory level at the vendor site, as well as the inventory level at the operative site as indicated by block 1826. A vendor can have the vendor computer 126 compare inventory levels, selection precision and actual usage to allow a vendor to determine actual inventory requirements as indicated by block 1826. Thus, it may be possible for a vendor to reduce excess inventory. In an embodiment, a vendor may have the vendor computer 126 monitor the supply of raw components for implant manufacturing. Accordingly, the vender can perform real time inventory and raw components inventory monitoring. Real time monitoring allows the vendor to stream line the ordering and deliver process of raw components to more closely match inventory supply levels. This allows a vendor to create just in time inventory of raw components for implant manufacturing and for the implants for various users.

A flow diagram showing one example of a method of comparing imaging studies and/or analyzing an implant already placed in a patient is shown in FIG. 19. In an embodiment, where the output device 218 displays multiple images, each image may be selected from one study, or each image may be selected from different studies. Where the multiple images represent a single study, the user can select or map points on a first or primary image, and then map points on additional images that represent the same points as those mapped on the first image. By mapping the same points on each of the images, one is able to compare and properly analyze each image regardless of the orientation that each image represents.

The user at personal computing device 110 can select a particular imaging study to view as indicated by block 1900. The imaging study can be either in an uncompressed or compressed format. The user can select whether to view a single image or multiple images as indicated by block 1902. The user can select to have the personal computing device 110 display a single image as indicated by block 1904. The user can select to have the personal computing device display multiple images as indicated by block 1906. Where the user selects to view multiple images, the user can select one image as the primary image as indicated by block 1908. A primary image allows the user to manipulate the image properly. It should be understood, that at any block the user can change which image represents the primary image.

In block 1910, the image is calibrated. The image may be calibrated using similar techniques as block 1610 in FIG. 16. The user can then select or map various locations on the image. The user can select the same locations in each of the multiple images, where the user selects to view multiple images. In an embodiment, the system 100 can be configured to recognize certain characteristics of images. Such characteristics may include certain aspects of an implant, such as the stem, collar, cup, disc, ball and the like. This allows the user to analyze specified areas on the image. This further allows the user to compare specified areas on an image with another image. The user or system 100 can map one or multiple points on an image as indicated by block 1912. Where system 100 provides mapping points, the user may add, change, delete, modify or accept the points mapped as indicated by block 1914.

When the mapping is completed, or as each point is mapped, the system 100 may analyze the mapped points. The analysis may include a measurement of the mapped points and/or provide and angle of measure between different mapped points as indicated by block 1916. These results may be provided to the user as indicated by block 1918. The results may be provided in a graphical, numerical or other usable format.

The user is provided with an option to select an additional imaging study or an implant image as indicated by block 1920. The user may select whether to view the additional imaging study or the implant as indicated by block 1922. In an embodiment, the comparison of multiple imaging studies allows a user to follow an implant in a patient over time. Where the user selects to view an additional imaging study, the user may elect to map the same locations in the additional imaging study as the user mapped in the first imaging study.

Where the user selects to view an implant image, the user may be provided with a selection of implant characteristics as indicated by block 1924. The selection of an implant as indicated by block 1924 is similar to the implant selection process indicated by block 1620 in FIG. 16. The user can narrow down the possibilities of the implant by selecting various characteristics, such as any distinguishing features like the shape, configuration, components, materials and the like. The user can then select a possible implant as indicated by block 1926. The user can reject the implant and select a different implant image as indicated by block 1928. After an implant image or imaging study is selected, the user can import and overlay the implant image or the imaging study as indicated by block 1930. As indicated by block 1932, the user can perform low level image manipulations at any time, in a similar manner as indicated by block 1632 in FIG. 16. As indicated by block 1934, the user can perform high level image manipulations at any time in a similar manner as indicated by block 1634 in FIG. 16.

In block 1936, the user can have the system 100 verify the match between the imaging study and the implant image or the second imaging study. For example, system 100 can compare specified map points of the implant image with specified points of the implant template image.

The user can select whether the current displayed implant image or additional imaging study is correct as indicated by block 1938. If not, the user can go back to any prior block until the user approves the selection. The user can then select to add an additional implant image to the display as indicated by block 1940. This may be necessary as an implant may comprise multiple components, or where a patient requires multiple implants. After the comparison of imaging studies, and/or implant template images, the user can update the patient's medical record as indicated by block 1942.

In summary, it will be appreciated that systems and methods of management and communication of digital information though a network, and more particularly systems and methods for manipulating and communicating medical information. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

The invention is claimed as follows:

1. A method of distributing digital medical images, the method comprising:
storing a first medical image in a compressed format and an uncompressed format on a first server, the first server being located at a first medical office;
receiving first login information at a central server from a first client device, the first login information being associated with the first server;
sending a first redirection message from the central server to the first client device, the first redirection message instructing the first client device to request information from the first server;
receiving a first image request at the first server from the first client device, the first image request being indicative of the first medical image, the first image request being associated with a first requested format, the first requested format being one of the compressed format and the uncompressed format;
sending the first medical image from the first server to the first client device in the first requested format;
storing a second medical image in the compressed format and the uncompressed format on a second server, the second server being located at a second medical office different from the first medical office;
receiving second login information at the central server from a second client device, the second login information being different than the first login information, the second login information being associated with the second server;
sending a second redirection message from the central server to the second client device, the second redirection message instructing the second client device to request information from the second server;
receiving a second image request at the second server from the second client device, the second image request being indicative of the second medical image, the second image request being associated with a second requested format, the second requested format being one of the compressed format and the uncompressed format; and
sending the second medical image from the second server to the second client device in the second requested format.

2. A method of storing digital medical images, the method comprising:
storing a first medical image on a first server and not storing a second medical image on the first server, the first server being located at a first medical office;
storing the second medical image on a second server and not storing the first medical image on the second server, the second server being located at a second medical office different from the first medical office; and
storing an index on the first server and storing the index on the second server, the index including information associated with the first medical image and the second medical image.

3. A method of retrieving digital medical images, the method comprising:
acquiring a new medical image at a first medical office;
sending the new medical image to a viewing station at the first medical office;
presenting a list of medical images at the viewing station, the list of medical images being associated with the new medical image, the list of medical images being acquired prior to the new medical image;
receiving a user selection indicative of a medical image in the list of medical images;
retrieving the medical image from a second different medical office via a computer network; and
sending the medical image to the viewing station at the first medical office.

4. A method of analyzing a plurality of digital medical images, the method comprising:
storing a first medical image of a portion of a patient at a first time;
storing first metadata associated with a first markup of the first medical image;
storing a second medical image of the portion of the patient at a second time subsequent to the first time;
storing second metadata associated with a second markup of the second medical image;
calculating a value based on the first metadata and the second metadata; and
displaying information indicative of the value.

5. A method of managing implant inventory, the method comprising:
displaying a first medical image;
selecting a first implant based on the first medical image;
storing data indicative of the first implant;
displaying a second medical image;
selecting a second implant based on the second medical image;
storing data indicative of the second implant;
aggregating at least a portion of the data indicative of the first implant and at least a portion of the data indicative of the second implant to create aggregated implant order information; and
sending the aggregated implant order information to a supplier associated with the first implant and the second implant.

6. A method of distributing digital medical images, the method comprising:
receiving first login information from a first user authorized to view a first medical image and a second medical image;
receiving a selection indicative of the first medical image located on a first server, the first server being located at a first medical office;
receiving a selection indicative of the second medical image located on a second server, the second server being locaed at a second medical office different from the first medical office;
receiving a request for temporary login information to be associated with the first medical image and the second medical image;
receiving the temporary login information at a central server from a client device;
sending a redirection message from the central server to the client device, the redirection message instructing the client device to request information from at least one of the first server and the second server;
sending an index to the client device, the index including information associated with the first medical image and the second medical image;
receiving an image request at the first server from the client device, the image request being indicative of the first medical image;
sending the first medical image from the first server to the client device; and
disabling the temporary login information.

7. A method of selecting an implant, the method comprising:
sending a first medical image from a first medical office to a third party implant selection service;
receiving first data at the first medical office from the third party implant selection service;
selecting a first implant based on the first data;
sending a second medical image from a second medical office to the third party implant selection service, the second medical office being different than the first medical office;
receiving second data at the second medical office from the third party implant selection service; and
selecting a second implant based on the second data.
